(19) United States
(12) Patent Application Publication
(10) Pub. No.: US 2026/0202574 A1
(43) Pub. Date: Jul. 16, 2026

(54) FIBER-OPTIC GEODESY: HIGH-RESOLUTION SUBSURFACE DEFORMATION MONITORING WITH TELECOMMUNICATION INFRASTRUCTURE

(71) Applicants: California Institute of Technology, Pasadena, CA (US); Valey Kamalov LLC, doing business as INTERNATIONAL INSTITUTE FOR OCEAN FIBER SENSING, Gainesville, FL (US); Reykjavik University, Reykjavík (IS)

(72) Inventors: Jiaxuan Li, Houston, TX (US); Ettore Biondi, Stanford, CA (US); Zhongwen Zhan, Arcadia, CA (US); Valey Kamalov, Gainesville, FL (US); Vala Hjörleifsdóttir, Reykjavík (IS)

(73) Assignees: California Institute of Technology, Pasadena, CA (US); Valey Kamalov LLC, doing business as INTERNATIONAL INSTITUTE FOR OCEAN FIBER SENSING, Gainesville, FL (US); Reykjavik University, Reykjavík (IS)

(21) Appl. No.: 19/419,933

(22) Filed: Dec. 15, 2025

Related U.S. Application Data
(60) Provisional application No. 63/733,583, filed on Dec. 13, 2024.

(51) Int. Cl. G01V 8/10; G01L 1/24; G01V 1/22; G01V 1/28; G01V 1/30

(52) U.S. Cl. CPC G01V 8/10; G01L 1/242; G01V 1/226; G01V 1/288; G01V 1/30; G01V 2210/6161; G01V 2210/675

(57) ABSTRACT

A geodesy technique using telecommunication fiber-optic cables for real-time monitoring of subsurface quasi-static deformations. The fiber-optic cables comprise dense arrays of strainmeters, measuring strain rate data by processing the low-frequency content of cable vibration or deformation signals contained in optical backscattering. The technique is demonstrated to image the magma movement during dike intrusion events at minute time scale, exhibiting enhanced sensitivity and achieving high-temporal resolution and low noise levels with minimal data processing. The system can measure subsurface deformation in both onshore and offshore environments.

### CROSS REFERENCE TO RELATED APPLICATIONS

This application claims the benefit under 35 U.S.C. Section 119(e) of the following co-pending and commonly-assigned application:
U.S. Provisional Patent Application Ser. No. 63/733,583, filed on Dec. 13, 2024, by Jiaxuan Li, Ettore Biondi, Zhongwen Zhan, Valey Kamalov and Vala Hjörleifsdóttir, entitled “FIBER-OPTIC GEODESY: HIGH-RESOLUTION SUBSURFACE DEFORMATION MONITORING WITH TELECOMMUNICATION INFRASTRUCTURE,” docket number G&C 176.0260USP1 (CIT 9251-P);
which application is incorporated by reference herein.

### BACKGROUND OF THE INVENTION

### 1. Field of the Invention

This invention relates to the use of fiber-optic geodesy with a telecommunication infrastructure to provide high-resolution monitoring of subsurface deformation.

### 2. Description of the Related Art

(This application references a number of different publications as indicated throughout the specification by one or more reference numbers in parentheses, e.g., (x). A list of these different publications ordered according to these reference numbers can be found below in the section entitled “References.” Each of these publications is incorporated by reference herein.)

Damages resulting from natural ground-failure and mass-movement phenomena such as landslides, sinkholes, and volcanic activity (including magma intrusions and associated eruptions) represent recurring social and economic burden in the United States and worldwide. Classical geodetic techniques, such as electronic distance measurement (EDM), borehole strainmeters, tilt measurements, satellite-based methods such as Global navigation satellite system (GNSS) and interferometric synthetic aperture radar (InSAR) (2-4) can reveal magma accumulation and transport over timescales ranging from hours to decades, or assess volcanic and seismic hazards (5, 6), (7-10, 11). However, capturing the detailed evolution of mass movement such as that resulting from magmatic intrusions on the minute timescale or in real time remains challenging, as achieving millimeter-level precision with GNSS data typically requires daily averaging (12), and it takes days for InSAR to acquire repeating measurements. Moreover, the fast-changing dynamics of a mass flow, such as that resulting from the evolution and emplacement of magma volume, the magma flow rates, and the propagation speed of the magma pulse-remain difficult to resolve. However, such information is critical for understanding the dynamics of magma intrusion and ultimately to forecast whether an intrusion will end as an eruption (13).

Distributed acoustic sensing (DAS) technology can convert preexisting telecommunication fiber-optic cables into dense arrays of deformation sensors (14-16) and has been gaining increasing attention in volcanic regions for its potential to enhance the monitoring and imaging of volcanic systems (17-22). High-frequency DAS recordings have proven particularly effective in monitoring natural earthquakes and advancing our understanding of earthquake source physics (23-26). Low-frequency DAS (LFDAS) recordings along fibers in boreholes have been widely used to monitor and characterize fracture growth during hydraulic fracturing (27-29). Additionally, LFDAS shows great potential for monitoring other geophysical phenomena, such as internal waves and tides (30), tsunamis (31, 32), and landslides (33). However, these techniques (27-29, 33) as applied to sensing of quasi-static ground deformations lack the spatiotemporal resolution needed for reliable forecasting and are spatially limited in terms of needing the fibers to be physically located in the hazard. Accordingly, there exists a clear need for a cost-effective and real-time warning methodology capable of remotely detecting such hazards prior to catastrophic failure. The present disclosure satisfies this need.

### SUMMARY OF THE INVENTION

The present disclosure describes a geodesy technique using telecommunication fiber-optic cables for real-time monitoring of subsurface quasi-static deformations. The fiber-optic cables comprise dense arrays of strainmeters, measuring strain rate data by processing the low-frequency content of cable vibration or deformation signals contained in optical backscattering. Predictions can be made using a system-level physical model that governs/determines the time evolution of the underlying source using the strain rate data as input. The model can be a time-evolving inverse physical system model with conservation constraints.

As an example application, the technique was demonstrated to successfully infer future mass movement of dike intrusions near Grindavik, Iceland, on a minute timescale. LFDAS revealed distinct strain responses from nine intrusive events, six resulting in fissure eruptions. Geodetic inversion of LFDAS strain reveals detailed magmatic intrusions, with inferred dike volume rate peaking systematically 15 to 22 min before the onset of each eruption. In active volcanic regions, LFDAS recordings can offer critical insights into magmatic evolution, eruption forecasting, and hazard assessment. Other applications include performing early warnings and detecting precursory ground deformations before other hazardous events such as, but not limited to, landslides, sinkholes, and the precursory slip of earthquakes.

Illustrative embodiments of the inventive subject matter disclosed herein include, but are not limited to, the following:
1. A method for monitoring a source, comprising:
receiving distributed optical fiber sensing (OFS) data from a plurality of channels along at least one optical fiber in an active telecommunications network, the optical fiber in physical contact with ground susceptible to a quasi-static deformation in response to one or more changes in at least one physical state of a source of the quasi-static ground deformation; and
monitoring a change in the source as a function of time using the OFS data comprising or converted to strain or strain rate data and/or processing the OFS data to identify deformation patterns indicative of the quasi static ground deformation.
2. The method of clause 1, further comprising inferring, from or using the strain or strain rate data, future mass movement resulting from the one or more changes.
3. The method of clause 1 or 2, wherein:
   the monitoring or processing uses the strain or strain rate data having temporal frequency components less than about 0.1 Hz (e.g., in a range of 0.005 Hz-0.1 Hz), and/or
   the quasi-static deformation is characterized by the strain or strain rate data temporally filtered with a low pass filter (signal processing) with a maximum cutoff frequency at or below about 0.1 Hz, e.g., thereby retaining minute-scale to hour-scale deformation.
4. The method of any of the clauses 1-3, further comprising performing a geodetic measurement of the ground deformation and/or the source using the strain or strain rate data and wherein the strain-rate data is obtained with minute-scale temporal resolution, comprising sampling intervals in a range of approximately 1 to 120 seconds.
5. The method of any of the clauses 1-4, further comprising processing the OFS data to obtain the strain rate data and optionally wherein the OFS data comprises distributed acoustic sensing (DAS) data.
6. The method of any of the clauses 1-5, wherein the monitoring or processing comprises calculating or determining, from the OFS data comprising or converted to strain or strain rate data, a metric for the source that can be used to infer future mass movement resulting from the one or more changes.
7. The method of clause 6, wherein the metric is the strain rate data above a predetermined threshold with the changes and that is a predictor or forecast of the mass movement corresponding to a sinkhole, avalanche, landslide, mudslide, fault creeping, or magma eruption, or seafloor deformation, the method further comprising: outputting a signal forecasting the avalanche, mudslide, landslide, sinkhole formation, fault creeping, or magma eruption if the strain or strain rate data is above the predetermined threshold.
8. The method of any of the clauses 1-7, the monitoring further comprising outputting the metric, the strain, or the strain rate data in real time with the changes and wherein the metric, the strain, and/or the strain rate data measures the changes at a time scale of 1 minute or less.
9. The method of any of the clauses 1-8, wherein the changes, the ground deformations, the strain, or the strain rate data have a temporal period in a range of 1-6 hours.
10. The method of any of the clauses 1-9, wherein the source and positioning of the optical fiber are such that the OFS data can be processed to measure a strain rate of greater than 0.1 nanostrain per second for the optical fiber in a range of 5 m-50 km of the source and/or a strain having a frequency of more than 0.1 Hz and when at least a portion of the fiber is not in physical contact with the mass movement.
11. The method of any of the clauses 1-10,
receiving, in a computer, the strain rate data measured using the OFS data comprising phase of Rayleigh backscatter from the optical fiber caused by strain applied to the fiber in response to the ground deformation;
receiving, in the computer, source information useful in an algorithm modeling the strain rate data as a function of the physical state of the source; and
calculating a metric comprising a time evolution of the at least one physical state from the strain rate data and the source information.
12. The method of clause 11, wherein the calculating comprises using the algorithm to numerically solve a model for the strain rate data as an inverse problem using a Green's function method, minimizing an objective function, an iterative gradient method, or a least squares method.
13. The method of clause 11, wherein:
the mass movement is a magma eruption at a surface of the ground, the source information comprises:
location and orientation of one or more dikes connected to one or more magma chambers, and
location of the magma chambers, and
the at least one physical state comprises:
dike opening size at different depths as a function of time,
magma chamber deflation volume as a function of time,
and a further input to the computer includes at least one of an elastic property of the surrounding crust or a coupling factor for conversion of the strain rate data to a ground strain.
14. The method of clause 11, wherein source is a source of a sinkhole, the mass movement is ground collapse, the source information includes location of a slip plane, and the physical source state is a deflation or subsurface opening of the slip plane.
15. The method of clause 11, wherein the source is a source of the mass movement comprising a landslide, avalanche, or mudslide, the source information includes a location of the slip plane, and the physical source state is an amount of moving mass e.
16. The method of any of the clauses 1-15, further comprising generating a spatial and temporal map of a subsurface deformation and/or induced subsurface deformation inferred from the strain rate data.
17. The method of any of the clauses 1-16, further comprising processing the OFS data to obtain the strain rate data, comprising:
dividing the fiber into a plurality of the channels each having a gauge length of 5-20 meters (m);
applying a low pass filter (e.g., cut off 0.01 Hz or 0.1 Hz or less) to the OFS data to remove high frequency seismic signals that are not attributed to the ground
deformation (e.g., not attributable to magmatic movement or dike intrusion); applying a first spatial median filter across a plurality of channels to remove common mode noise resulting from temperature fluctuations,
applying a second median filter along both spatial and temporal dimensions to remove the effect of high-frequency earthquake signals and/or traffic signals;
integrating the data in time across each of the channels, and using the integrated signal to obtain strain rate data;
applying a coupling factor to convert OFS strain to actual ground deformation strain (calibrated using GNSS and seismometer data); and
integrating the data along a plurality of neighboring channels to obtain the strain rate data as a function of position along the fiber.
18. A computer-implemented system, comprising:
a computer programmed to:
receive distributed optical fiber sensing (OFS) data from a plurality of channels along at least one optical fiber in an active telecommunications network, the optical fiber in physical contact with ground that experiences a quasi-static deformation in response to one or more changes in at least one physical state of a source of the quasi-static ground deformation; and
monitoring a change in the source as a function of time using the OFS data comprising or converted to strain or strain rate data and/or processing the OFS data to identify deformation patterns indicative of the quasi static ground deformation.
19. The system of clause 18, further comprising the computer programmed to output a warning forecasting the mass movement if the metric is above a threshold value.
20. The system or method of any of the clauses 1-19, further comprising:
an interrogator coupled to, or configured to be coupled, or capable of being coupled to the optical fiber, wherein the interrogator comprises a modulator for modulating telecom signals transmitted into the fiber and a demodulator for extracting the DAS data comprising a phase of the Rayleigh backscattering of the telecom signals from each of the channels; and
the interrogator comprising or coupled to the computer with a link transmitting the DAS data to the computer.
21. The system or method of any of the clauses 1-19, further comprising a network of the optical telecommunication fibers, where two or more fibers are used to provide optical fiber sensing data, and used to monitor the changes in time.
22. The system of any of the clauses 1-21, wherein the channels are distributed along a length of optical fibers in a range of 50 km-10000 km.
23. An apparatus, comprising:
a geodetic sensor or system operable to:
receive distributed optical fiber sensing (OFS) data from a plurality of channels along at least one optical fiber in an active telecommunications network, the optical fiber in physical contact with ground that experiences a quasi-static deformation in response to one or more changes in at least one physical state of a source of the quasi-static ground deformation; and
sense a change in the source as a function of time using the OFS data comprising or converted to strain or strain rate data and/or processing the OFS data to identify deformation patterns indicative of the quasi static ground deformation.

### BRIEF DESCRIPTION OF THE DRAWING

The patent or application file contains at least one drawing executed in color. Copies of this patent or patent application publication with color drawing(s) will be provided by the Office upon request and payment of the necessary fee.

Referring now to the drawings in which like reference numbers represent corresponding parts throughout:

FIG. 1. Flowchart illustrating a method of sensing.

FIG. 2. Flowchart illustrating a method of calculating.

FIG. 3. Flowchart illustrating a method of obtaining strain rate data.

FIG. 4A. Example monitoring of a magmatic system, showing a variety of systems. Volcanic systems can be very different. In the Iceland case, the magma reached to the surface through a horizontally propagating dike (fissure eruptions).

FIG. 4B. Example monitoring of a landslide.

FIG. 4C. Example monitoring of a sinkhole.

FIG. 4D. Example monitoring of seafloor deformation.

FIG. 5. Location map including seismicity, dike geometry, and fiber geometry. The background map includes roads, the city boundary of Grindavik, GNSS stations, active fractures (47), mountain peaks near the dike, and the digital elevation model (48). Colored patches represent the lava fields from the 2023 to 2024 eruptive sequence (36), the 2021 to 2023 Fagradalsfjall eruptions, and the previous eruption period (1210 to 1240 A.D.). The 100-km DAS array starts from Keflavik (inset) near the airport, going southward along the coast and then going eastward, crossing the town of Grindavik. Select channel numbers between 2500 and 6000 are displayed, with their locations marked by red dots R. Earthquake swarms for all nine dike intrusions are color-coded by event, with symbol size scaled by magnitude (M). Lava fissures during all six eruptions are shown. Two sets of grabens formed, one during the November diking event and the other during the January eruption. A 14-km-long linear dike is fitted using the surface lava fissures, and the magma domain is modeled as a Mogi point source.

FIG. 6A-6I. Denoised strain rate recordings over 12 hours during the nine intrusive events. (FIG. 6A) Recording of eruption E1. The intersections of the fiber cable with the dike (black solid line) and grabens (gray dashed lines) formed in November 2023 and January 2024 are marked. The vertical red line represents the eruption time. The black arrow marks the polarity change shortly after the eruption. (FIG. 6B, FIG. 6C, FIG. 6E, FIG. 6G, and FIG. 6I) Similar to (FIG. 6A) but for recordings of eruptions E2 to E6, respectively. The strong noise in (FIG. 6G) after around 16:40 (UTC) was caused by the destruction of the fiber cable by lava. (FIG. 6D, FIG. 6F and FIG. 6H) Recordings of arrested intrusions E4a, E5a, and E6a, respectively. The strain rate amplitudes for E5a (FIG. 6F) and E6a (FIG. 6H) are multiplied by a factor of 10 to enhance the visibility of these two weak events.

FIG. 7A-70. Distribution and evolution of dike opening and seismicity for nine intrusive events. (FIG. 7A to FIG. 7C) The temporal evolution of event E1 is illustrated by colored arrows connecting snapshots of dike opening distribution and its associated seismicity [see (35) for details]. The contours represent 40,60, and 80% of the maximum opening and are color-coded by event. The diamond represents the projection of the Mogi source onto the dike plane. (FIG. 7D to FIG. 7F) similar to (FIG. 7A to FIG. 7C) but for event E2. (FIG. 7G to FIG. 71) Dike opening distribution for events E3, E4a, and E4, respectively. (FIG. 7J) Dike opening for event E5a, which is similar to the initial opening distribution during event E5 in (FIG. 7K and FIG. 7L). (FIG. 7M) Dike opening for event E6a, which is similar to the initial opening distribution during event E 6 in (FIG. 7N and 0). Note that the maximum amplitude in the displacement color bar is 140 cm for E1 and E6; 180 cm for E2; 80 cm for E3, E4a, E4, and E5; and 2 cm for E5a and E6a.

FIG. 8A-8B. Temporal evolution of dike volume and dike volume rate. (FIG. 8A) Dike volume history for all nine intrusive events. The time series are aligned by the eruption time (vertical line at time 0). For noneruptive events (E4a, E5a, and E6a), each time series is shifted such that the dike volume rate correlates with that of eruption E4. (FIG. 8B) Dike volume rate history. Note that, except for E2, all eruptions reach their peak dike volume rate 15 to 22 min before the eruption onset. The two-stage volume increase of E2 may be caused by the secondary supply of magma or pressure increase due to basalt vesiculation.

FIGS. 9A-9F: Map of lava field, eruptive fissures, seismicity, and LFDAS strain during six eruptive events E1-E6. Lava field of the current eruption is in purple P and previous eruptions in light purple LP. Eruptive fissures of the current eruption are in orange and previous eruptions in light yellow. LFDAS strain signal at the end time of the seismicity window is shown. Note the other geological and geographic features on the map are the same as in FIG. 5.

FIGS. 10A-10C: Map of lava field, eruptive fissures, seismicity, and LFDAS strain during three arrested intrusive events E4a, E5a, and E6a. Same as FIG. 9, but for E5a and E6a, the amplitude range of the colorbar is ±1 microstrain.

FIGS. 11A-11I: The 12-hour strain rate recordings during the nine intrusive events before denoising. Similar to FIG. 6, but showing the data before denoising, where spikes caused by earthquakes and the background smooth trend are visible. The number of earthquakes per minute is shown as a solid green line G, with the dark green vertical bar G indicating 10 earthquakes per minute.

FIG. 12A-12B: Average strain rate between channel 4150 and 4240 and dike volume rate for eruptions E1, E3, E4, E5, and E6. (FIG. 12A) Average strain rate for each eruption reaches to peak about 15 to 22 minutes before the eruptions occurred (the line at time 0). (FIG. 12B) Dike volume rate for each eruption reaches to peak at a similar time from about 15 to 22 minutes before the eruption occurred.

FIG. 13A-13H: Determining the scaling between fiber-recorded LFDAS strain to physical ground deformation strain using a local broadband seismometer and the global positioning system (GPS). (FIG. 13A) DAS-recorded surface waves on 30 channels from a section of cable aligned with the great-circle path between the 2024 M7.4 Hualien teleseismic earthquake and Iceland. (FIG. 13B) Similar to (FIG. 13A) but for the 2024 M7.5 Noto Earthquake. (FIG. 13C) Averaged DAS data over the 30 channels in (FIG. 13A). (FIG. 13D) Similar to (FIG. 13C) but for the 2024 M7.5 Noto Earthquake (FIG. 13B). (FIG. 13E) The teleseismic waveforms recorded on the nearby broadband seismometer (II.BORG) for the 2024 M7.4 Hualien Earthquake (FIG. 13A and FIG. 13C). (FIG. 13F) Similar to (FIG. 13E) but for the 2024 M7.5 Noto Earthquake (FIG. 13B and FIG. 13D). (FIG. 13G) Map of the two earthquakes and the broadband seismic station. (FIG. 13H) Variance reduction of LFDAS strain for different scaling factors in joint inversion with both LFDAS and GPS for eruption E1. A scaling factor of 3.2 produces the highest variance reduction.

FIG. 14A-14I: Data fitting (strain) for nine intrusive events. In each panel, the observed stain data is on the top and the strain data modeled using the inverted dike opening and Mogi volume decrease is at the bottom. For eruptive events, we denote the eruption time using a horizontal line. The white gap in the modeled strain means channels in that section are masked and are not used for inversion. For eruption E2 (panel FIG. 14B), we mask channel 3550-3800 since this section contains large strain signals caused by local graben movement. We mask channel 3420-3750 for event E5a (FIG. 14F), channel 3350-3660 for event E5, channel 3200-3750 and 5800-6000 for event E6a, and channel 3300-3500 for event E6 since these channels contain abnormal large strain noise.

FIG. 15: Snapshots of dike opening evolution of eruption E2. Similar to FIG. 7D-3F in FIG. 7, but with time interval of 5 minutes. The dark dot within each panel tracks the migration of magma pocket.

FIG. 16A-16B: Migration speed of the magma pocket during eruption E2. (FIG. 16A) The scattered points represent centers of magma pockets from FIG. 15. The background color indicates the cumulative opening from all snapshots in FIG. 15. The propagation of the magma pocket can be divided into two stages, represented by red R and blue B respectively. (FIG. 16B) shows the propagation speeds in each stage, where the distance is measured from the first point in each stage from the first dot. FIG. 15. The migration speed slows down from 0.9 m s⁻¹ to 0.2 m s⁻¹ as the magma pocket reaches to a depth of about 1 km.

FIG. 17A-17I: Volume and volume rate history for both the dike and the Mogi source for all intrusive events (FIG. 17A) Increased volume (top panel) and volume rate (bottom panel) history for the dike and decreased volume and volume rate for the Mogi source during eruption E1. The vertical line represents the eruption time. Similar plots for subsequent events are in (FIG. 17B-17I).

FIG. 18A-18G: Cumulative dike opening including the November dike intrusion. (FIG. 18A) shows the smoothed opening of the November 2024 dike (11) projected into the panel of our dike models [see (35)]. The contours are then indicating the location of E1 and opening, with contours shown representing 20, 40, 60, 80, and 100 cm. (FIG. 18B) shows the cumulative model with the addition of E1, but contours show the outline of E 2. The panels continue in this way accounting for E1-3,E4a, E4-6. It is notable that large opening tends to occupy shallow levels where less magma has been emplaced or the boundaries of the November dike.

FIGS. 19A-19G: Cumulative dike stress including the November dike intrusion. This figure is equivalent to FIG. 18 but showing the changes in normal stress on the dike plane due to the cumulative opening [see (35)]. This comparison demonstrates the November 2024 dike had a very significant contribution to the stress field, generating a zone of increased compression at depth, but increased tension at shallow levels. This shallow zone is then where the subsequent eruptive dikes occur, which modify some parts to relative compression.

FIG. 20A-20E: Inversion of a coupled dike and chamber model. (FIG. 20A) Misfit between normalized observed dike volume rate and synthetic dike volume rate by grid-searching the three dimensionless parameters (α, Ψ, and R). The blue dot B represents the parameter set with the smallest misfit. The orange dot O represents an end-member case with a relatively small misfit. (FIG. 20B) Comparison between observed normalized dike volume rate curve and the synthetic dike volume rate curve based on the two parameter sets in (FIG. 20A). (FIG. 20C) Initial overpressure Δp0 at the dike inlet given different magma viscosity ηm. (FIG. 20D) Parameter c given different initial overpressure Δp0. (FIG. 20E) Magma chamber volume Vc given different magma chamber compressibility βc.

FIG. 21A-21F: Predicted GPS horizontal displacements, InSAR line of sight (LOS) displacement, and wrapped phase for events E5a and E6a. (FIG. 21A) Predicted GPS horizontal displacements given the dike opening and volume decrease from event E5a. (FIG. 21B) Predicted LOS displacement from event E5a. (FIG. 21C) Predicted wrapped phase given the LOS displacement in (FIG. 21A) and a noise level of 0.2 cm. (FIG. 21D) Similar to (FIG. 21A) but for event E6a. (FIG. 21E) Similar to (FIG. 21B) but for event E6a. (FIG. 21F) Similar to (FIG. 21C) but for event E6a.

FIG. 22: Map of fiber geometry and GPS locations for the resolution test. We use LFDAS channels 2500 to 6000 and 42 three-component GPS stations for the resolution test. Note that much fewer GPS stations may be available in practice.

FIG. 23A-23C: Resolution test to verify which part of the dike can be robustly resolved with LFDAS strain. (FIG. 23A) Input dike model with a Gaussian opening centered at each grid. We plot the opening model every 8 grids along the strike and every 5 grids along the dip. The number 100 represent the total volume of the dike opening. The contours are 40%, 60%, and 80% of maximum opening amplitude. (FIG. 23B) Similar to (FIG. 23A) but for the inverted dike model. Note that the inverted opening pattern and total volume is very similar to the input ones. (FIG. 23C) Correlation coefficient between the input model and inverted model at each grid. Grids with correlation coefficient smaller than 0.9 are further penalized with a ZOT regularization term as seen in equation S1

FIG. 24A-24H: Checkerboard test to illustrate the resolution power of LFDAS recordings. (FIG. 24A-24B) Input models. Model in (FIG. 24A) has a total dike opening volume of 10 million m³. Model in (FIG. 24B) mask the opening from the surface to 2 km depth. (FIG. 24C-24D) Inverted model using only LFDAS strain. (FIG. 24E-20F) Inverted model using only GPS displacements. (FIG. 24G-24H) Jointly inverted model using both LFDAS strain and GPS displacements. Note that the LFDAS strain shows higher resolution near the fiber cable and better resolution at depth. Joint inversion with both LFDAS strain and GPS displacements can further enhance the resolution on the northeast section of the dike and at deeper depth as indicated by the black arrows.

FIG. 25A-25D: Resolution test to show both the dike opening volume and Mogi source decreased volume can be resolved. (FIG. 25A) Input model dike opening distribution. The volume of dike opening is 3 million m³ and volume of Mogi source deflation is 1 million m³. (FIG. 25B) Inverted dike opening using LFDAS has a total volume increase of 3.38 million m\hat{ }3. (FIG. 25C) Data residual norm with respect to Mogi source volume change. The optimal volume decrease of Mogi source is 0.96 million m³, which is very close to the input value. (FIG. 25D) Data fitting between the observed strain and modeled strain.

FIG. 26 is a diagram of an exemplary interrogator coupled to or comprising a computer for distributed acoustic sensing (DAS) according to one or more embodiments.

FIG. 27. Example hardware environment.

FIG. 28. Example network environment.

### DETAILED DESCRIPTION OF THE INVENTION

In the following description of the preferred embodiment, reference is made to the accompanying drawing which forms a part hereof, and in which is shown by way of illustration a specific embodiment in which the invention may be practiced. It is to be understood that other embodiments may be utilized and structural changes may be made without departing from the scope of the present invention.

### Technical Description

Illustrative embodiments of the inventive subject matter described herein comprise a fiber-optic geodesy technique for (e.g., real-time) monitoring of subsurface quasi-static deformation with high spatiotemporal resolution using telecommunication fiber-optic cables. Specifically, the approach can turn fiber-optic cables into dense arrays of strainmeters by utilizing the low-frequency content of cable vibration or deformation signals through, e.g., measuring Rayleigh backscattering.

Fiber-optic geodesy presents several advantages over modern geodetic observation technologies such as the GNSS and InSAR described above.

Firstly, fiber-optic geodesy has unprecedented temporal resolution. For example, we used this method to image the magma movement during dike intrusion events at minute time scale, which is unattainable with GNSS or InSAR, as GNSS requires daily averaging to achieve millimeter-level precision, while InSAR takes days to weeks to provide repeat measurements.

Secondly, fiber-optic geodesy demonstrates enhanced sensitivity over GNSS and InSAR. In this disclosure, we identified two small dike intrusions, each with an opening displacement of about 1 cm at a depth of about 1 km, which local GNSS stations or InSAR did not detect due to their higher noise levels. This fundamental advantage can significantly improve and complement existing geodetic observation systems. Moreover, this method achieves high-temporal resolution and low noise levels with minimal data processing, which enables a real-time monitoring system. This system has successfully assisted the Icelandic Meteorological Office (IMO) in issuing early warnings for the latest three volcanic eruptions.

Thirdly, using the existing telecommunication fiber network, this method can measure subsurface deformation in both onshore and offshore environments. Offshore settings present significant challenges for satellite-based geodetic observations.

Conventional seafloor geodetic measurements using mechanical or acoustic systems are often expensive and technically challenging. Fiber-optic geodesy can significantly improve the ability to monitor terrestrial or seafloor deformations (e.g., near active subsea volcanoes or landslides). Applications of the monitoring technology are wide ranging including, but not limited to, scientific applications, public safety, mitigation of damages, and could be used during insurance claims adjusting or for reduction of insurance premiums.

### Example Geodesy Method

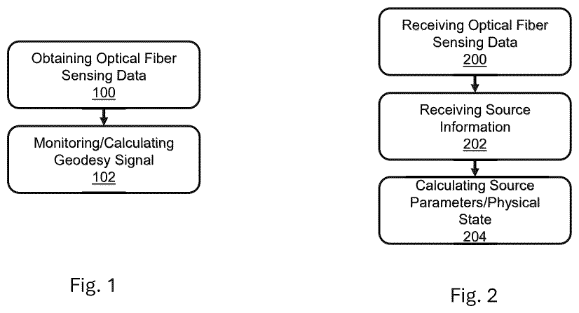

FIG. 1 is a flow chart illustrating a method for detecting and monitoring a source. The method comprises the following steps.

Block 100 represents receiving optical fiber sensing (OFS) data from a plurality of channels along at least one optical fiber in an (e.g., active) telecommunications network, the optical fiber in physical contact with ground that experiences a quasi-static deformation in response to one or more changes in at least one physical state of a source of the quasi-static ground (or geologic structure) deformation. Examples of optical fiber sensing data include, but are not limited to, any data reflecting a change in a property of the optical fiber [59], such as change in fiber length, cable vibration, deformation of the fiber, temperature, polarization (state of polarization, SOP) or photo-elastic properties (e.g., change of refractive index due to stress/strain), or distributed acoustic sensing (DAS) data. As needed, the optical fiber sensing data can be processed to obtain the strain rate data. Interferometry multispan techniques can also be used [61].

Example geological structures or ground include, but are not limited to, the crust or a subsurface of the ground of the Earth, a planet, or other astrophysical object.

Typical examples of telecommunications networks include those actively being used for public communication (public internet, cable, telephone) rather than dedicated cables for sensing applications. The channels can be distributed over varying lengths of fiber networks (10-10000 km) to provide wide area sensing.

Block 102 represents monitoring or sensing a change in the source, or obtaining/sensing geodesy data as a function of time using the optical fiber sensing data comprising or converted to strain rate data. The step can comprise represents determining (e.g., calculating), from the OFS data comprising or converted to strain rate data, a metric for the source that can be used to infer future mass movement resulting from the one or more changes.

In one embodiment, the metric is the strain rate data above a predetermined threshold with the change that is a predictor or forecast of an event or mass movement such as, but not limited to, formation of sinkhole, avalanche, landslide, mudslide, fault creeping, or magma eruption. For example, the monitoring can comprise outputting a signal forecasting the avalanche, mudslide, landslide, sinkhole formation, fault creeping, or magma eruption if the strain rate data is above the predetermined threshold.

In some embodiments, the monitoring comprises outputting a signal measuring the change in real time with the change. The forecast signal can comprise an early warning signal that forecasts the event (e.g., hazardous mass movement or mass flow) to either provide sufficient time for mitigation to prevent or suppress damage to surrounding infrastructure (e.g., building) caused by the mass movement, or allow evacuation prior to the event occurring. In some embodiments, the warning signal is provided at least 15 minutes prior to the event/mass movement occurring.

In some embodiments, the monitoring outputs a signal measuring the changes comprising a physical evolution of the source at a time scale of 1 minute or less. In yet further examples, the change and/or ground deformation has a temporal period in a range of 1-6 hours.

In one or more embodiments, the source and positioning of the optical fiber are such that the OFS data can be processed to measure a strain rate of greater than 0.1 nanostrain per second for the optical fiber in a range of 5 m-50 km of the source and/or a strain having a frequency of more than 0.1 Hz and when at least a portion of the fiber is not in physical contact with the mass movement.

In yet further embodiments, step comprises generating a spatial and temporal map of subsurface deformation or induced subsurface deformation inferred from the strain rate data. For example, OFS data from undersea optical fibers can be used to map transcontinental seafloor deformation, e.g. using multispan subsea monitoring to create dynamic maps of the seafloor. Currently, only static seafloor maps exist but changes of subsurface OFS data from subsea cables can be used to create dynamic maps, e.g., of movement of continents on the scale of a few millimeters a year, or fault dynamics.

For example the measured strain can be used to map, as function of time and space, how much the crust has deformed in response to various sources.

FIG. 2 illustrates an embodiment for monitoring or otherwise obtaining a geodesy signal.

Block 200 represents receiving, in a computer, the strain rate data measured using the optical fiber sensing data (e.g., comprising phase of Rayleigh backscatter from the optical fiber caused by deformation of the fiber in response to the change).

Block 202 represents receiving, in the computer, source information useful in an algorithm modeling the strain rate data as a function of the physical state of the source. Example source information could include the location of slip planes for the formation of avalanches, mudslides, landslides, or sinkholes. In another example where the source comprises dikes connected to magma chambers, the source information could be dike geometry (location, strike, depth, dimensions) and magma chamber (point source) location. Further inputs to the model may include elastic properties of the surrounding crust (at least one of shear modulus, bulk modulus, or Poisson's ratio) and coupling factor for DAS strain conversion.

Block 204 represents calculating at least one the physical state (e.g., structural property) of the source and time evolution of the physical state; and monitoring the source using the time evolution of the physical state.

The calculating can comprise using the algorithm to numerically solve a model for the strain rate data as an inverse problem using a Green's function method, minimizing an objective function, an iterative gradient method, or a least squares method.

Alternatively stated, the inverse model is used to work backward from measured deformation to estimate the physical source causing it using a known response function,

In one or more embodiments, an inverse model is employed to reconstruct a hidden physical source state from measured deformation data (strain or strain rate data), wherein the reconstructed state is constrained for physically plausible behavior or wherein the reconstructed state is constrained by one or more conservation laws that physically couple successive reconstructions in time and prevent non-physical behavior. In one or more embodiments, a conservation-constrained inverse model estimates unobserved source or structural properties from distributed measurements while enforcing physical balance relationships across time). In one embodiment, an inverse model is used to work backward from measured deformation to estimate the physical source state causing it, e.g., using a known response function, while enforcing conservation or constraints so the estimates remain physically realistic over time.

In one or more embodiments, e.g., for or the data presented herein, regularizations can be used to invert for the spatially and temporally continuous source state to promote physically plausible behavior of the source state. For the data presented herein, the inversion was performed independently for each time step, and within each time step, the spatial smoothing was applied. In the next step, it was desirable to smooth the inversion along the time axis as well.

For example,

$$d ( x , t ) = ℛ [ s ( x , t ) ]$$

Where d is the deformation (strain or strain rate data), R is the response function (can be quasi static), and s(x, t) are the source states as a function of time. The equation can be solved using

$$s ( x , t ) = arg {min}_{s ( x , t )} ‖ {d}_{obs} ( t ) - ℛ [ s ( x , t ) ] ‖ subject to 𝒞 ( s ( x , t ) , s ( x , t - Δ t ) ) = 0$$

where s (x, t) represents the source side spatial opening distribution or source state and its evolution over time. In the inversion scheme used in the working example, the inversion was performed independently for each time step. Within each time step, the spatial regularization was applied. In other embodiments, it may be desirable to make the inversion smooth along the time axis as well. Therefore, the constraints (C) equations could include smoothing/regularization along both t, and x.

An example includes equation S2:

$$m , {V}_{c} , = {arg min}_{m , {V}_{c}} \{ {‖ {G}_{reg} m - ( d - {V}_{c} {G}_{c} ) ‖}^{2} \}$$

In a least squares solution using Green's a response function

$$s ( t ) = arg {min}_{s} {‖ {d}_{obs} ( t ) - {G}_{s} ‖}^{2}$$

Where G is the response function in linearized form suitable for solution using matrix methods:

$$( {G}^{T} G ) s ( t ) = {G}^{T} {d}_{obs} ( t )$$

In one or more embodiments, the modeled system can be assumed to equilibrate between successive source states, such that deformation at each time corresponds to a mechanical equilibrium response to the instantaneous source state. In one or more embodiments, a quasi-static assumption allows the response function to be applied independently at each time step and the temporal evolution of the source state is such that (after each incremental change in the source, the surrounding medium rapidly relaxes to mechanical equilibrium, and the observed deformation corresponds to that equilibrium state. In some embodiments, a quasi static deformation is that which can be modeled as described herein, and/or slow moving deformations characterized strain data filtered with a low pass filter with a maximum cut-off at or below 0.1 Hz (the deformation and/or the strain/strain rate data having temporal frequency components less than about 0.1 Hz (e.g., in a range of 0.005 Hz-0.1 Hz) or characterizable by geodetic strain measurements.

The response function is known a priori as an input—example response functions or models include, but are not limited to, an Okada half space model

In some embodiments, the boundary conditions that drive deformation are not prescribed but are instead recovered as part of the time-evolving, conservation-constrained inverse model, rather than being externally imposed and known beforehand. The boundary conditions can refer to the source-side forcing conditions that drive the observed deformation and are treated as unknowns in the inverse problem. Examples of such boundary conditions include the time-dependent opening displacement in the dike.

In some embodiments, the calculating can comprise processing the strain data using a model relating the strain data to input parameters describing the ground deformation, and wherein the input parameters are iteratively adjusted so that a difference between the strain data and calculated strain data using the parameters is minimized (minimizing an objective function).

In one or more embodiments, measured deformation (strain data) acquired as a function of time are analyzed using the known response function to reconstruct a corresponding physical source state through the inverse solution. Once the source state is reconstructed, its magnitude, spatial distribution, and temporal evolution may be evaluated relative to known physical failure criteria, stability thresholds, or conserved quantities. Because the source state represents the underlying physical process driving deformation—such as accumulated slip, pressurization, volumetric expansion, or material weakening—the reconstructed source history provides a basis for assessing whether the system is approaching a catastrophic failure condition, including rupture, collapse, eruption, or runaway instability, thus allowing a prediction to be made.

In a Green's function method, the model can comprise a quasi static response function relating the strain rate data to the source parameters. The response function can be calculated using the source information and assumed to be essentially time invariant (quasi static). The Green's function can be calculated with numerical methods (FEM) using elastic parameters such as shear and bulk modulus. The model can simulate a series of patches along the dike or slip plane, and the method can solve a matrix equation (e.g., set of N linear equations) with the N unknowns being the physical state at each of the patches and the knowns being strain rate data provided from at least N different channel locations.

Example models include an Okada elastic half space model, using for example, Okada dislocation sources and optionally a Mogi point source.

### Example Filtering Method

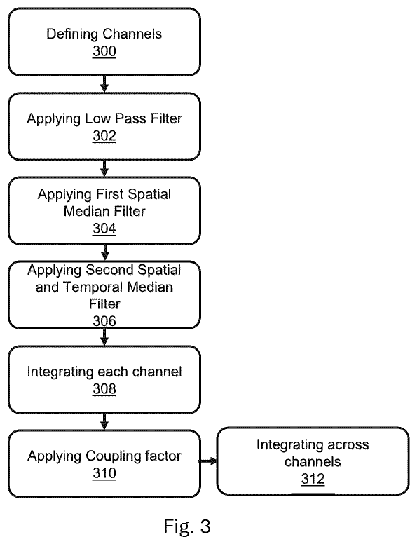

FIG. 3 illustrates a processing the optical fiber sensing (e.g., DAS data) to obtain the strain rate data.

Block 300 represents dividing the fiber into a plurality of the channels each having a gauge length of 5-20 m.

Block 302 represents applying a low pass filter (e.g., cut off 0.01 Hz or less or 0.1 Hz or less) to the data to remove high frequency seismic signals that are not attributed to the ground deformation (e.g., not attributable to magmatic movement or dike intrusion).

Block 304 represents applying a first spatial median filter across a plurality of channels to remove common mode noise resulting from temperature fluctuations.

Block 306 represents applying a second median filter (e.g., spatial and temporal median filter) along both spatial and temporal dimensions to remove the effect of high-frequency earthquake signals and/or traffic signals. This procedure can be in other formats, for example, machine learning models can be used to achieve similar effects.

Block 308 represents integrating the data in time across each of the channels, and using the integrated signal to obtain strain rate data.

Block 310 represents optionally applying a coupling factor to convert strain to actual ground deformation strain (calibrated using GNSS and seismometer data).

Block 312 represents integrating the data along a plurality of neighboring channels to obtain the strain rate data as a function of position along the fiber.

The number of channels can span an extensive network of optical fibers, e.g., 1-100 km range. Low frequency algorithms as described herein (e.g., FIG. 3) can also be applied for obtaining OFS data from long haul telecom cables, to receive strain rate data along 1,000 to few thousand km span of optical fiber, and allow monitoring with a single device (interrogator).

### Example Applications

### 1. Forecasting Magma Eruption

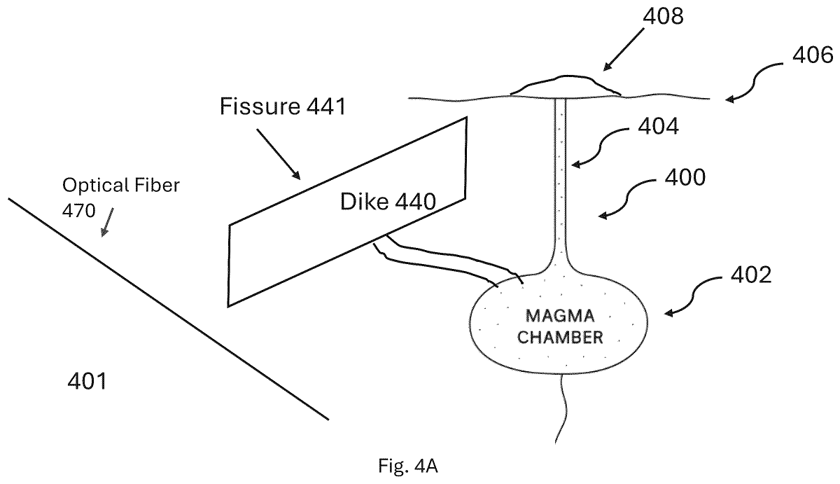

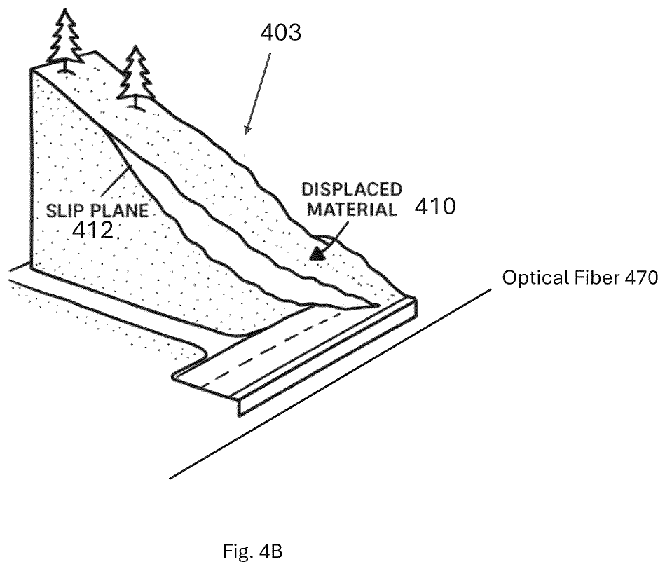

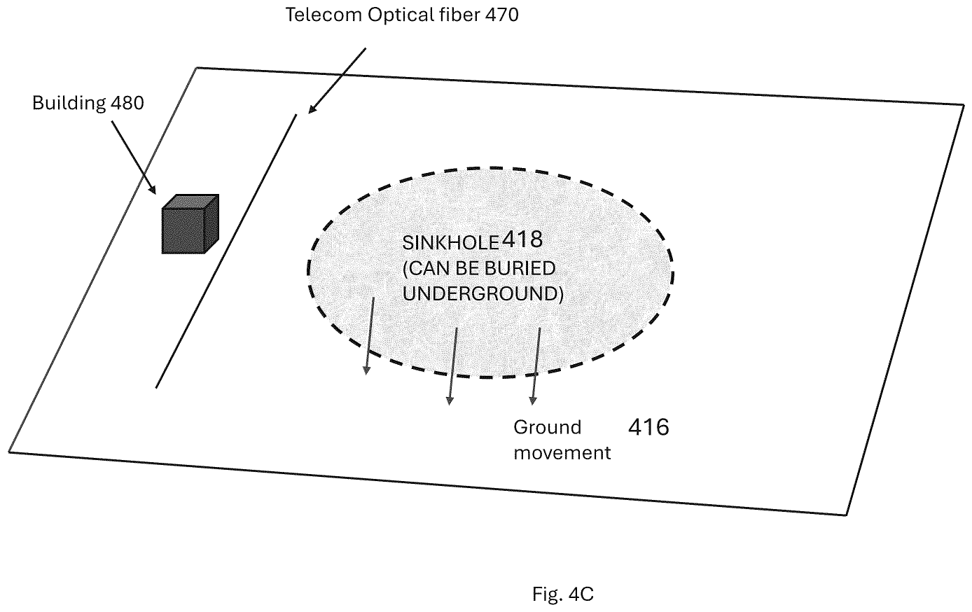

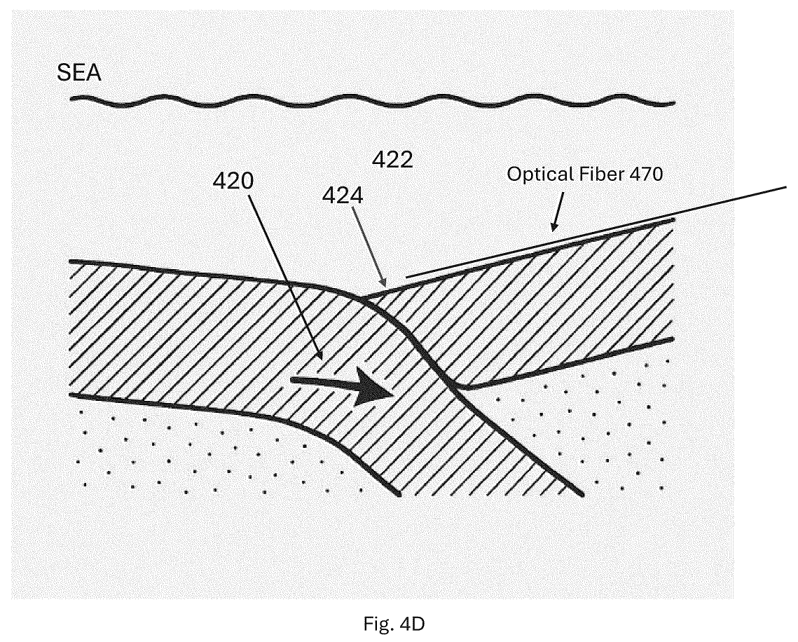

FIG. 4A illustrates a region of the Earth comprising dikes having inlets connected to a magma chambers. The source information includes location and size of the magma chambers and location and geometry (e.g., orientation or strike) of the dikes. The physical state(s) being calculated comprise dike opening size at different depths as a function of time and magma chamber deflation volume as a function of time. Further inputs to the model include elastic properties of the surrounding crust (Poisson's ratio) and coupling factor for DAS strain conversion.

The model (e.g., Okada model) models the magma chamber as a reservoir pushing magma upward, the dike as a crack that opens when magma pressure is above a threshold, a driving force associated with magma pressure inside the chamber and dike, and a resistance to magma flow comprising the weight and stiffness (elastic modulus) of the overlying crust which pushes back to close the crack.

In one embodiment, the method comprises repeatedly running the forward model with different guesses for dike opening and deflation until the predicted strain matches the measured strain. However, other methods as described herein, such as a Green's function method or statistical methods, can be used.

The method can comprise further comprising forecasting an eruption 408 (magma erupting from the ground surface 406) if:
the strain rate data/metric is above a threshold value, and/or
(ii) geometry changes (e.g., if dike opening reaches the surface 406 and/or magma chamber deflation indicates large magma transfer).

As discussed above, the strain data can be used to generate tomographic maps, e.g., of magma pressure (indicating threshold sufficient to overcome crustal resistance and tensile strength) and create the ground deformation or stress gradient in the surrounding crust. As is known in the art, strain can be converted to pressure using Shear modulus (μ) Bulk modulus (K) Poisson's ratio (v), and dike opening and deflation can be inferred from pressure.

Volcanic systems can be very different. In the Iceland case, the magma reached to the surface through a horizontally propagating dike 440 (fissure 441 eruptions).

In one or more examples, the optical fiber 470 can be crossing the dike or not crossing the dike (remotely positioned).

### 2. Forecasting Landslides, Avalanches, Mudslides

FIG. 4B illustrates an example where the region source comprises a source of a mass movement 410 comprising a landslide, avalanche, or mudslide, the source information comprises location of slip planes 412, and the physical source state being calculated includes mass.

The landslides/avalanches/mudslides involve the mass moving on the surface and the source state/physical state would be the amount of mass that has been moved, which caused shear loading on the boundary between the moving mass and the basement, and vertical load/unload due to mass redistribution. This can be modeled using Boussinesq solution (elastic half-space due to point load on the surface), Cerruti solution (tangential loads on the surface), or Boundary Element Method (BEM) or Finite Element Method (FEM) modeling for complex geometries, for example [65]. IN this example, the optical fiber 470 is along a road, although other positionings are possible.

### 3. Forecasting Sinkhole Formation.

FIG. 4C illustrates an example where the source comprises a source of a mass movement 416 comprising ground collapse forming a sinkhole 418, the source information includes location of slip planes and the physical source state modeled as a deflation source, for example. In some examples, the sinkhole can be treated as ‘deflation’ source, wherein a deflation Mogi source or closing sill (penny-shaped crack) can be used to model the surface strain response. In one more embodiments, more generally Discrete Element Method (DEM) modeling can be used for modeling the granular flow.

In one or more examples (generally applicable, not just for sinkhole applications), the interrogator and/or computer can be located in a residential or commercial/industrial building 480 with optical fiber service, wherein the optical fiber 470 (or cable including fiber 470) is used for local sensing of mass movement as used herein. Alternatively, the interrogator and/or computer system can be located at a remote location, e.g., a network operation center, cable landing station. Predictions can be used for assessing insurance claims, for example.

### 4. Monitoring of Seafloor Deformation

FIG. 4D illustrates an example where the source comprises a source of tectonic movement 420, the mass movement comprises undersea 422 eruptions or ground deformation 424 detected by the optical fiber 470. The subsea fissure eruptions or earthquake response can still be modeled using the Okada model. The Okada model can model the surface deformation responses from opening (due to magma intrusion)/shear dislocation (due to slip on fault plane) for a rectangular patch in a homogeneous half space. Analytical models for other simple geometries include: Mogi source (spherical deep chamber), the Fialko model (2001) (penny-shaped crack for modeling horizontal sill), the Bonaccorso and Davis (1999) model to model the response of pressurized magma pipes). Or more generally modeled by BEM or FEM methods [66, 67].

### Working Example: Minute-Scale Dynamics of Recurrent Dike Intrusions in Iceland with Fiber-Optic Geodesy (See Also [64])

### Experimental Setup

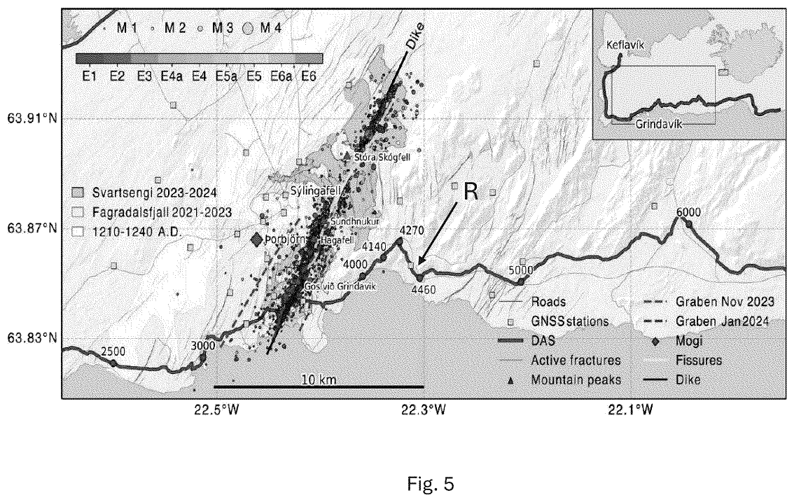

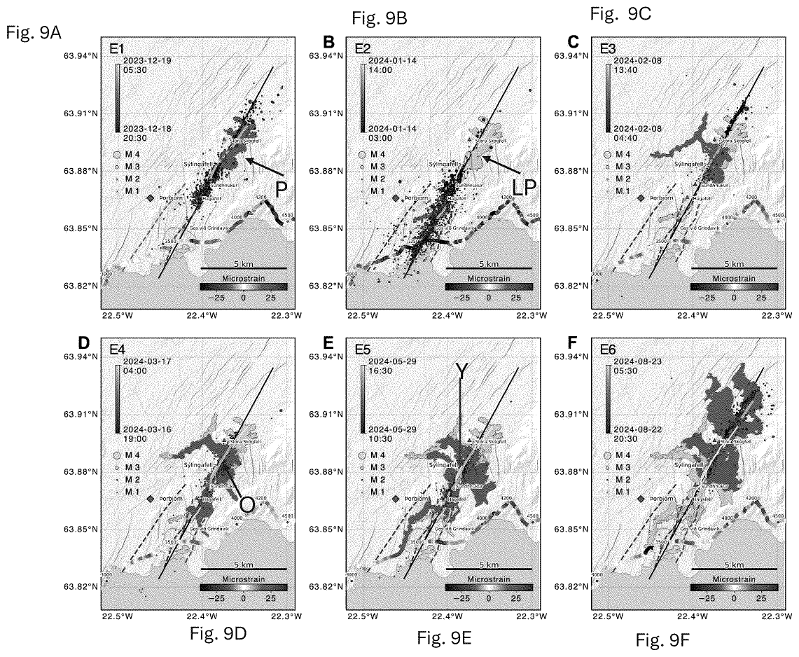

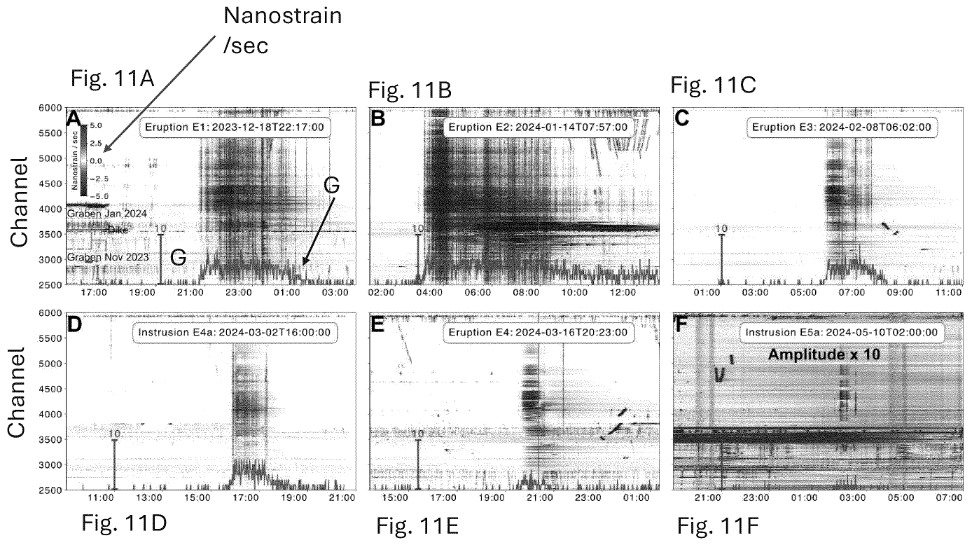

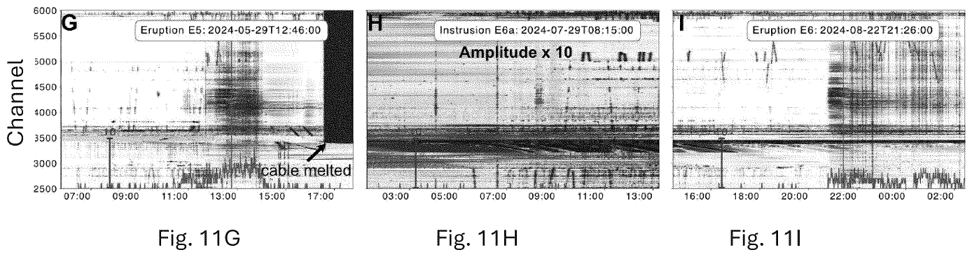

In the experimental study, we utilized a telecommunication fiber cable as a dense array of strainmeters. We used LFDAS recordings to capture rapid magma intrusion dynamics with minute-scale temporal resolution during the 2023 to 2024 intrusion sequence in Iceland (11, 34). On 10 Nov. 2023, a 15-km-long linear dike formed below the Sundhnnkur crater row in the Svartsengi volcanic system, passing below the town of Grindavik in the Reykjanes Peninsula in southwest Iceland. The diking event was concurrent with the deflation of a magma source at a depth of about 4.1 km to the northwest of Grindavik (11). Ten days later, we deployed a DAS interrogator in Keflavik, converting a 100-km-long fiber cable running along the coastline and through Grindavik into a DAS array with about 10,000 recording channels. Following the November dike event, inflation continued in the region, accumulating magma over several months, followed by rapid deflation during dike intrusions. During our recording period from 20 Nov. 2023 to 14 Nov. 2024, nine diking events occurred, six of which resulted in fissure eruptions, and three of which were arrested before reaching the surface. We denote the eruptive events as E1 to E6, whereas the three arrested intrusions preceding events, E4, E5, and E6, are labeled as events E4a, E5a, and E6a, respectively (FIG. 5, and FIGS. 9 and 11). The first eruption (E1) started on 18 Dec. 2023, with surface fissures extending from the Sundhnnkur craters to about 1 km north of Stóra-Skógfell (Ain FIG. 9). The second eruption (E2) on 14 Jan. 2024 occurred near Grindavik, destroying several houses there and reaching Mt. Hagafell to the north (B in FIG. 9). Subsequent eruptions and intrusions, as inferred by the extent of fissures and seismicity, were spatially confined to the areas of the first and second eruptions, except for the last recorded eruption, E6 on 22 Aug. 2024, which extended about 2 km north of Stóra-Skögfell (FIGS. 9 and 11).

Turning a Telecommunication Cable into Geodetic Sensors

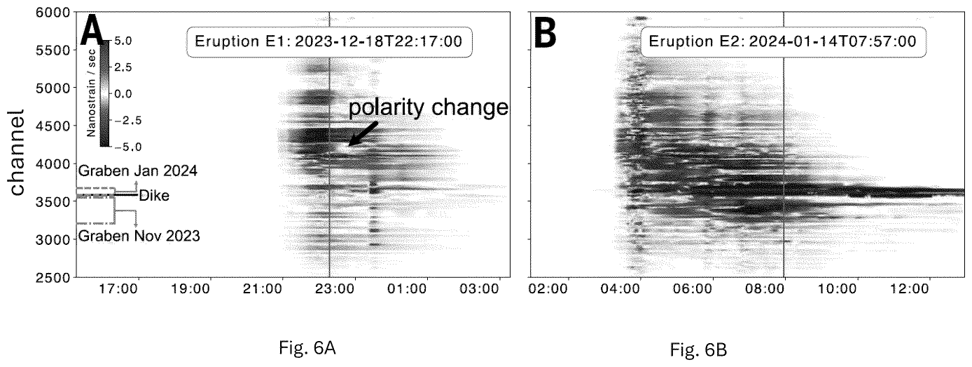

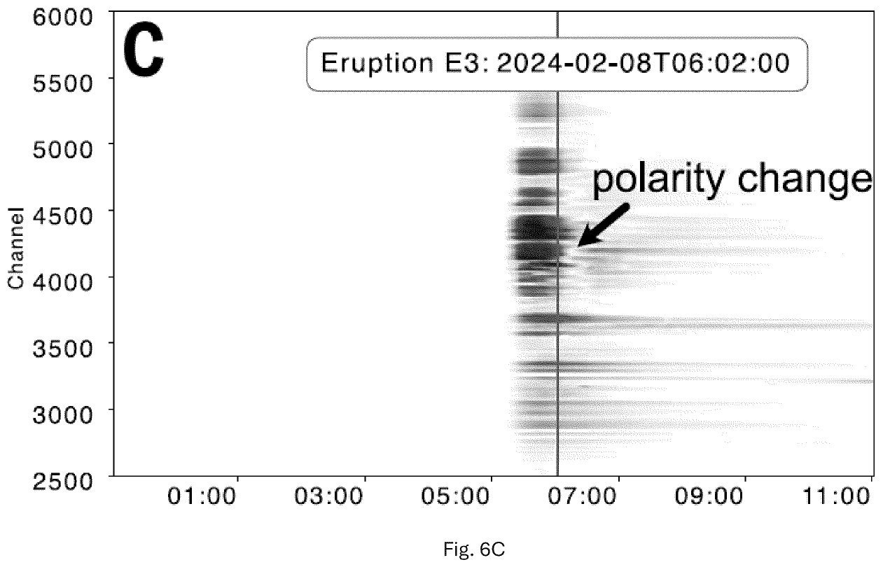

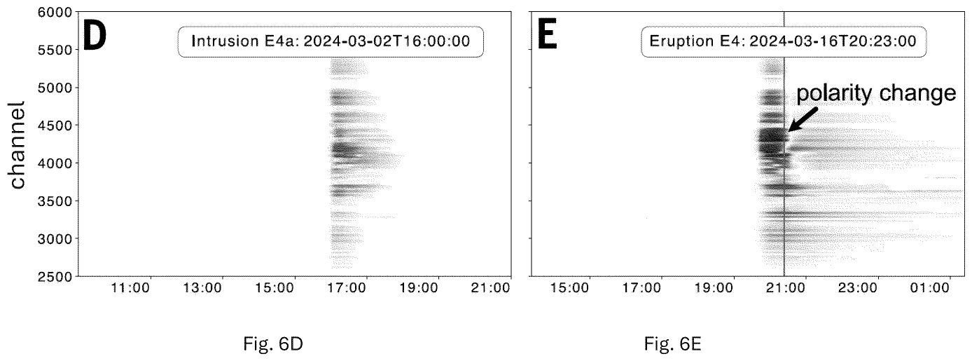

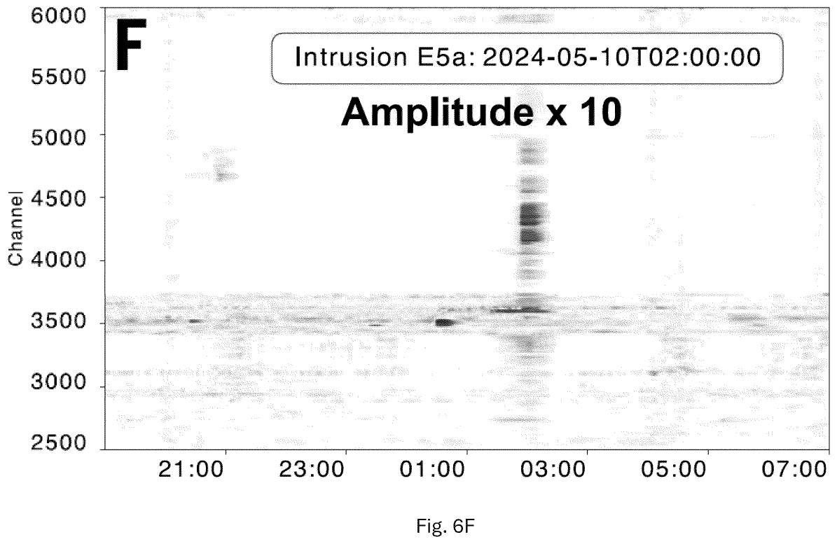

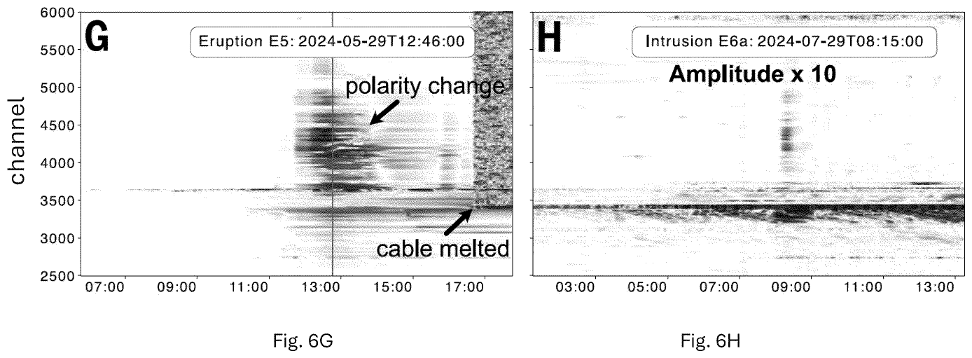

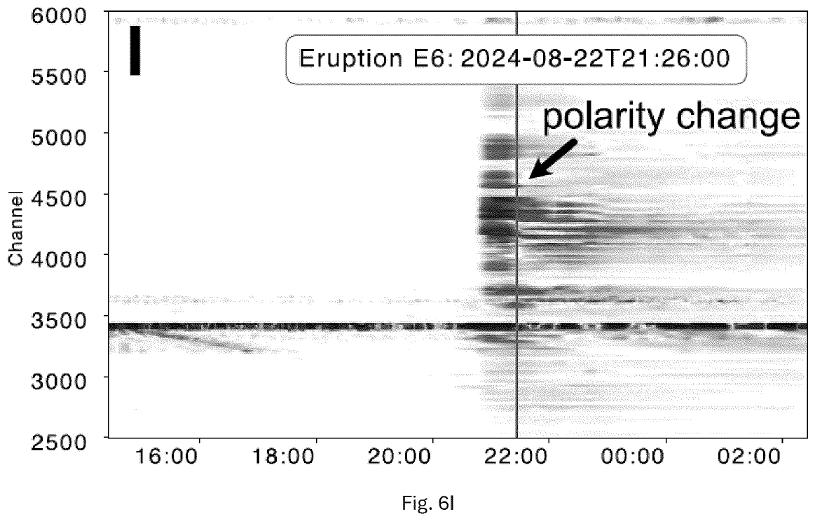

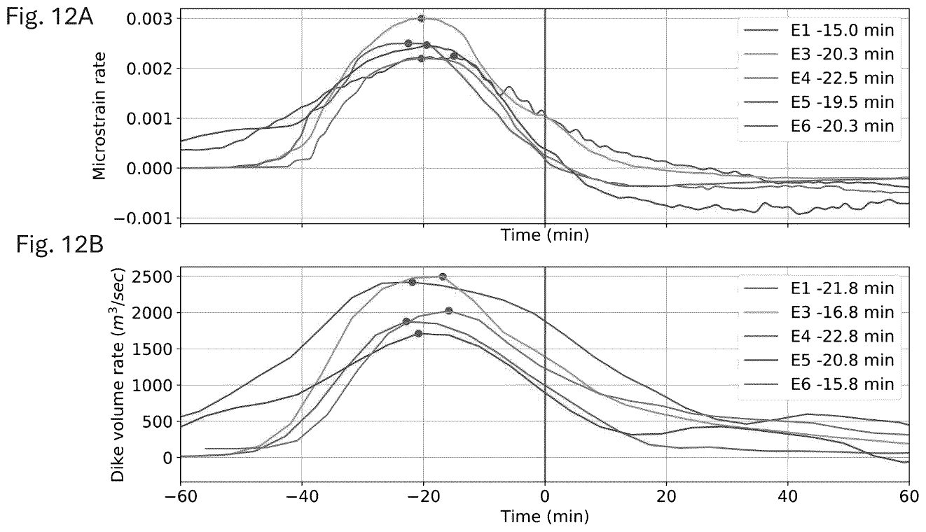

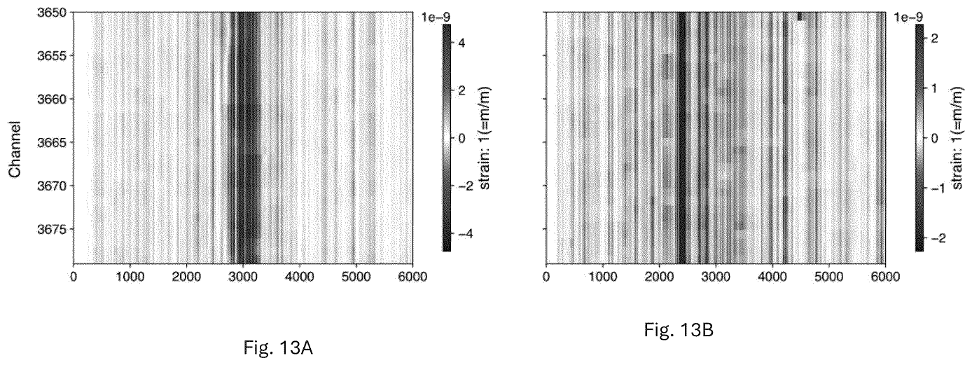

We observed distinct strain-rate signals on the DAS array for all nine intrusive events after applying a low-pass filter with a 0.01-Hz cutoff frequency and a spatial median filter to remove common-mode noise [see (35) for details]. These signals (smooth blue and red, FIG. 6 and FIG. 11) emerged tens of minutes to hours before eruptions and persisted for hours, concurrent with increased seismic activity (FIG. 11). Arrested intrusions exhibited weaker strain-rate responses and shorter durations compared with that of eruptive events. Early LFDAS recordings of all intrusive events consistently show a positive strain rate (i.e., extension) between channels 4140 and 4270 and a negative strain rate (i.e., compression) between channels 4270 and 4460 (FIGS. 5 and 6), suggesting that the magma fed through a common inlet at the bottom of the dike. For all eruptive events, except for E2, the strain rate along these sections peaked about 15 to 22 min before the eruption (A in FIG. 12). Additionally, strain-rate polarity flipped shortly after eruptions, whereas no polarity changes were observed during arrested intrusions (FIG. 6). The post-eruption polarity change may indicate a pressure drop in the dike as the fissure formed.

The strain-rate signals for E2 lasted the longest, with a duration of more than 10 hours, and displayed a progressively localized spatial pattern (B in FIG. 6 and B in FIG. 11), suggesting that the magma was approaching the fiber cable. Around 6:00 (UTC) on 14 Jan. 2024 a large strain-rate response emerged, centered around channel 3600. It eventually accumulated to the largest strain recorded on this DAS array with no saturation, with an amplitude of ~1000 microstrain. This signal corresponds to the development of a graben beneath the fiber cable, formed during this dike intrusion and similar to that formed during the November dike intrusion (11). By contrast, strain responses corresponding to the distant dike openings mostly had amplitudes of tens of microstrain. During arrested intrusions E5a on 10 May 2024 and E6a on 29 Jul. 2024, strain signals lasted less than an hour and had maximum amplitudes of around 0.1 microstrain.

At about 16:30 (UTC) on 29 May 2024, the fiber cable west of Grindavik was melted by lava during eruption E5, which disabled recordings beyond channel 3437. A week later, a 650-m temporary surface fiber was deployed by the electronic communication company Ljósleidarinn to replace the damaged section, restoring both telecommunication and DAS array recordings. However, this surface cable segment (channel 3389 to 3454) exhibited higher noise levels, as seen in E6a and E6, and was excluded from subsequent analyses.

Dike Intrusion Dynamics from LFDAS Recordings

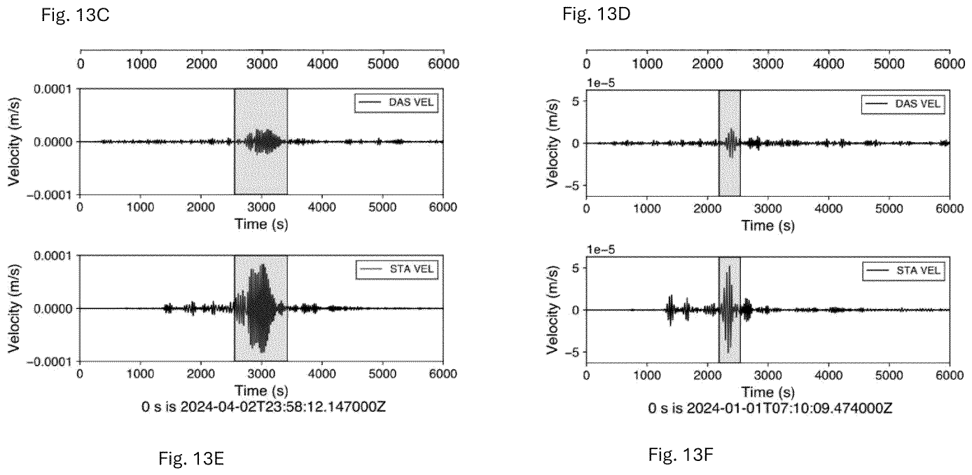

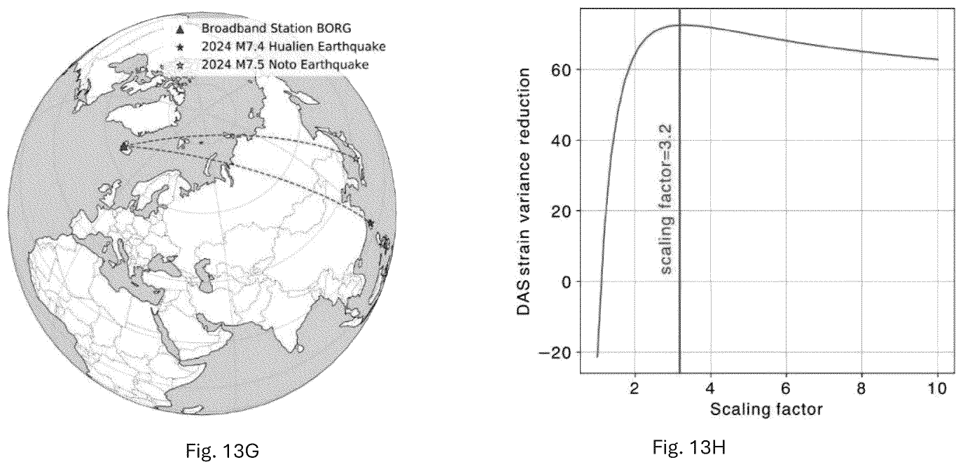

We integrated strain-rate signals from channel 2500 to 6000 (FIG. 6) to derive strain during intrusive events to further infer the evolution of dike opening and magma domain deflation [see (35) for details]. The dike was modeled as a predefined vertical rectangular plane, with its strike determined by fitting a common line to the surface fissures mapped from all eruptions (36). We assumed that the dike plane is vertical, as the distribution of earthquakes at the bottom of the dike is approximately aligned with the surface lava fissures (FIG. 5). The magma domain was treated as a point source (Mogi since; red diamond, FIG. 5), located in the same position as that inferred during the November dike event (11). The forward strain modeling along the fiber assumes an elastic half-space model and uses analytical solutions for the dike and the point source (1, 37). We further processed strain-rate recordings in FIG. 11 to remove spikes and long-period background noise (FIG. 6). Then we integrated the strain rate data and multiplied by a coupling factor of 3.2 to obtain the physical ground deformation strain (FIG. 13). We estimated this factor by analyzing DAS records in comparison with data from a local broadband seismometer (38) and nearby GNSS stations [see (35) for details]. We extracted the LFDAS strain across channels every 5 min and performed the inversion independently for each time step (FIG. S6).

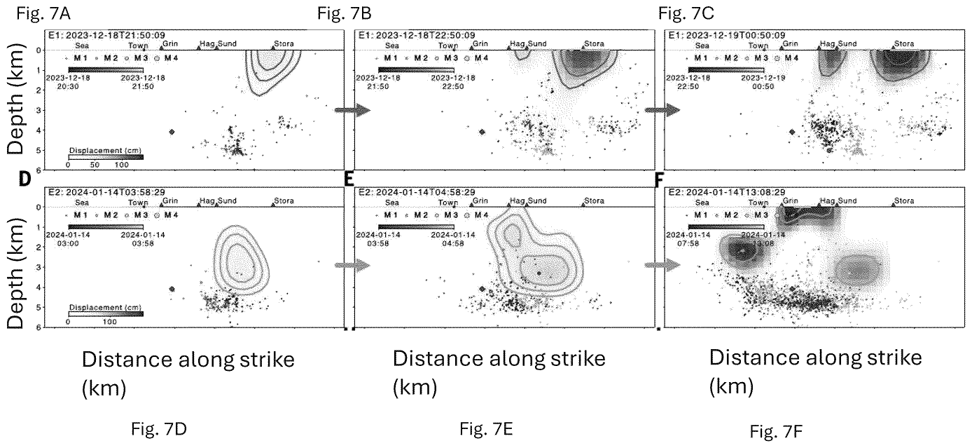

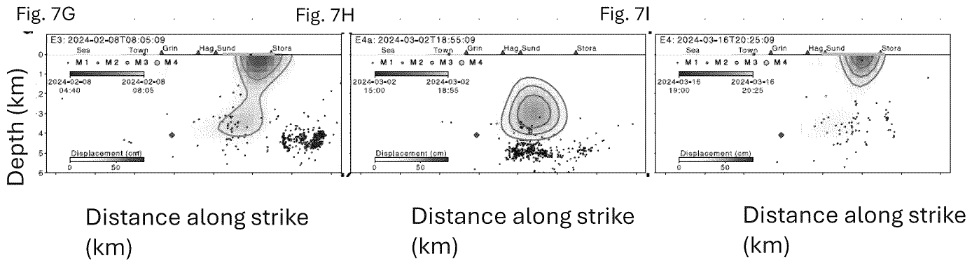

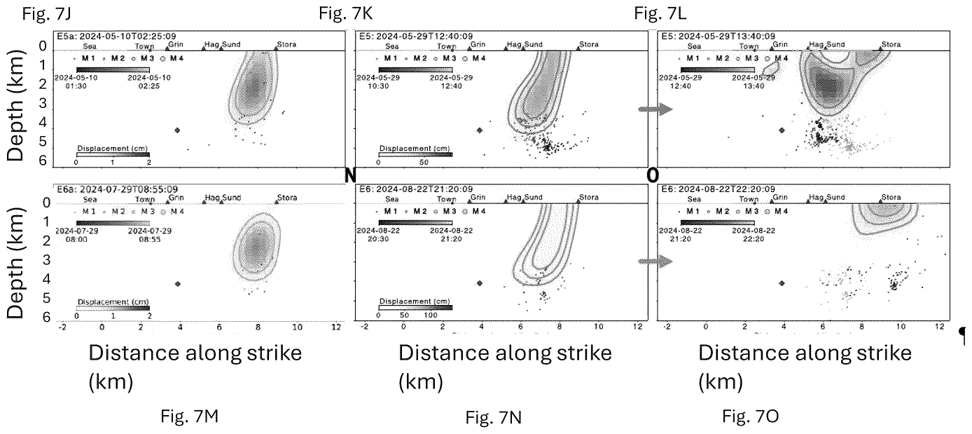

For all nine intrusive events, the models show that the dike openings began between the Sundhnnkur craters and Mt. Stóra-Skógfell (FIG. 7), with earthquake swarms occurring below the opening at a depth of about 4.5 km [see (35) for details]. This is similar to the location of initial seismicity starting around 7 a.m. on 10 Nov. 2023 (11). This pattern suggests a common magma feeding inlet at the bottom of the dike for all intrusive events, including the November dike event. In eruptive events, E1 to E6, the dike opening breached the surface, aligning with locations of eruptive fissures (FIG. 7). By contrast, for noneruptive event E4a, the dike opening was trapped at a depth of about 3 km (FIG. 7). For the other two noneruptive events, E5a and E6a, the maximum opening occurred at depths of about 2 km (FIG. 7).

We observed a clear spatial migration pattern of dike opening during eruptions E1, E2, E5, and E6 (FIG. 7). Among these, event E2 shows the longest migration. The dike opened at a depth of about 2 to 3 km, like that observed during E4a, before propagating horizontally toward Grindavik and vertically to shallower depths (FIG. 7). The maximum opening eventually reached the surface just north of Grindavik, where the lava erupted. By tracking the location of maximum local opening during intrusion, we estimate the initial migration speed of the magma pocket to be about 0.9 m s⁻¹. The migration then slowed down to about 0.2 m s⁻¹, when the magma pocket reached a depth of about 1 km (FIGS. 11 and 12). Event E1 started below Mt. Stóra-Skógfell and migrated southwest to Mt. Hagafell (FIG. 7). Both E5 and E6 started with a similar opening pattern to the preceding noneruptive intrusions E5a and E6a but with substantially larger amplitudes (FIG. 7). Whereas event E5 propagated about 2 km southward, E6 extended 2 km north of Mt. Stóra-Skógfell (FIG. 7).

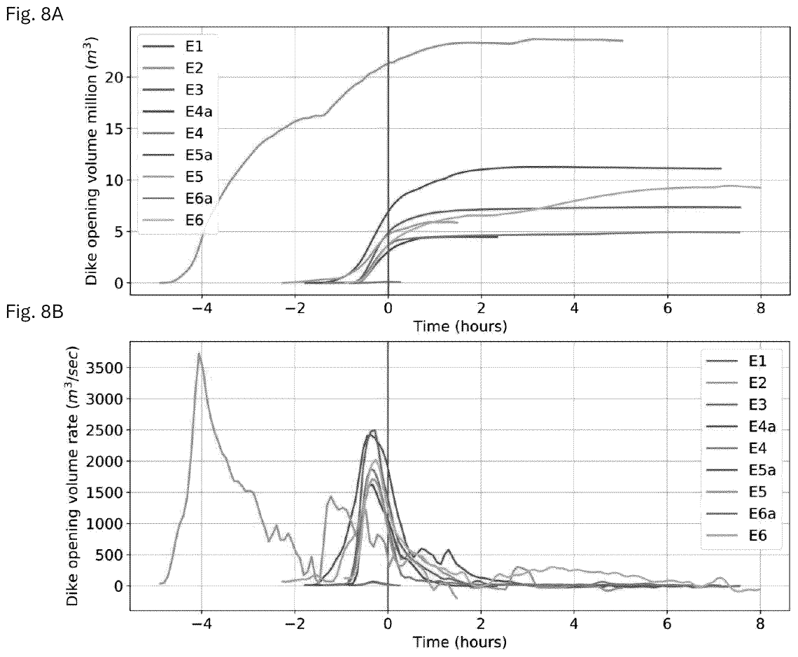

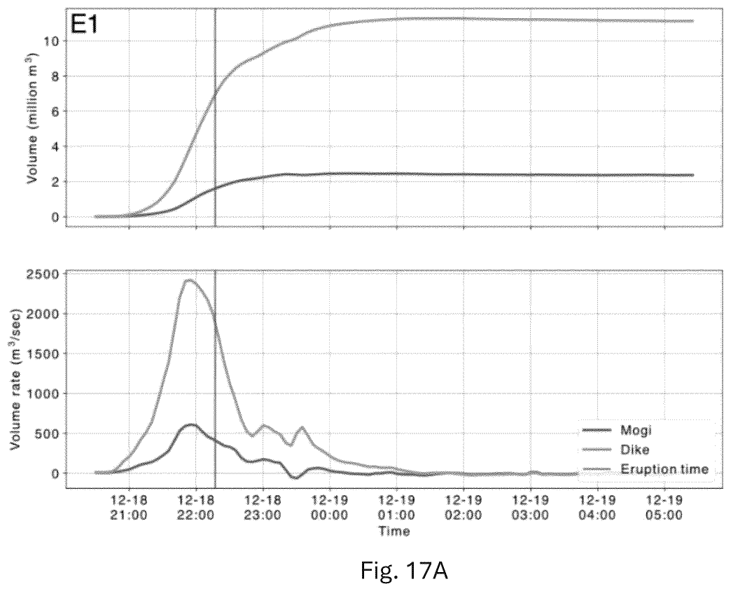

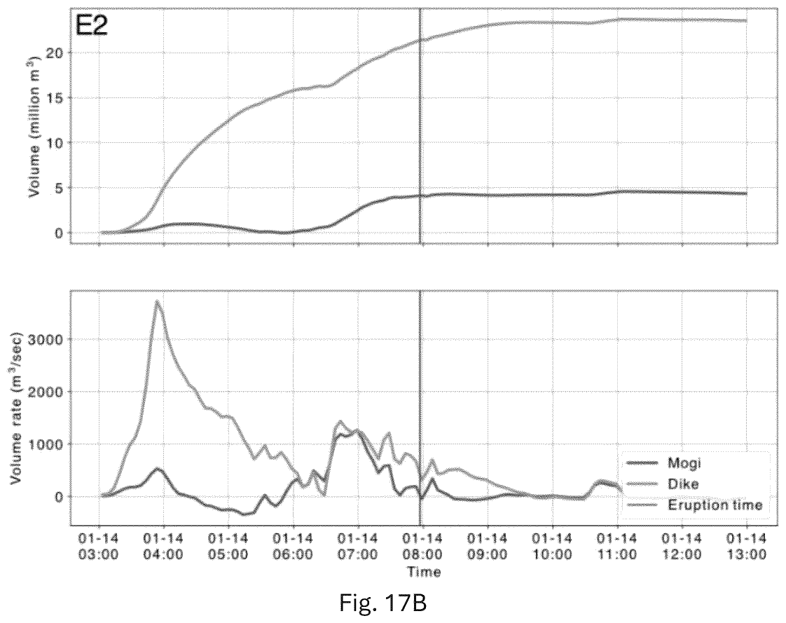

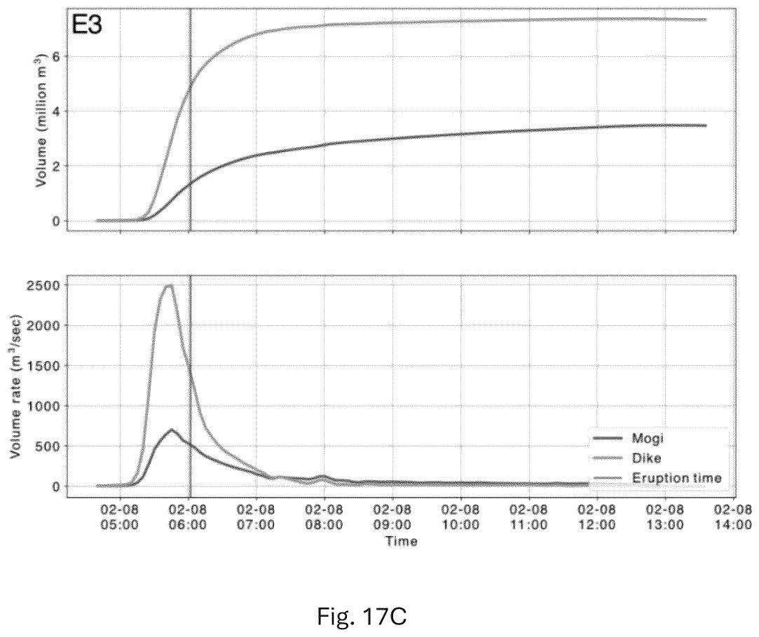

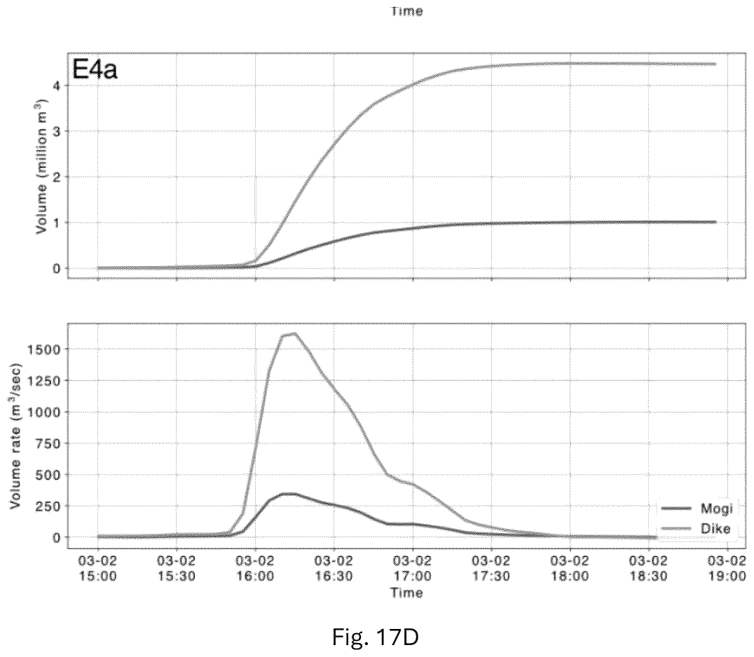

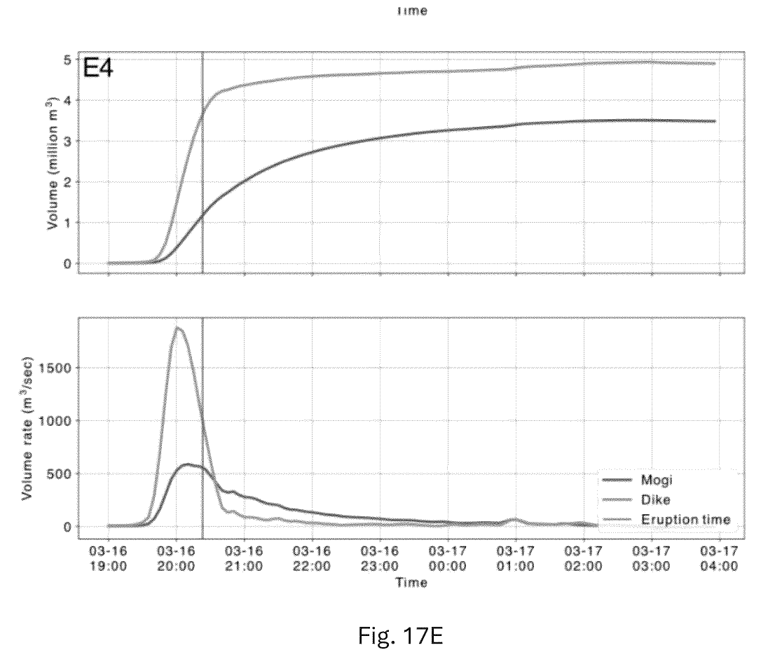

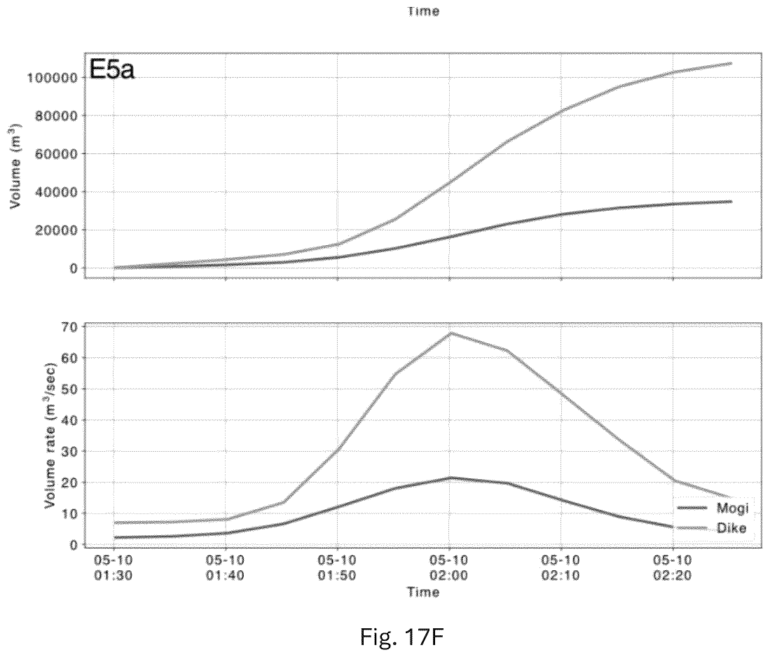

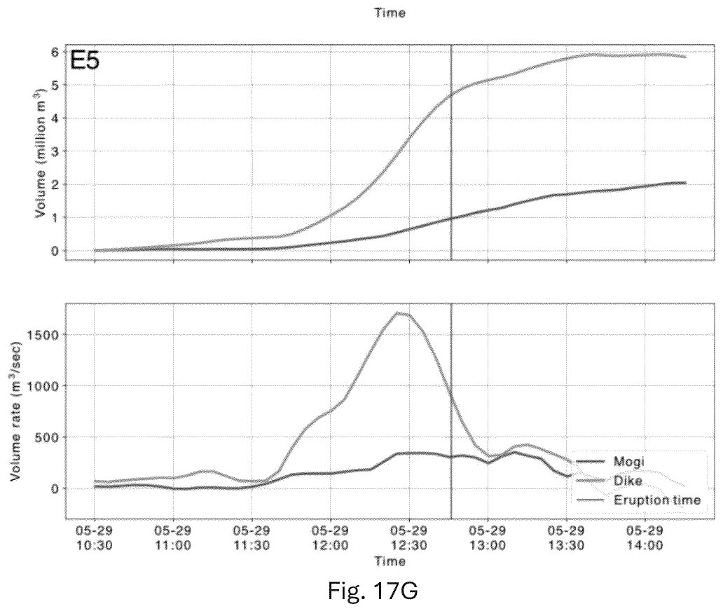

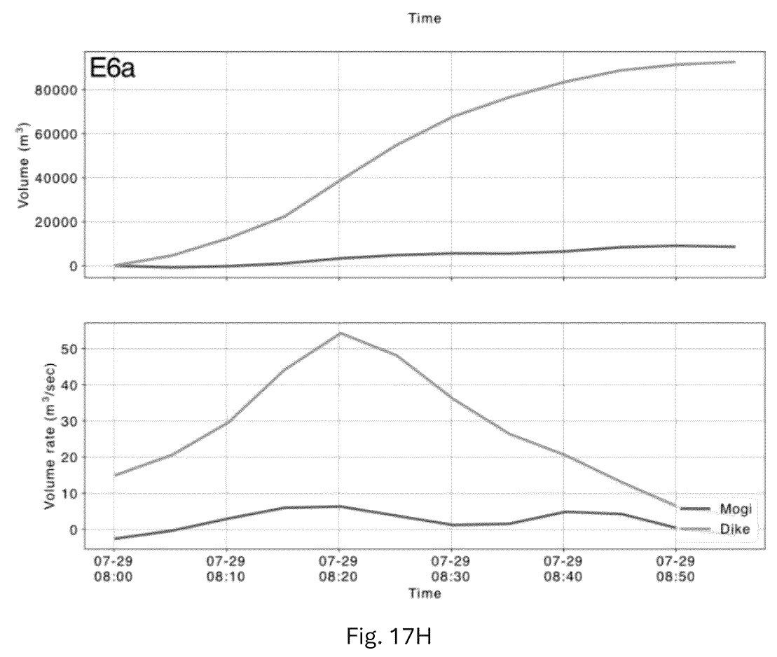

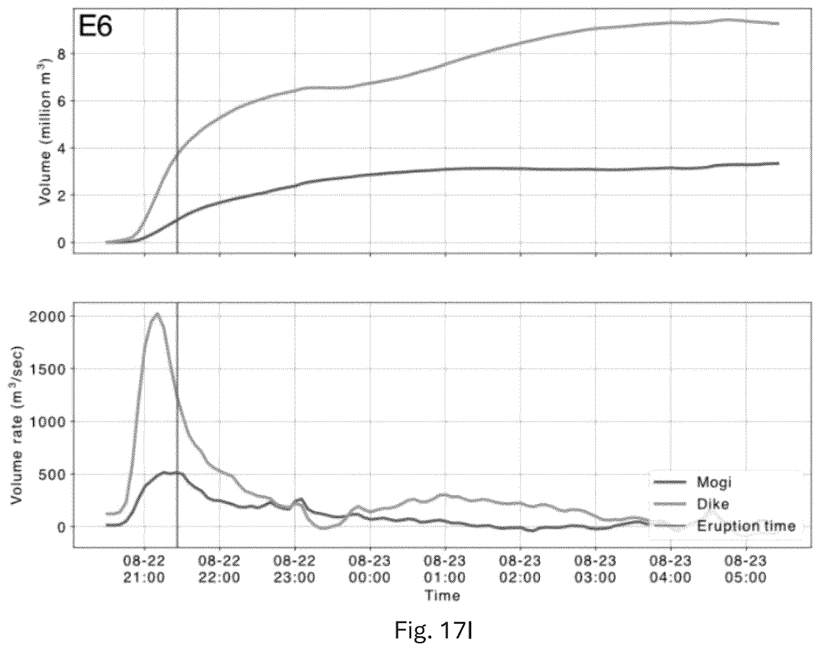

We can determine the volume history of both the dike opening and point source deflation from the inversion (FIG. 17). The inferred opening volume of the dike is generally larger than the deflation volume, as also observed during the November dike intrusion (11). This discrepancy can be partly explained by the greater compliance of a dike compared with that of an ellipsoidal magma chamber (39). Furthermore, large variation in volume ratios (1.4 to 5.9) may reflect melts originating from different sills within the magma domain, each with different volatile content and compressibility (34). In the following, we focus on changes in dike volume, as the point source volume is less well resolved owing to the smaller magnitude of deflation-induced strain and potential noise caused by local fault movements. Eruption E2 has the largest dike volume among all intrusive events, with a total volume of about 23.5 million m³ and a peak volume rate exceeding 3700 m³ s⁻¹ (FIG. 8). Eruptions E1, E3, and E6 have associated dike volumes of approximately 11.1, 7.2, and 9.3 million m³, respectively.

The arrested intrusion E4a and eruption E4 have similar dike volumes and occurred just 2 weeks apart, with a combined dike volume of about 9.4 million m³. Eruption E5 reached a dike volume of 5.8 million m³ when the fiber was melted by the lava and data acquisition beyond channel 3389 was seized. Without this damage, the inferred volume would likely have continued to increase. The two smaller intrusive events, E5a and E6a, only result in a dike volume of about 0.1 million m³. In total, based on available measurements, these nine intrusive events produced a dike volume of about 67 million m³.

A notable feature of the dike growth history is the similar evolution of volume rates for all eruptive events, except E2 (B in FIG. 8 and B in FIG. 12). Dike volume rate first increased rapidly, reaching a peak 15 to 22 min before the eruption, and then gradually declined to zero. Such a repetitive pattern suggests a consistent magma plumbing geometry and relatively stable stress state of the volcanic system, where the magma pressure builds in the magma domain during inflation, driving the magma flow through a conduit into the dike's inlet during deflation, and eventually growing the dike tip to the surface. Sometimes, the dike fails to breach the surface, resulting in arrested intrusions, such as E4a, E5a, and E6a. Eruption E2 is distinguished from other eruptions by its long duration, large dike opening volume, and a two-stage volume increase in which an initially trapped intrusion resumed growth and eventually led to an eruption. This second phase of volume growth may be attributed to the secondary supply of magma from the southwest section of the dike below Grindavik (F in FIG. 7) or to the increased dike pressure from basalt vesiculation at shallower depths (13, 40). Eruption E6 also shows a two-stage dike volume increase, though the second stage occurred after the eruption began and had a smaller volume increase.

### d. Example Physical model

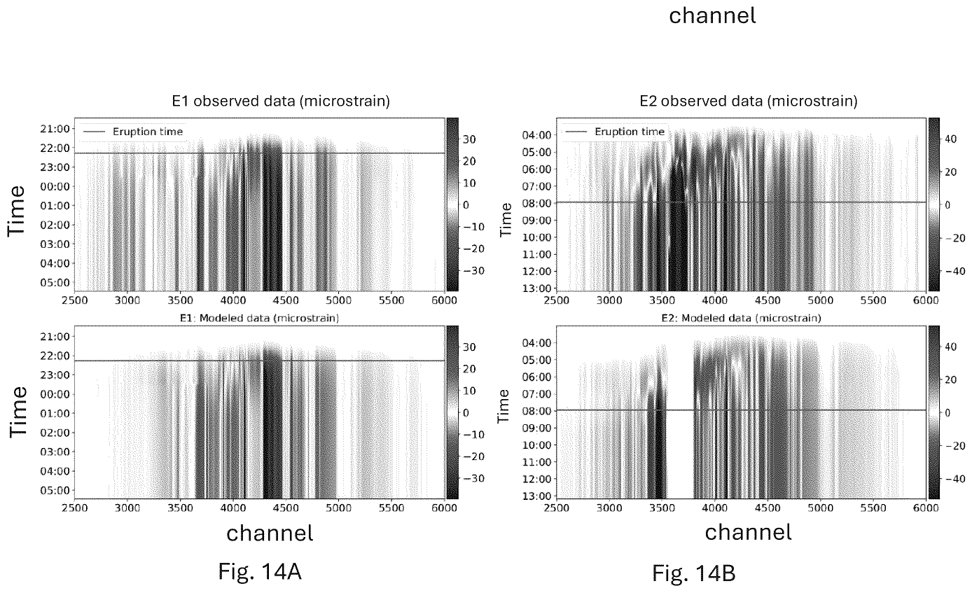

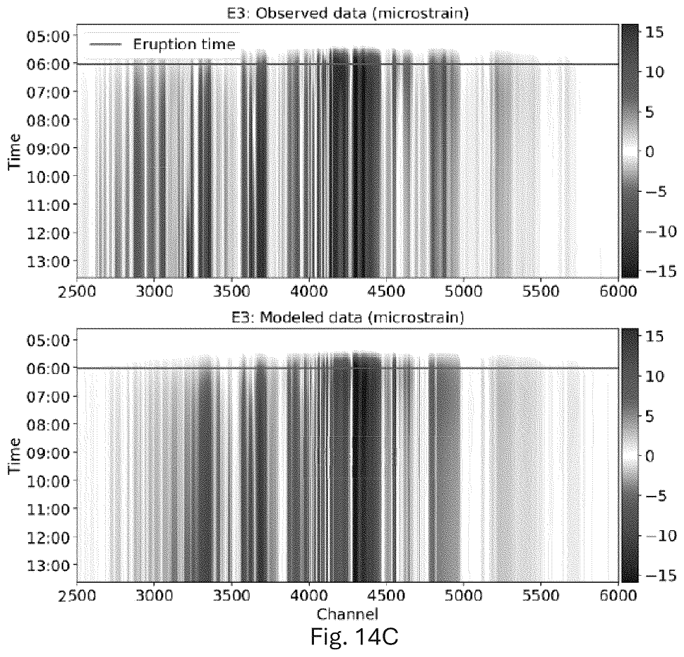

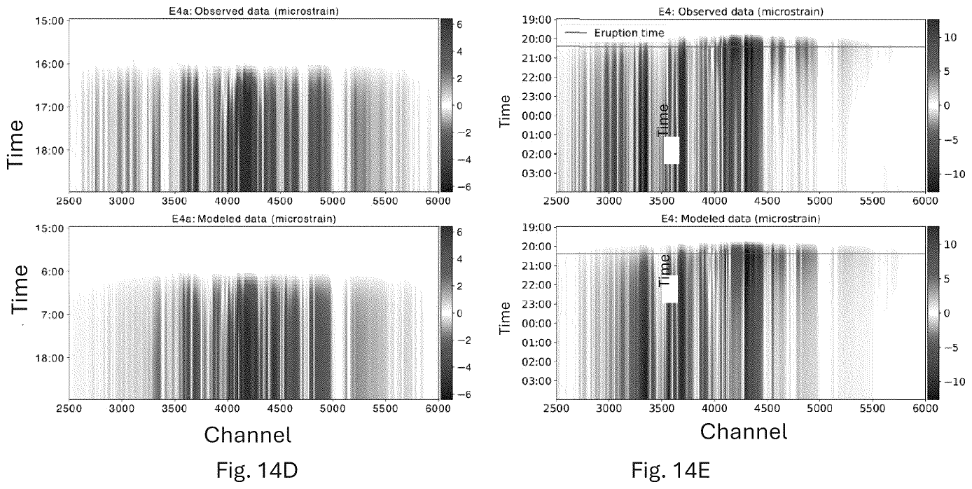

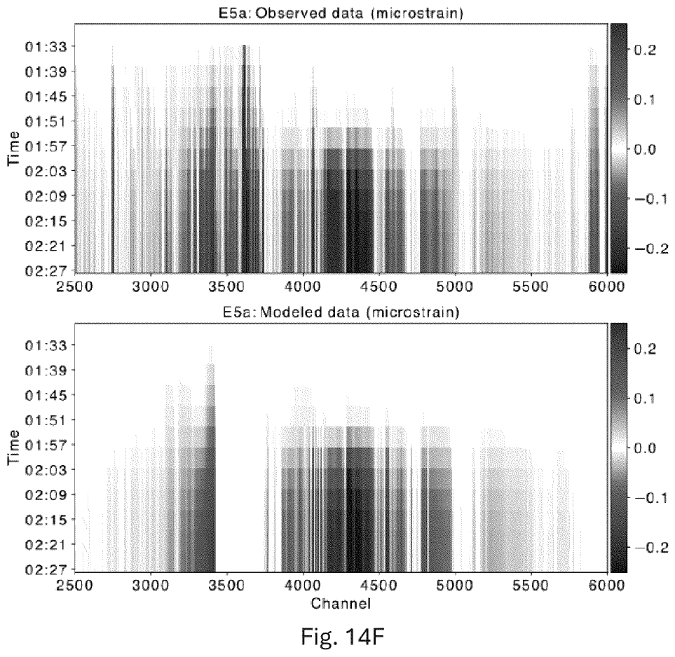

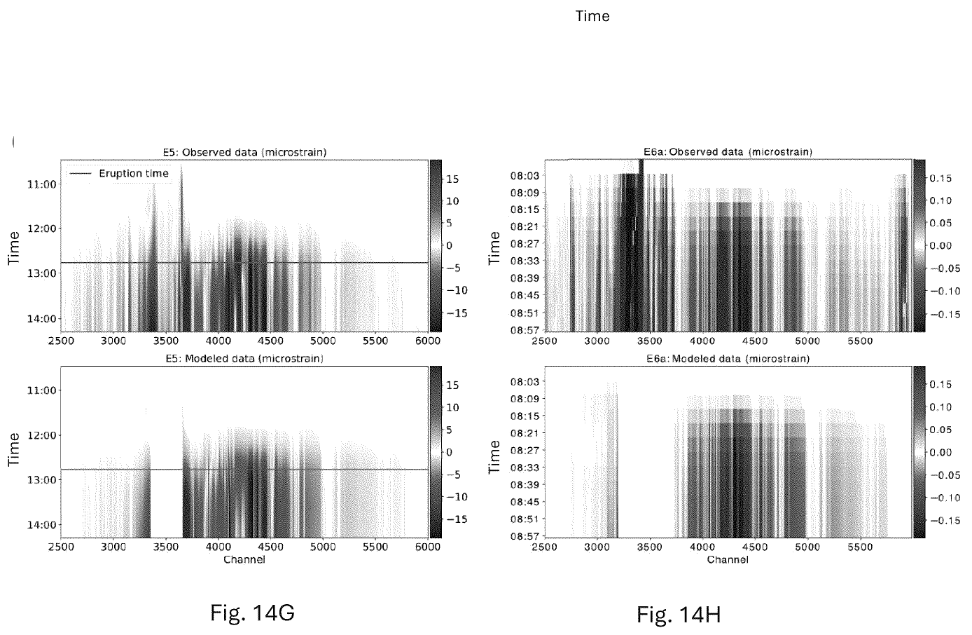

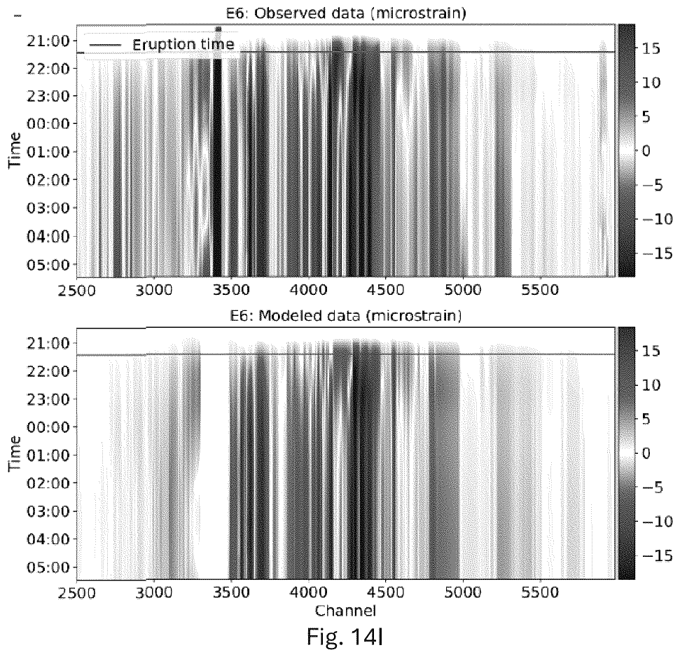

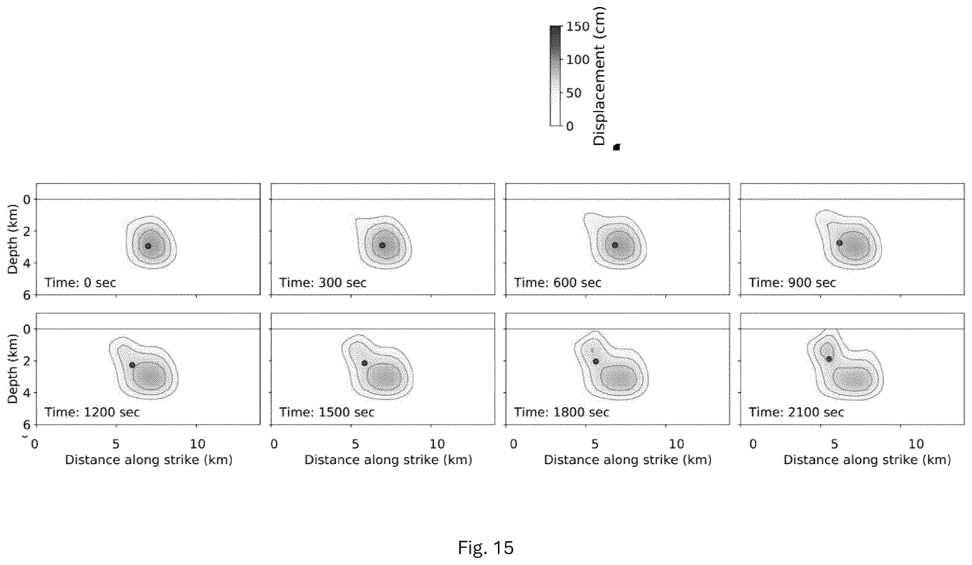

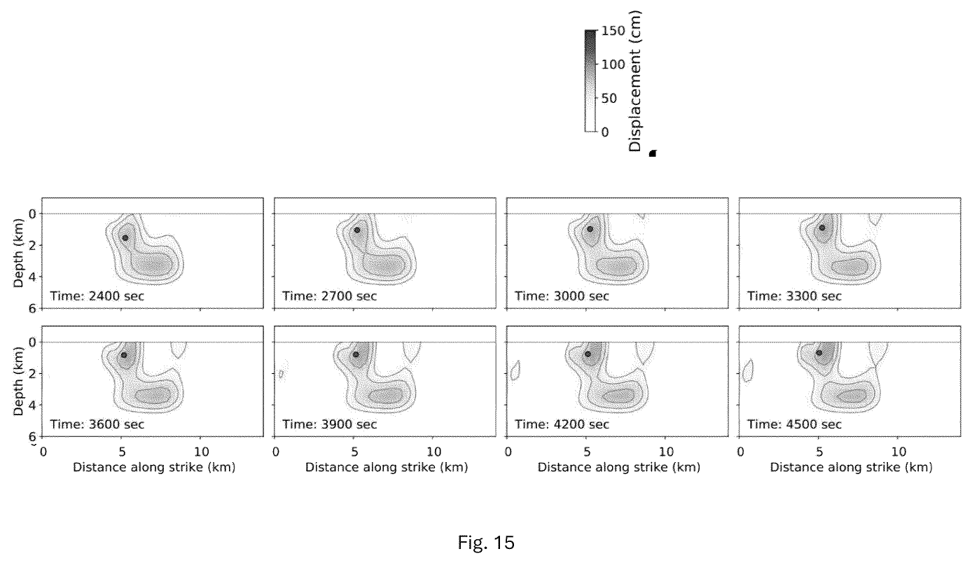

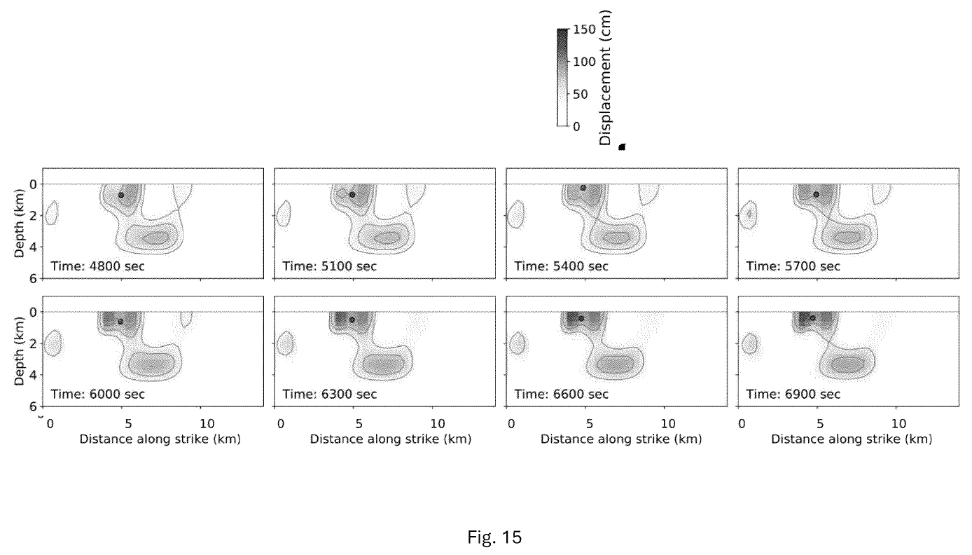

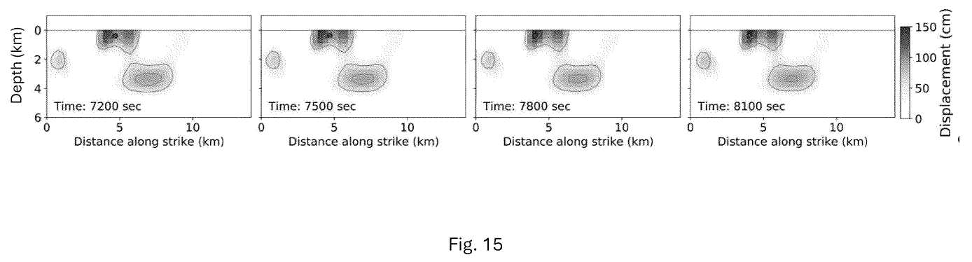

We propose that each intrusive event was affected by previous events, among which the November diking event had the most impact. The November dike intrusion did not breach the surface, possibly owing to accumulated tensional tectonic stress and negative buoyancy in the shallow crust (13) that favored lateral growth, forming a 15-km-long dike with up to 8 m of inferred opening and a total dike volume about 130 million m³ (11). This is about twice the combined volume of subsequent intrusions by 14 Nov. 2024. This extensive opening at depths ranging from 1.5 to 5 km increased compressive stress at depth but decreased compression in the shallower crust relative to the background stress state (35). These stress changes facilitated the dike reaching shallow levels and later eruptions. Eruptions E1 and E2 filled the opening gap in the upper 1.5 km and were spatially separated around Mt. Hagafell. During the early stage of the E2 intrusion (D to F in FIG. 7), its vertical propagation was stalled by the opening boundary of E1, likely because of the negative vertical stress gradient locally induced by E1. Later eruptions and arrested intrusions arranged themselves in the upper crust where there was stress and opening deficit (FIGS. 14 and 15), suggesting self-organization of diking events and the possibility to estimate the location of the following dike and eruption.

The history of the observed dike volume rate can be modeled by using a simple lumped model with a coupled system of a dike and a crustal magma chamber (13). In this model, the dike grows as a semi-ellipsoid, with the magma inlet at its base. Temporal evolution of this system is governed by three dimensionless parameters: α, Ψ, and R [see (35) for details]. Parameter α reflects the competition between the combined negative buoyancy in the shallow crust and the vertical tectonic stress gradient against the driving pressure at the dike inlet. Parameter Ψ represents the volume and compressibility ratio between the dike and magma domain. Eruptions are favored by a small α, indicating higher driving pressure and lower resistance, and a small Ψ, indicating a large magma chamber relative to the dike, which makes the pressure within the magma chamber harder to deplete. Parameter R characterizes the hydraulic property of the magma plumbing system and represents the relative rate between magma flow into the dike over dike propagation. A larger R indicates a more conductive conduit and favors eruptions.

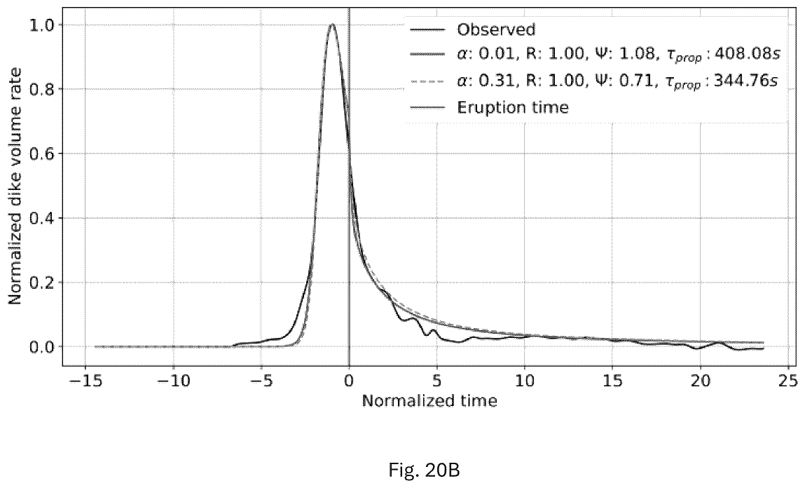

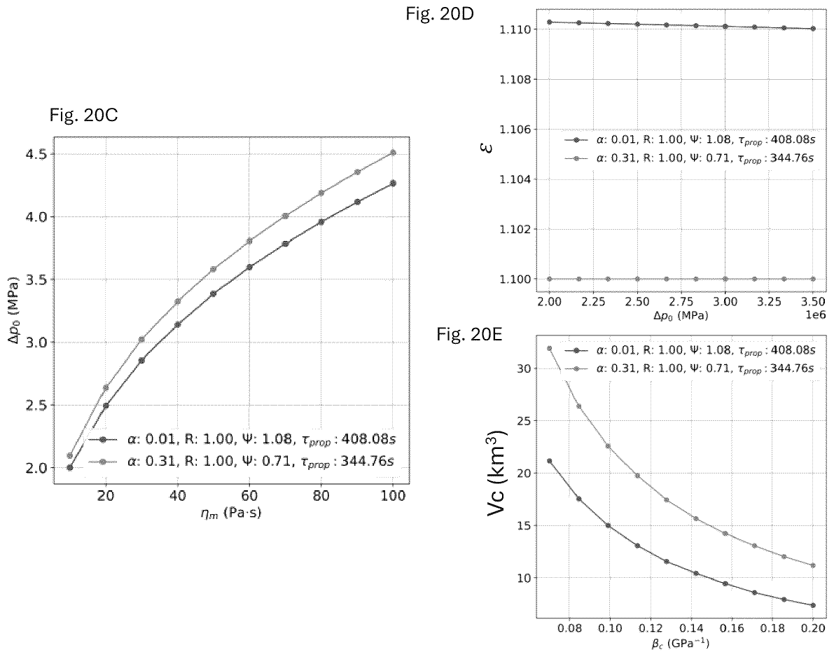

We can infer some physical properties of the magma plumbing system, including the initial dike overpressure, the vertical gradient of the tectonic normal stress, and the volume of the magma domain, by using the probable parameter ranges of α, Ψ, and R constrained by the observed dike volume rate patterns (FIG. 20). From the observation, the typical time interval between the dike volume rate peak and the eruption is about 20 min (FIG. 8 and FIG. 12), and the depth of the dike inlet is about 2.5 km (FIG. 7). Assuming a crustal shear modulus y of 15 GPa and Poisson's ratio v of 0.27, we can estimate the initial overpressure as a function of magma viscosity (C in FIG. 20). For example, a magma viscosity of 50 Pa*s would infer an initial overpressure to be about 3.5 MPa. In addition, the set of the probable parameter α indicates a low effective density [see (35) for details]. If we assume a magma density of ρₘ of 2610 kg/m³ and a crust density of ρᵣ of 2350 kg/m³(10,11), this implies a positive vertical gradient of normal stress locally induced by the November dike intrusion (D in FIG. 20). We can also estimate the volume of the magma chamber, which varies with Ψ and the effective compressibility of the magma chamber β_{c}. For example, with Ψ=0.71, an effective compressibility of 0.14 GPa⁻¹ implies a magma domain volume of about 10 km³. An effective compressibility of 0.07 GPa⁻¹ will require the magma domain to be approximately 21 km³ (E in FIG. 20). The substantial volume of the chamber, despite uncertainties related to its compressibility, indicates its capacity to store and release large amounts of magma.

### e. Implications for Volcano Monitoring and Fiber-Optic Geodesy

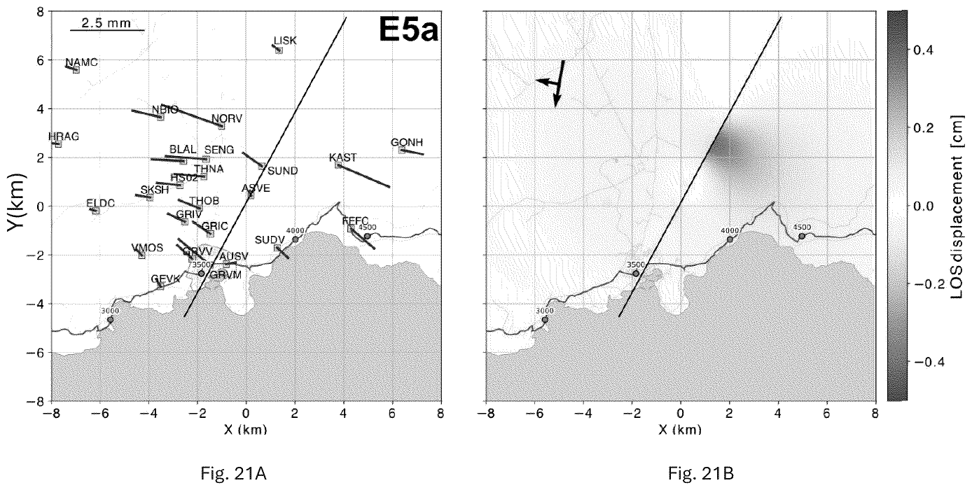

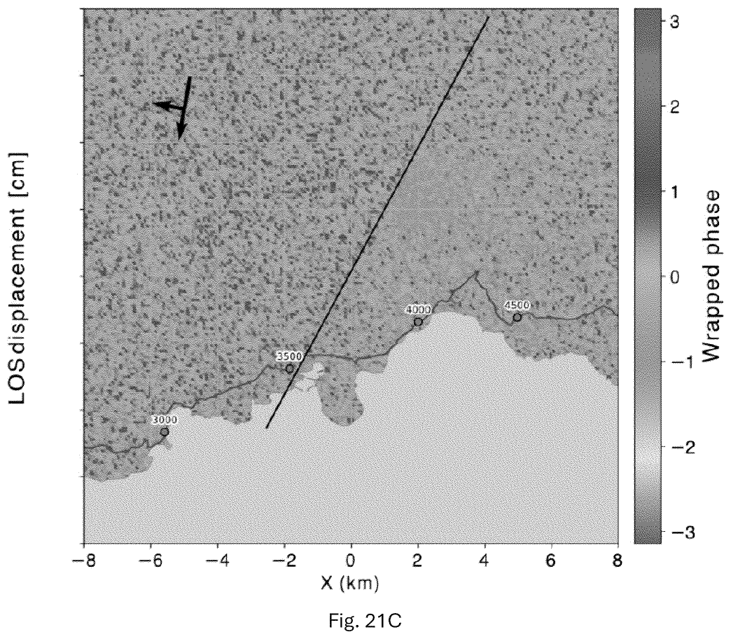

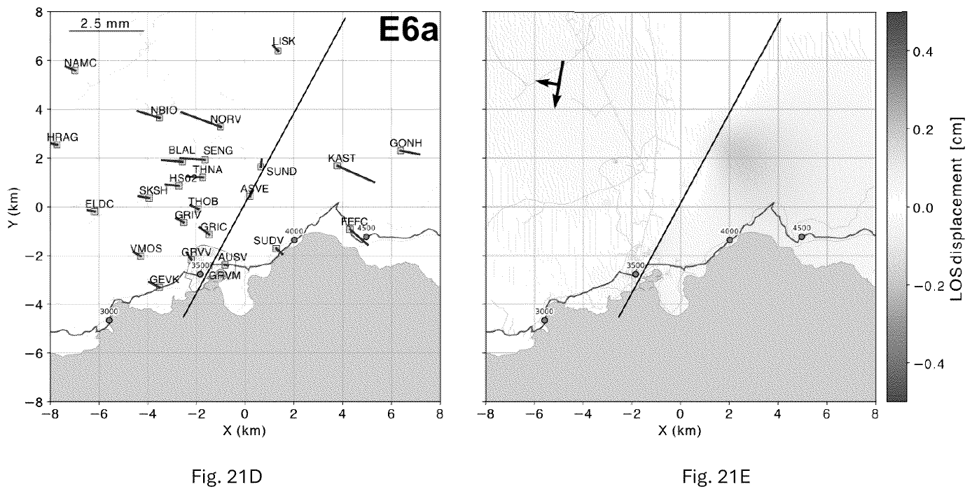

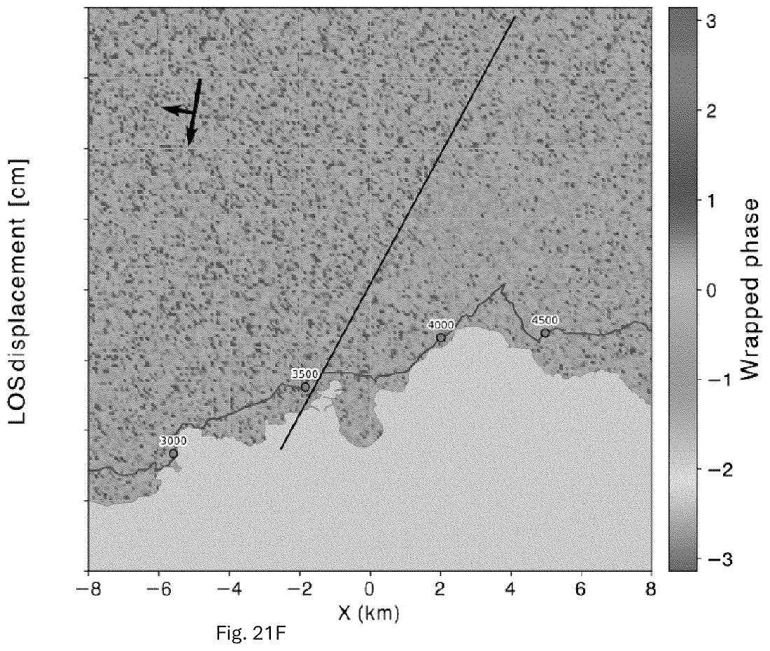

Our results from the 2023 to 2024 intrusion sequence in Iceland demonstrate how LFDAS recordings along fiber cables can complement current geodetic observation systems, offering minute-scale deformation monitoring previously unattainable with conventional geodetic techniques. Although InSAR can resolve millimeter-level surface deformation over a two-dimensional area, its temporal resolution is limited, often requiring days between measurements. Similarly, GNSS continuously monitors surface displacements at discrete points but requires substantial time averaging to achieve millimeter-level resolution. Classical geodetic techniques, such as borehole strainmeters and tilt meters, require substantial financial investment to provide continuous but single-point measurements. In addition, EDM is labor intensive and expensive to operate. By contrast, LFDAS recordings provide both high spatial and temporal resolution by converting fiber cables spanning tens of kilometers into dense arrays of thousands of strainmeters spaced just meters apart. Additionally, lower noise levels can be achieved in LFDAS strain recordings through array processing and denoising (FIG. 6). For example, the deformation induced by the arrested intrusions E5a and E6a falls below the noise threshold of both GNSS and InSAR (FIG. 21). This approach improves our understanding of rapid magma flow dynamics and potentially provides valuable insights into how the stress induced by dike intrusions interacts with earthquakes (9, 10).

LFDAS requires minimal processing to detect dike intrusion-induced strain, making it particularly attractive for real-time monitoring, early warning, and hazard assessments of volcanic eruptions. Since 27 Feb. 2024, we have operated an early warning system to assist the Icelandic Meteorological Office (IMO) in issuing alerts and evacuation orders. We successfully assisted the IMO in issuing early warnings for eruptions E4 on 16 Mar. 2024 and E5 on 29 May 2024 and in refraining from sending a warning for the arrested intrusion E4a on 2 Mar. 2024. Subsequently, we implemented an automatic detection system that sends an alert when the averaged LFDAS strain rate exceeds a preset threshold of 1 nanostrain per second, determined empirically based on previous events. For the recent eruption E6, this system issued an automatic early warning notification to IMO 26 min before the eruption occurred. With a predefined dike geometry, we expect LFDAS to provide nearly real-time imaging of dike intrusions to assess the location and likelihood of an eruption.

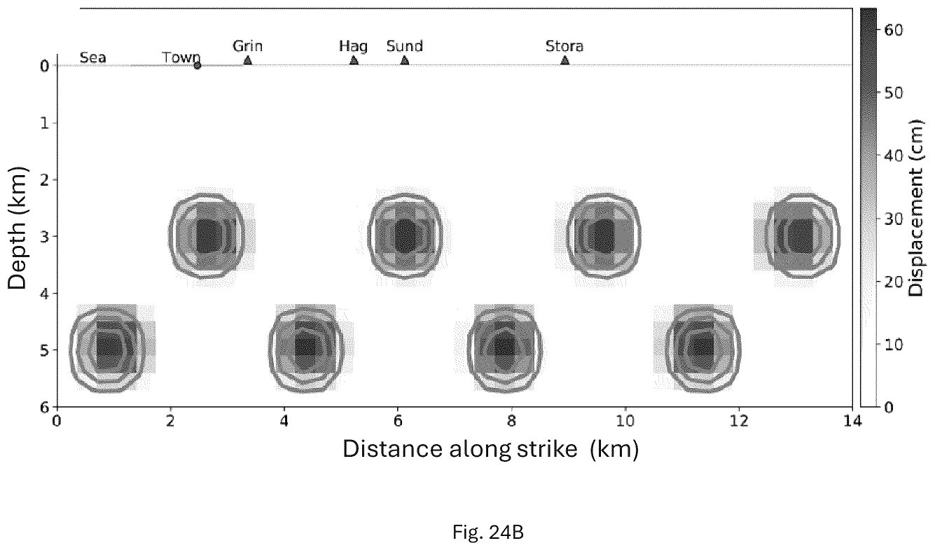

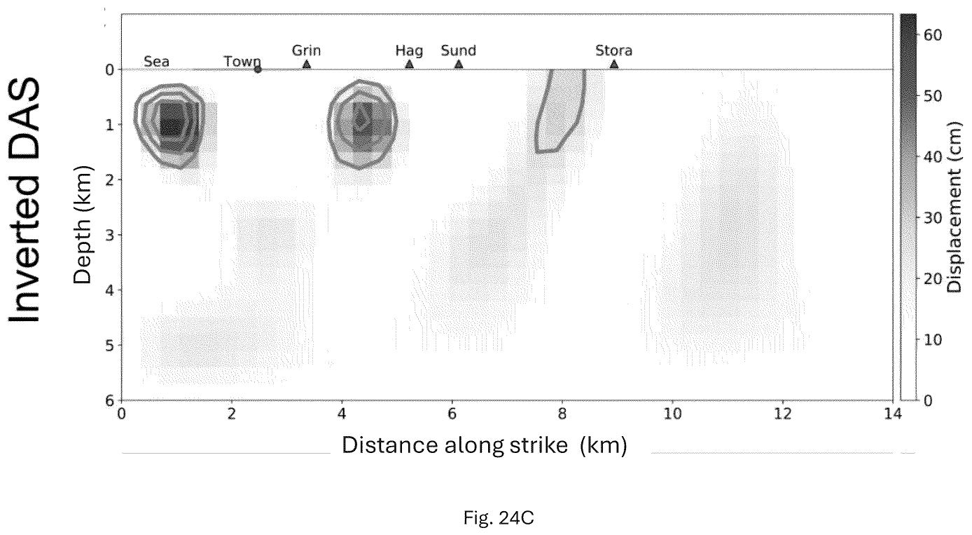

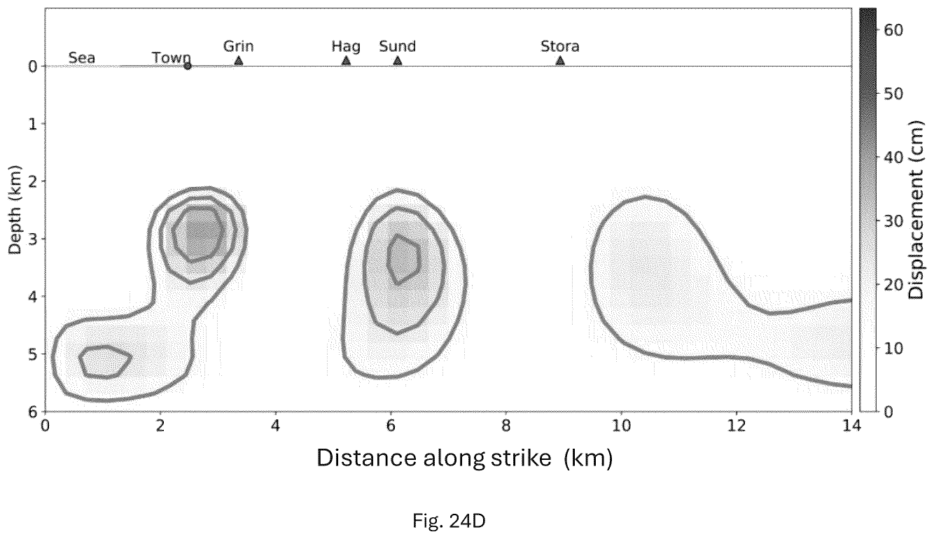

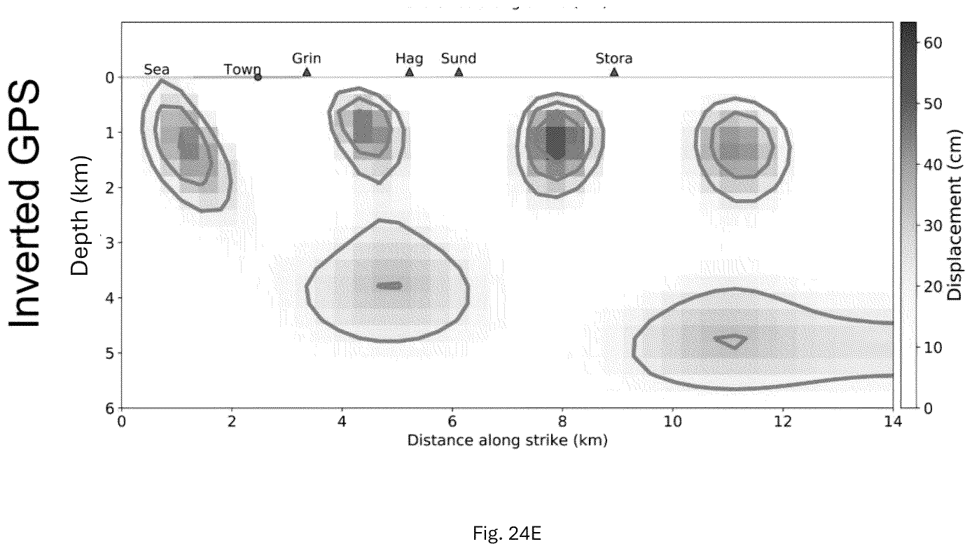

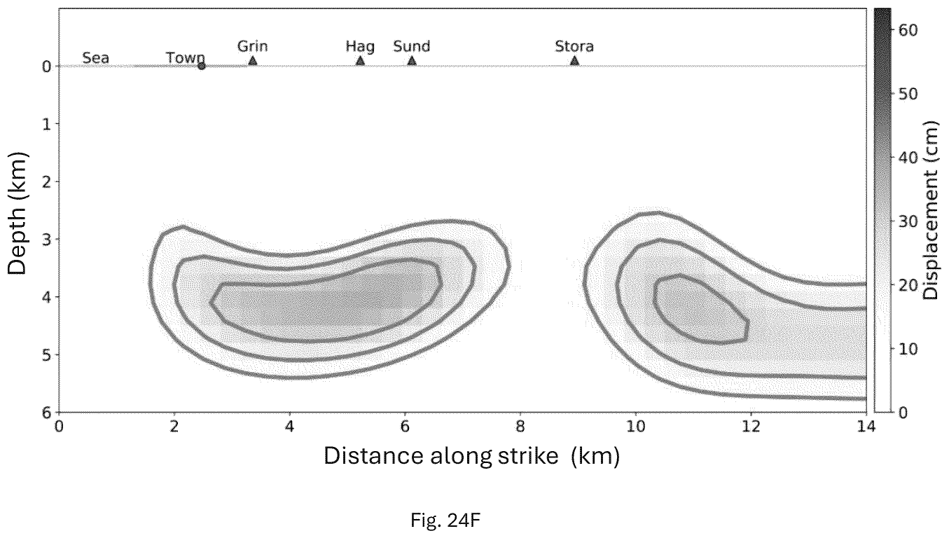

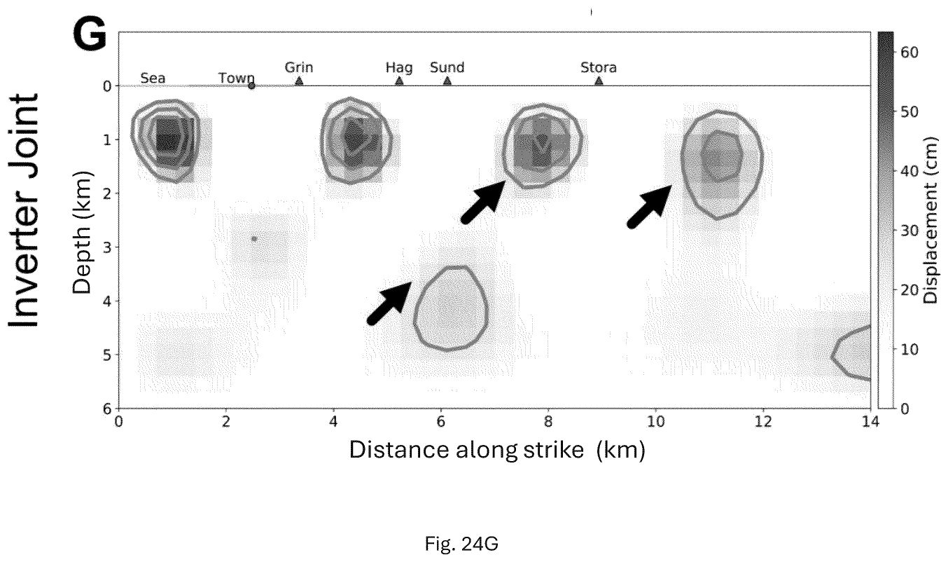

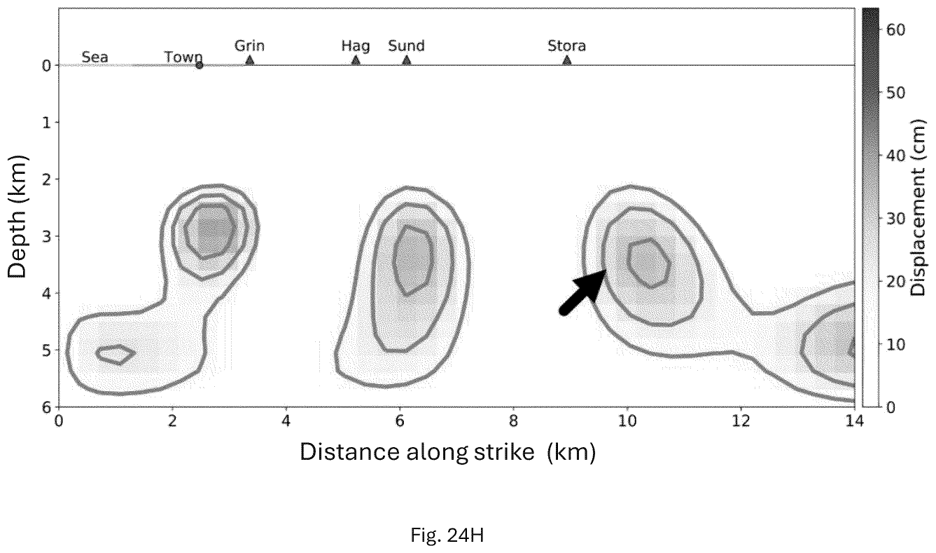

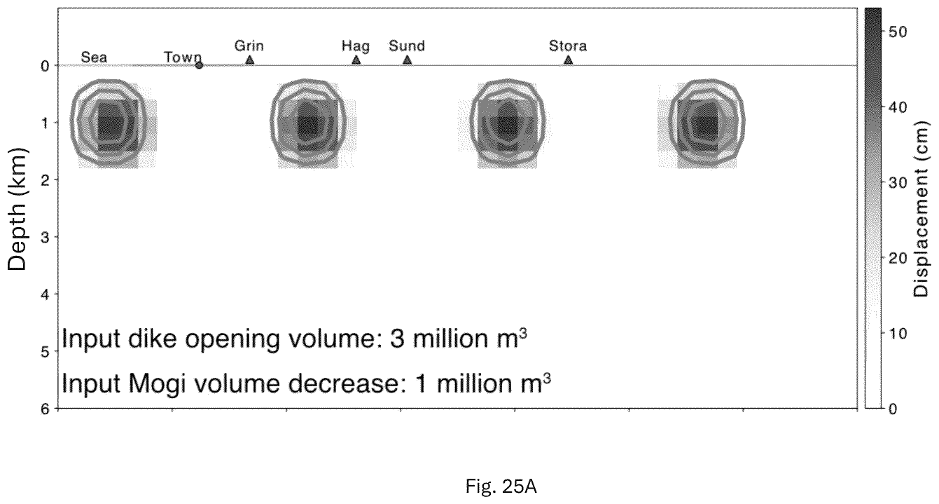

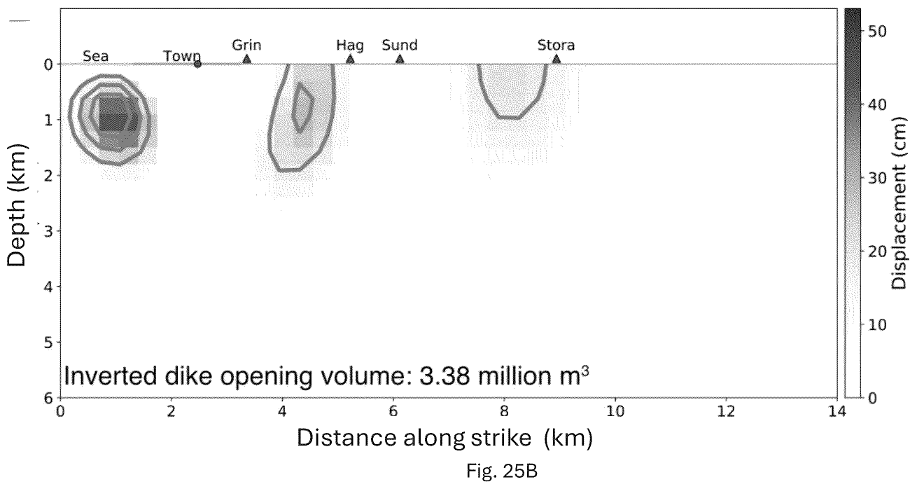

Currently, our inversion of dike openings relies solely on LFDAS recordings along a single fiber cable. However, joint inversions incorporating conventional geodetic measurements, such as GNSS and InSAR, or potentially multiple fiber cables at different azimuths, can greatly enhance the spatial resolution. For example, a joint inversion with LFDAS and GNSS improves the resolution on the dike's northeast section in tests with different opening depths (35) (FIG. 24). Additionally, GNSS and InSAR are critical to long-term monitoring on timescales of hours to decades, and it remains to be understood whether signals with similar timescales can be extracted from LFDAS. Nevertheless, as the Reykjanes Peninsula has since 2019 entered a new era of volcanic unrest (41, 42), similar studies based on a comprehensive dataset will be needed. Moreover, offshore fiber cables, some of which are near active underwater volcanoes (21,43,44), offer a rare opportunity to monitor areas where conventional geodetic techniques face major challenges. By converting preexisting fiber-optic infrastructure into high-resolution geodetic networks and integrating it with conventional geodetic methods, we anticipate new possibilities for monitoring and understanding volcanic activity as well as other geological processes, such as fault creeping and hillslope deformation (45, 46), heralding the emergence of fiber-optic geodesy.

### f. Materials and Methods Used for the Working Example

### LFDAS Processing, Denoising, and Scaling

We used the OptaSense QuantX™ interrogator and set up the recording with a sampling rate of 160 Hz, a channel spacing of 10.2 m, and a gauge length of 102 m. We determined the location of the each channel by driving along the fiber cable and mapping the GPS track of vehicle-induced signal on DAS recordings (50). During this process, bad channels such as fiber loop were identified and removed. We corrected the phase wrapping caused by int32 overflow or underflow in the same way as in (51). We then applied a low-pass filter with a corner frequency of 0.01 Hz and downsampled the data with a sampling interval of 10 seconds. To remove the common-mode noise, we subtracted the median value determined across channel 0-2500 at each time point. This common-mode noise was primarily caused by laser drifting due to temperature fluctuations within the room hosting the interrogator. After this, we applied the low-pass filter again. The resulting processed LFDAS recordings are shown in FIG. 11.

We further denoised the data in FIG. 11 to obtain the recordings in FIG. 6 through the following steps. First, we applied a moving-window median filter along the temporal axis with a window length of 15 minutes to remove spikes caused by high-frequency sources such as earthquakes and vehicles. Second, we performed another moving-window median filter along the spatial axis with a window length of 21 channels to remove anomalous spikes among adjacent channels. Finally, we estimated the background noise through a Gaussian process and subtracted it from the data to obtain the denoised data in FIG. 6. Specifically, we fitted the Gaussian process with a kernel function of

$$k ( x , {x}^{′} ) = {σ}_{0}^{2} {x}^{T} {x}^{′} + c exp ( - \frac{{‖ x - {x}^{′} ‖}^{2}}{2 {ℓ}^{2}} )$$

using data before and after the processing window in table T1 and then predicted and subtracted the noise within the processing window. This approach effectively removed both the trending and periodic signal, resulting in cleaner data (FIG. 6).

Since the fiber cable was within a buried conduit, accounted for the coupling factor to obtain realistic strain measurements (38, 52, 53). We estimated a coupling factor of about 3.2, which converts the fiber-recorded strain to the physical ground deformation strain. We estimated this coupling factor using two independent methods and obtain consistent results. The first method estimated the coupling factor by comparing DAS-recorded Rayleigh waves with those from a local broadband seismometer, II.BORG™ following the approach described in reference (38). We analyzed two large teleseismic events: the 2024 M7.4 Hualien Earthquake and the 2024 M7.5 Noto Earthquake, both showing high signal-to-noise ratio Rayleigh waves on both the DAS and the seismometer (A-F in FIG. 13). For the DAS recordings, we selected a section of fiber cable aligned with the great-circle path between the teleseismic events and Iceland, averaging the recordings over 30 channels (A-D in FIG. 13). We then converted the averaged DAS strain rate recordings, bandpass-filtered between 0.02-0.04 Hz, to velocity recordings using the apparent Rayleigh phase velocity along the fiber section (53). The phase velocity was calculated from a local 1D velocity model (54). For the seismometer recordings, we rotated the horizontal components to align with the orientation of the DAS section. Finally, the coupling factor was calculated as the ratio between the peak velocities from the seismometer and that from DAS, which is about 3.2 (C-F in FIG. 13). The second method involved a joint inversion using both LFDAS strain and GPS displacements from (11) for eruption E1. We performed a grid search for the coupling factor and find a factor of about 3.2 can yield the best fit for LFDAS strain in the joint inversion with GPS data (H in FIG. 13).

### (ii) Seismicity

We used PhaseNet-DAS™ and GaMMA™ to detect and associate earthquakes based on DAS records (24). We first located events recorded on at least 70% of the whole DAS array and 70% of the first 1000 channels with the NonLinLoc™ package (55). Their locations were further refined using static station terms and relocated with GrowClust™ (56). We used these events as master events to calculate relative traveltime differences with other detected events (subevents) through waveform cross-correlation. We grid searched (56) each subevent's optimal location by minimizing the relative travel time differences across its best five event pairs. We determined the magnitudes of the earthquakes using the unfiltered DAS strain rate (23). The remaining events from the South Iceland Lowlands (SIL) catalog, detected but not matched with the master events, were added for completeness. Our final catalog during eruptions (see the window in table T1) contained 4962 events, with only 42 events (about 0.85% of the total number) directly from the SIL catalog, which originally contains 1030 events.

(iii) Geodetic Modeling and Inversion

We consider a model consisting of a deflating magma source and an opening dike. We model the dike as a rectangular vertical plane with a height of 6 km in depth and a length of 14 km along strike. We mesh the dike plane into 20-by-40 rectangular patches. Refining the mesh of the dike plane does not affect the results. Initially, we invert for both strike-slip and opening component on the dike and find the strike-slip component to be negligible. Therefore, we invert only for the opening component on the dike in all subsequent inversions. For each patch element on the dike, we can calculate its strain tensor E at each fiber channel using the Okada dislocation model (37). To model the longitudinal strain along the fiber cable, we calculate the fiber-channel azimuth a and perform a moving-window median filter with a window length of 11 channels to remove the abnormal azimuths due to channel location errors. We assume the cable is locally horizontal. The longitudinal strain ε^{L} can then be calculated as ε^{L}=v^{T}εv, where v=[sin (α), cos (α),0]^{T} represents the fiber orientation vector with respect to the north. The Green's function Gₖₙ between the channel k and mesh element n is calculated as the longitudinal strain ϵₖₙ^{L} caused by a unit opening in the mesh element n. To invert for the dike opening using the observed LFDAS strain, we solve the linear problem:

$$m = {arg min}_{m} \{ {‖ Gm - d ‖}^{2} + λ {‖ {L}_{2} m ‖}^{2} \} \qquad ( S1 )$$

where G is a K-by-N matrix, with K representing the number of channels and N representing the number of mesh elements. The column vector d represents the observed LFDAS strain. The column vector m represents the opening of each mesh element to be inverted. L₂ represent the second-order Tikhonov (SOT) regularization term. In the inversion of the dike opening, we set λ=0.2 through the L-curve analysis (57). We solve the equation S1 with the constraints that elements in m are non-negative, i.e. only opening and no closing.

We model the magma domain as a Mogi point source (1) and calculate the deflation-induced fiber strain in a similar way to model the dike-induced strain. Suppose the longitudinal strain caused by a unit volume deflation is G_{c}. We invert for both the deflation volume V_{c} and dike opening m such that:

$$m , {V}_{c} , = {arg min}_{m , {V}_{c}} \{ ‖ {G}_{reg} m - ( d - {V}_{c} {G}_{c} ) {‖}^{2} \} , \qquad ( S2 )$$

where G_{reg} represent the regularized G matrix, which combines G and the SOT regularization in equation S1.

### (iv) Resolution Test of Inversion

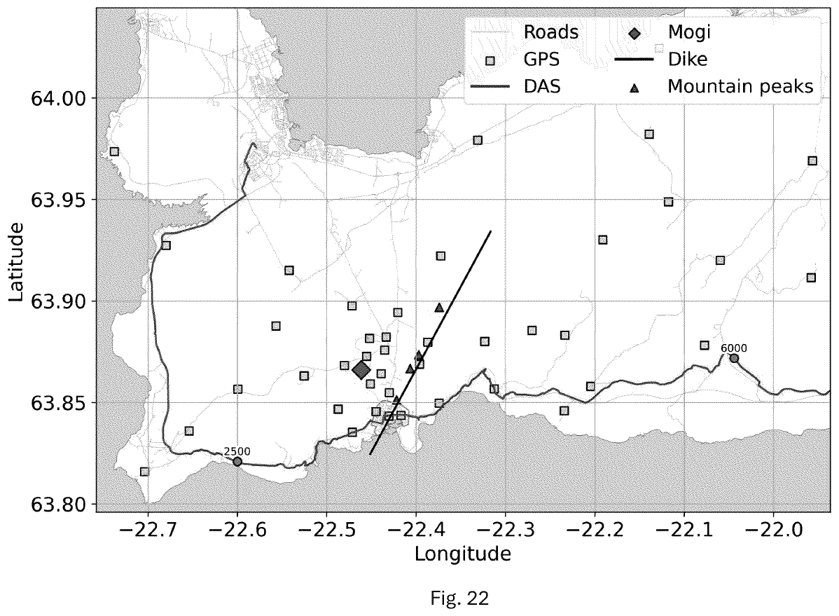

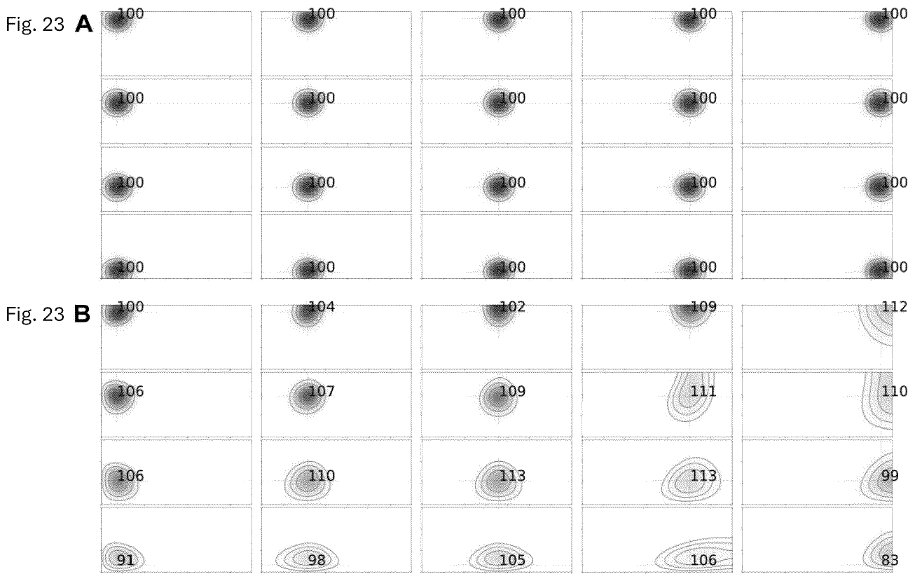

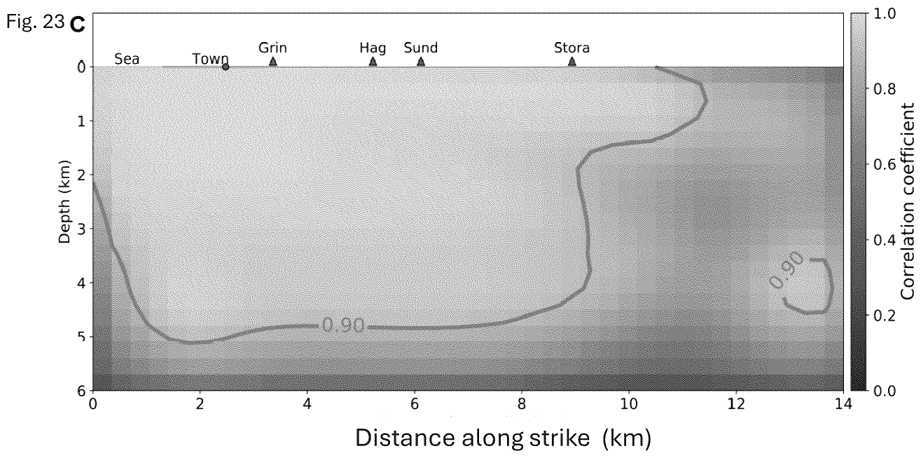

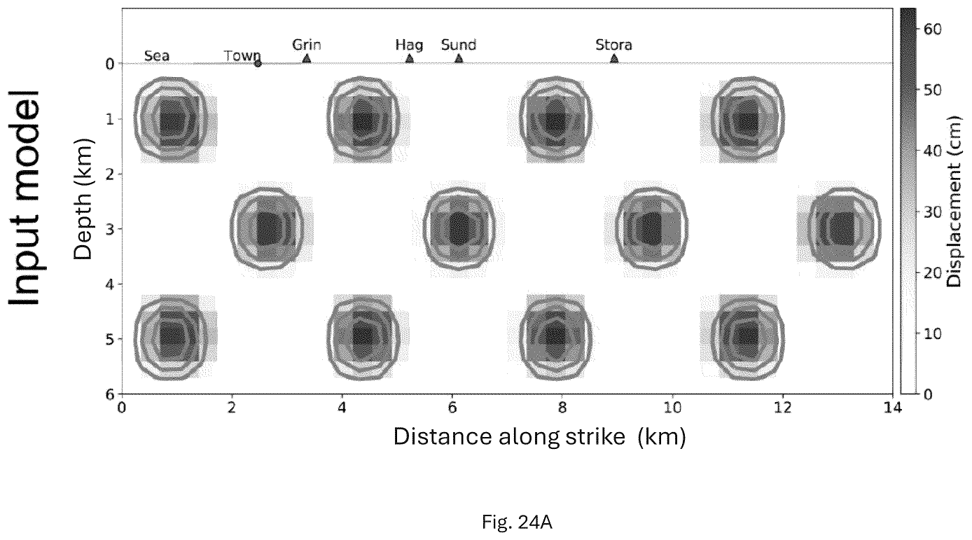

We first conduct an impulse test to verify which section of the dike can be well resolved using LFDAS recordings at channels 2500-6000 (FIG. 22). To do so, we input a Gaussian opening centered at each mesh element in synthetic modeling (A in FIG. 23) and calculate the corresponding synthetic fiber strain. We then perform the inversion by solving the equation S1 with a regularization parameter of λ=0.2. For the inverted model (B in FIG. 23), we calculate its correlation coefficient with the input model (C in FIG. 23). If a mesh grid produces a correlation coefficient lower than 0.9, an additional zero-order Tikhonov (ZOT) regularization term with λ₀=0.2 is applied when inverting the observed LFDAS strain.

We then conduct a checkerboard test to demonstrate the resolution power of the dense LFDAS array and the potential improvement when combined with GPS data in a joint inversion. In the forward modeling, we input a checkerboard opening model with a total volume of 3 million m³. We add Gaussian white noise to both the LFDAS strain (with a standard deviation of 0.1 microstrain) and GPS displacement (with a standard deviation of 1 mm, which is at the lower limit of the GPS noise level). In the inversion, we determine the optimal value based on the L-curve analysis (57). We find that the inversion with LFDAS strain has higher resolution near the fiber cable and better depth resolution compared to the GPS. For the joint inversion using both LFDAS strain and GPS displacements, we set the weighting as

$$\frac{{w}_{DAS}}{{w}_{GPS}} = \frac{{λ}_{GPS}}{{λ}_{DAS}}$$

where λ_{DAS} and λ_{GPS} are the optimal damping parameter determined by individual L-curve analyses. As expected, including GPS data in joint inversion further improves the resolution on the northeast section of the dike (FIG. 24).

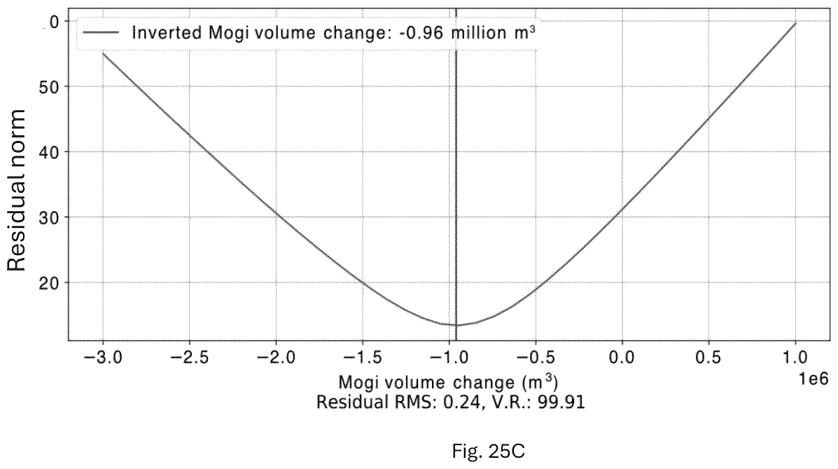

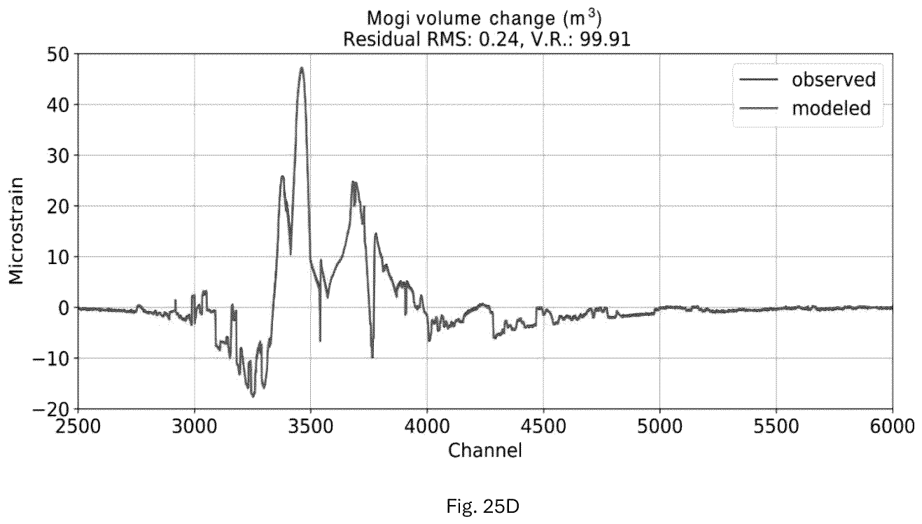

Finally, we demonstrate that the Mogi deflation volume can be resolved in a synthetic test. The input model includes an opening dike with a total volume of 3 million m³ and a deflation of 1 million m³. In this test, we solve the equation (S2) and are able to resolve both the dike opening pattern and the volume change within either the dike or the Mogi source (FIG. 25).

### (v) Stress and Cumulative Opening Modeling

In FIGS. 14 and 15, we show cumulative opening and normal stress changes on the dike plane and compare them to the November 2023 dike modeled by Sigmundsson et al. (2024) (11). First, we use the dike opening model for the November dike and project it into the plane of our modeled dikes. The two grids are then colocated by interpolating the projected opening of the November dike using nearest neighbor interpolation onto our modeled dike plane. Since the results of Sigmundsson et al. (2024) are less smooth than our results, we apply a 5-point averaging over the grid to achieve comparable smoothness, allowing for a more meaningful summation of the two datasets. Cumulative opening is generated by summing up the main events, including E4a, but excluding E5a and E6a, which contribute little to the overall opening.

If the cumulative opening at a specific time is given by m, then the cumulative changes in normal stress acting on the dike plane can be calculated by computing the matrix of influence coefficients G_{σ}, whose n-th row is a vector representing the contribution to the normal stress change due to the unit opening of all dislocations onto the n-th dislocation. In other words, element (n,m) represents the contribution to the normal stress change from the unit opening of the m-th element at the center of the n-th element. We use rectangular dislocations in an elastic half-space to compute each influence coefficient (37). Having constructed G_{σ}, the normal stress change Δσ can be rapidly evaluated for each opening vector m using matrix multiplication:

$$Δ σ = {G}_{σ} m . \qquad ( S3 )$$

### (vi) A Coupled Dike and Magma Chamber Model

We consider a simple coupled dike and magma chamber model following the approach by Segall et al. (13), where a chamber feeds magma to the dike. In the following, we perform simulations and make discussions based on four dimensionless equations (25a-d) as described in (13). The dimensionless equations contain four time-dependent variables a^{~}, b^{~}, p^{~}_{d}, and p^{~}_{c}, with a^{~} and b^{~} representing the dimensionless half length of horizontal and vertical axis of the semiellipsoid, and p^{~}_{d} and p^{~}_{c} representing the dimensionless overpressure within the dike and in the chamber respectively. The temporal evolution of these four parameters is controlled by three non-dimensional parameters α, Ψ, and R:

$$a = \frac{Δ pgd}{Δ {p}_{0}} \qquad ( S4 )$$

$$Ψ = \frac{2 π ( 1 - v ) {d}^{3}}{3 {V}_{c} {β}_{c}^{∼} μ} ,$$

$$R = \frac{{τ}_{prop}}{{τ}_{flow}} = \frac{9 η c {μ}^{3}}{8 {{πρ}_{m} [ ( 1 - v ) Δ {p}_{0} d ]}^{3}} ,$$

$$where :$$

$${τ}_{prop} = {\frac{3 ημ}{4 {( 1 - v )}^{2} μΔ {p}_{0}}}^{3} , \qquad ( s5 )$$

$${τ}_{flow} = \frac{2 π ( 1 - v ) {ρ}_{m} {d}^{3}}{3 μ c} .$$

Here, τₚᵣₒₚ represents the characteristic time for magma propagation and τ_{flow} represents the characteristic time for flow between the magma reservoir and a half unit-circle stationary dike. Parameter Δρ represents the effective density and has the form following (13):

$$Δρ = ( {ρ}_{m} - {ρ}_{r} ) + ( 1 - ϵ ) {ρ}_{r} . \qquad ( S6 )$$

The physical parameters are as the following:
g: gravitational acceleration,
ρₘ: magma density,
ρᵣ: crust density,
μ: shear modulus,
v: Poisson's ratio,
η: magma viscosity,
Δp₀: initial overpressure at dike inlet,
d: dike inlet depth,
β⁻_{c}: magma chamber effective compressibility,
V_{c}: magma chamber volume, and
c: conduit geometry constant.

The parameter E represents the ratio between the vertical gradient of normal stress

$$\frac{d σ}{dz}$$

over the lithostatic stress ρᵣg (13). Since normal stress σ(z) is composed of tectonic stress σₜ(z) and lithostatic stress σₗᵢₜₕₒ(z)=ρᵣgz (assuming a homogeneous shallow crust density). We have:

$$\frac{d σ}{dz} = {ϵρ}_{r} g = {ρ}_{r} g + \frac{d {σ}_{t}}{dz} . \qquad ( S7 )$$

Taking (S7) into (S6), the effective density can be rewritten as:

$$Δρ = ( {ρ}_{m} - {ρ}_{r} ) - \frac{1}{g} \frac{d {σ}_{t}}{dz} \qquad ( S8 )$$

In the shallow crust, ρₘ>ρᵣ. The first term on the right of (S8) represents the negative buoyancy, and the second term represents the competing vertical gradient of tectonic normal stress.

The evolution of dike intrusion varies substantially given different non-dimensional parameters α, Ψ, R. We perform a grid search to identify the optimal set of parameters that can reproduce the observed dike volume rate history by solving the dimensionless equations (25a-d) in (13) (Ain FIG. 20). To compare the synthetic and observed dike volume rate functions

$$\frac{{dV}_{d}}{dt} ,$$

we normalize both curves such that their maximum amplitudes are equal to 1. Their time axes are also normalized by the time interval Δt=tₑᵣᵤₚₜ−tₚₑₐₖ between the eruption (if eruption occurred, that is b≥1) and the peak dike volume rate (B in FIG. 20). For an optimal non-dimensional parameter set, we can calculate its synthetic interval Δt_{syn}. Given the observed time interval between the eruption and dike volume rate peak to be about 20 minutes (i.e. Δt_{obs}=1200 s) (B in FIG. 12), the characteristic time for magma propagation τₚᵣₒₚ can be calculated using:

$${τ}_{prop} = \frac{Δ {t}_{obs}}{Δ {t}_{syn}} . \qquad ( S9 )$$

We can then estimate some physical properties of this magma plumbing system, such as the initial overpressure Δp₀, the effective density Δρ, and the volume of the magma chamber V_{c}. For these calculations, we assume a shear modulus μ of 15 GPa, a Poisson's ratio v of 0.27 (11), and density of magma and crust to be ρₘ=2610 kg m⁻³ and ρᵣ=2350 kg m⁻³ respectively (10). First, given the calculated τₚᵣₒₚ, the initial overpressure Δp₀ is a function of the magma viscosity η via the first equation in (S5) (C in FIG. 20). Assuming a dike inlet depth of 2.5 km, the inferred a suggests a low effective density (an upper bound of 76 kg m⁻³ given α=0.31 and Δp₀=6 MPa). This low effective density implies either small negative buoyancy, a positive vertical stress gradient, or a combination of both (S8). Given the assumed densities above, the resulting vertical stress gradient

$$\frac{d {σ}_{t}}{dz} = ( ε - 1 ) {ρ}_{r} g$$

is positive and corresponds to approximately 10% of the lithostatic stress gradient (D in FIG. 20). Such a stress gradient may have been locally induced by the November dike intrusion. Furthermore, given an inverted, the magma chamber volume V_{c} is a function of the effective compressibility of magma chamber through the second equation in (S4) (E in FIG. 20).

In most recorded eruptive events, we first observe an initial positive slope in the dike's volume rate curve, which peaks before the eruption begins. After this peak, the slope decreases as the dike nears the surface. To gain an intuitive insight on the mechanisms driving the dike's volume rate and its recurring behavior across eruptive events, we focus on the second-order time derivative of the dike's volume. Following (13), the dike volume rate

$$\frac{{dV}_{d}}{dt}$$

is proportional to the differential overpressure between the magma chamber and the dike p^{~}_{c}−p^{~}_{d}. We have:

$$\frac{{d}^{2} {V}_{d}}{{dt}^{2}} ∝ ( \frac{{dp}_{c}^{∼}}{dt} - \frac{{dp}_{d}^{∼}}{dt} ) \qquad ( S10 )$$

When b^{~}<1 and p^{~}_{d}>αb^{~}, by substituting equations (25a-d) in (13), we have:

$$\frac{{d}^{2} {V}_{d}}{{dt}^{2}} ∝ \frac{{p}_{d}^{∼ 3}}{{E ( k )}^{2}} [ ( 1 - A ) {( {}^{∼} {\frac{b}{a}}^{∼} )}^{2} {p}_{d}^{∼} + ( 2 + A ) ( {p}_{d}^{∼} - α {b}^{∼} ) ] - R ( {p}_{c}^{∼} - {p}_{d}^{∼} ) [ ( \frac{E ( k )}{{a}^{∼} {b}^{∼ 2}} + Ψ ) ] , \qquad ( S11 )$$

with:
E(k): the complete elliptical integral of the second kind of modulus

$$k = \sqrt{\frac{1 - {b}^{∼ 2}}{a} {}^{∼} 2} , ,$$

the dike shape constant varying between 0 (thin blade) and −0.5 (circular crack).

The terms in the square brackets in (S11) are always positive. The dike overpressure p^{~}_{d} is greater than 0. In addition, since the intrusion process is driven by differential overpressure p^{~}_{c}−p^{~}_{d}, the overpressure within the chamber must be greater than or equal to the overpressure within the dike, i.e. p^{~}_{c}−p^{~}_{d}≥0. The dike's volume rate evolution is then controlled by the term in (S11) that dominates at any given time. In this model, we initially have equilibrium of overpressure between the chamber and the dike. Then following this equilibrium the dike grows, and thus, to have a positive volume rate of the dike, the dike pressure must drop faster than the chamber pressure. Otherwise, the temporal derivative of the differential overpressure

$$\frac{d}{dt}$$

(p^{~}_{c}−p^{~}_{d}) will be smaller than zero, which means the differential overpressure p^{~}_{c}−p^{~}_{d} will become negative. Thus, from (S10), the second-order derivative

$$\frac{{d}^{2} {V}_{d}}{{dt}^{2}}$$

is initially larger than 0, and the dike volume rate is increasing. As time increases, the overpressure within the dike p^{~}_{d} will decrease. This will both decrease the first term and increase the second term in equation (S11) and makes

$$\frac{{d}^{2} {V}_{d}}{{dt}^{2}} < 0$$

In between, the second-order derivative of dike volume must have crossed zero, when the dike volume rate reached its peak. This model provides a useful framework for understanding the primary mechanisms that lead to the dike's surface breakthrough. However, it neglects the dynamics of initial dike growth away from the magma chamber, when is not simply given by the pressure difference between the chamber and the dike (as reflected in equation (S10). Initially, the dike has a large internal pressure gradient that depends on the dike length (58). It is thus unclear how appropriate the model is for the initial phase of diking or if the pressure equilibrium condition is met at some stage. We suggest that with further analysis, the LFDAS may help distinguish between different physical models of diking and provide insight into the fundamental dynamics of magma chamber and dike interactions.

Table T1 below shows the event time and LFDAS processing time window for each intrusive event. For eruptions E1-E6, event time represents the eruption time. The processing time window are visually determined from the LFDAS strain rate recordings such that apparent LFDAS recordings are included within the processing time window.

| Event | | processing | processing |
|---|---|---|---|
| ID | event time | begin time | end time |
| E1 | 2023-12-18T22:17 | 2023-12-18T20:30 | 2023-12-19T05:30 |
| E2 | 2024-01-14T07:57 | 2024-01-14T03:00 | 2024-01-14T14:00 |
| E3 | 2024-02-08T06:02 | 2024-02-08T04:40 | 2024-02-08T13:40 |
| E4a | 2024-03-02T16:00 | 2024-03-02T15:00 | 2024-03-02T19:00 |
| E4 | 2024-03-16T20:23 | 2024-03-16T19:00 | 2024-03-17T04:00 |
| E5a | 2024-05-10T02:00 | 2024-05-10T01:30 | 2024-05-10T02:30 |
| E5 | 2024-05-29T12:46 | 2024-05-29T10:30 | 2024-05-29T16:30 |
| E6a | 2024-07-29T08:15 | 2024-07-29T08:00 | 2024-07-29T09:00 |
| E6 | 2024-08-22T21:26 | 2024-08-22T20:30 | 2024-08-23T05:30 |

### Example Interrogator

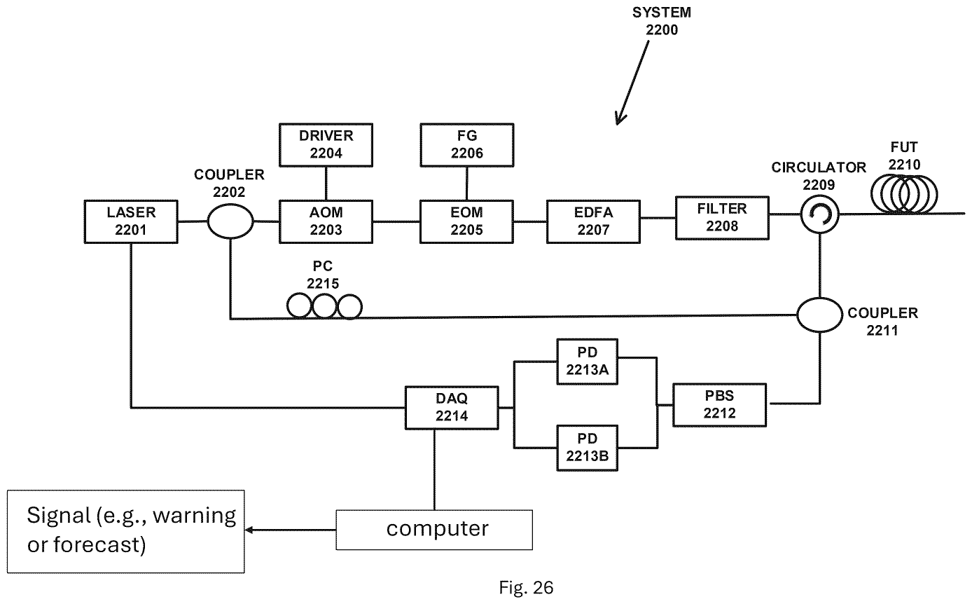

FIG. 26 is a diagram of an exemplary interrogator 2200 used for optical fiber sensing according to this invention (adapted from [60}, wherein the system 2200 includes a laser source 2201, optical coupler 2202, acousto-optic modulator (AOM) 2203, driver 2204, electro-optic modulator (EOM) 2205, function generator (FG) 2206, erbium-doped fiber amplifier (EDFA) 2207, filter 2208, optical circulator 2209, fiber under test (FUT) 2210, optical coupler 2211, polarization beam splitter (PBS) 2212, photodiodes (PD) 2213, data acquisition device (DAQ) 2214, and polarization controllers (PC) 2215.

The laser source 2201 emits a continuous wave (CW) coherent light beam with a relatively broad line width (~0.1 nm) to avoid interference induced by Rayleigh backscattered light in the FUT 2210. The laser source 2201 is optically coupled by coupler 2202 to the AOM 2203.

The AOM 2203 is controlled by the driver 2204 to provide switching or “gating” of the laser beam to create a train of light pulses so that ranging (time-of-flight of each pulse launched in the fiber) can be performed by mapping backscatter to distance along the fiber, thereby enabling spatial localization of perturbations along the fiber. The AOM also imparts a known frequency shift to each of the pulses so that stable heterodyne phase detection can be performed during demodulation.

The EOM 2205 is controlled by the FG 2206, e.g., to perform phase modulation, intensity modulation and/or polarization modulation of the train of light pulses.

The EDFA 2207 amplifies the light pulses, the filter 2208 filters the light pulses, which are then launched into the FUT 2210 by the circulator 2209.

In the demodulation process, the backscattered light returning through the optical circulator is combined with a reference optical field (LO) split from the same laser source by coupler to enable coherent detection. In the coherent configuration of FIG. 26, the combined optical fields are split by a polarization beam splitter (PBS) and detected by two photodiodes (PDs) in a balanced detection arrangement. The PDs convert the optical interference signals into complementary electrical signals that are subtracted to suppress common-mode noise and recover a heterodyne beat signal whose phase represents the local optical phase at each time-resolved fiber location. The beat signal is digitized by the data-acquisition (DAQ) system, and digital demodulation is performed to extract phase as a function of both distance and time, thereby yielding distributed dynamic strain or vibration measurements. Ranging is performed in the data acquisition device (DAQ) by comparing the absolute timing of detected Rayleigh backscattered signals with the launch time of the transmitted optical pulses, thereby determining the spatial location of scattering events along the fiber from the measured round-trip propagation delay. The strain rate data in each of the channels along the fiber can then be determined from the phase data.

Example interrogators include, but are not limited to, those in [62, 63].

In one or more embodiments using submarine cables comprising fibers, Rayleigh backscattering in transmission fiber propagates into receiving fiber through optical couplers installed in the submarine repeaters. Those optical couplers are standard part of every cable design. No modification in the submarine cable wetplant is needed, and every cable, even old cables, can be monitored entirely with sub-kilometer resolution based on Rayleigh backscattering. Couplers set attenuation of more than 10,000 times for Rayleigh backscattering but remaining small signal can be detected with coherent optical detection techniques. High capabilities are enabled by highly coherent lasers, which are commercially available today. The revolution that happened in data transmission during the last decade is applicable to optical fiber sensing. Therefore, optical fiber sensing techniques described in Ref.59 would likely be improved to enable entire cable monitoring, meaning every kilometer of the cable between repeaters would become a fiber sensor. The very same low frequency filtering algorithms described above are applicable to multi-span Rayleigh backscattering in transcontinental submarine cables.

In one or more embodiments, the interrogator can be coupled to or comprise a computer-implemented system as described herein, comprising:
a computer programmed to:
receive distributed optical fiber sensing (OFS) data from a plurality of channels along at least one optical fiber in an active telecommunications network, the optical fiber in physical contact with ground that experiences a quasi-static deformation in response to one or more changes in at least one physical state of a source of the quasi-static ground deformation; and
monitoring (e.g., using the computer) a change in the source as a function of time using the OFS data comprising or converted to strain or strain rate data and/or processing the OFS data to identify deformation patterns indicative of the quasi static ground deformation, and optionally outputting (from the computer) a monitoring signal indicating a status of or representing the change and/or displaying (in the computer) data representing the deformation patterns.

The interrogator and/or computer can be located in a residential or commercial/industrial building with optical fiber service, wherein the optical fiber is used for local sensing of mass movement as used herein. Alternatively, the interrogator and/or computer system can be located at a remote location, e.g., a network operation center, cable landing station. Predictions can be used for assessing insurance claims, for example.

### Hardware Environment

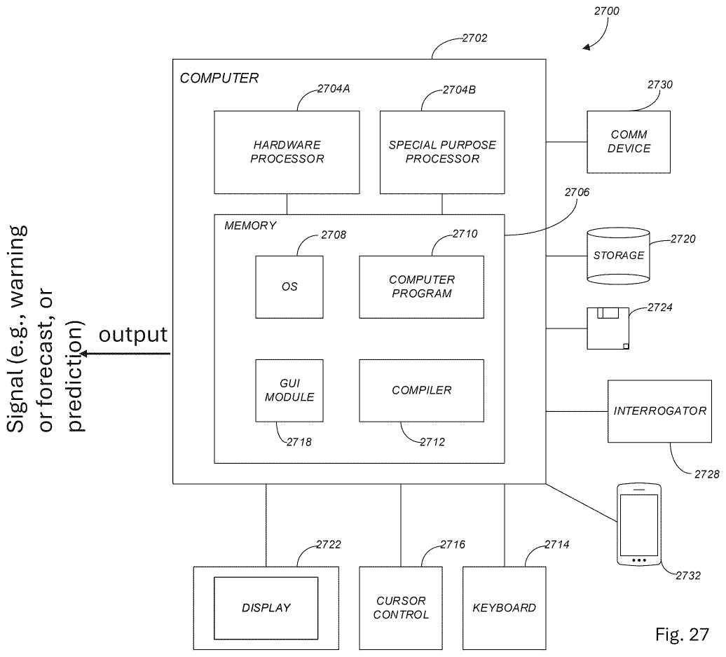

FIG. 27 is an exemplary hardware and software environment 2700 (referred to as a computer-implemented system and/or computer-implemented method) used to implement one or more embodiments of the invention. The hardware and software environment includes a computer 2702 coupled to an interrogator 2728 or other device for outputting and receiving OFS signals used to measure the strain as described herein, and may include peripherals. Computer 2702 may be a user/client computer, server computer, or may be a database computer. The computer 2702 comprises a hardware processor 2704A and/or a special purpose hardware processor 2704B (hereinafter alternatively collectively referred to as processor 2704) and a memory 2706, such as random access memory (RAM). The computer 2702 may be coupled to, and/or integrated with, other devices, including input/output (I/O) devices such as a keyboard 2714, a cursor control device 2716 (e.g., a mouse, a pointing device, pen and tablet, touch screen, multi-touch device, etc.) and a printer. In one or more embodiments, computer 2702 may be coupled to, or may comprise, a portable or media viewing/listening device 2732 (e.g., an MP3 player, IPOD, NOOK, portable digital video player, cellular device, personal digital assistant, etc.). In yet another embodiment, the computer 2702 may comprise a multi-touch device, mobile phone, gaming system, internet enabled television, television set top box, or other internet enabled device executing on various platforms and operating systems.

In one embodiment, the computer 2702 operates by the hardware processor 2704A performing instructions defined by the computer program 2710 under control of an operating system 2708. The computer program 2710 and/or the operating system 2708 may be stored in the memory 2706 and may interface with the user and/or other devices to accept input and commands and, based on such input and commands and the instructions defined by the computer program 2710 and operating system 2708, to provide output and results.

Output/results may be presented on the display 2722 or provided to another device for presentation or further processing or action. In one embodiment, the display 2722 comprises a liquid crystal display (LCD) having a plurality of separately addressable liquid crystals. Alternatively, the display 2722 may comprise a light emitting diode (LED) display having clusters of red, green and blue diodes driven together to form full-color pixels. Each liquid crystal or pixel of the display 2722 changes to an opaque or translucent state to form a part of the image on the display in response to the data or information generated by the processor 2704 from the application of the instructions of the computer program 2710 and/or operating system 2708 to the input and commands. The image may be provided through a graphical user interface (GUI) module 2718. Although the GUI module 2718 is depicted as a separate module, the instructions performing the GUI functions can be resident or distributed in the operating system 2708, the computer program 2710, or implemented with special purpose memory and processors.

In one or more embodiments, the display 2722 is integrated with/into the computer 2702 and comprises a multi-touch device having a touch sensing surface (e.g., track pod, touch screen, smartwatch, smartglasses, smartphones, laptop or non-laptop personal mobile computing devices) with the ability to recognize the presence of two or more points of contact with the surface. Examples of multi-touch devices include mobile devices (e.g., IPHONE, ANDROID devices, WINDOWS phones, GOOGLE PIXEL devices, NEXUS S, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 2702 according to the computer program 2710 instructions may be implemented in a special purpose processor 2704B. In this embodiment, some or all of the computer program 2710 instructions may be implemented via firmware instructions stored in a read only memory (ROM), a programmable read only memory (PROM) or flash memory within the special purpose processor 2704B or in memory 2706. The special purpose processor 2704B may also be hardwired through circuit design to perform some or all of the operations to implement the present invention. Further, the special purpose processor 2704B may be a hybrid processor, which includes dedicated circuitry for performing a subset of functions, and other circuits for performing more general functions such as responding to computer program 2710 instructions. In one embodiment, the special purpose processor 2704B is an application specific integrated circuit (ASIC), field programmable gate array (FPGA), graphics processing unit (GPU), or processor optimized for machine learning, artificial intelligence and/or neural networks.

The computer 2702 may also implement a compiler 2712 that allows an application or computer program 2710 written in a programming language such as C, C++, Assembly, SQL, PYTHON, PROLOG, MATLAB, RUBY, RAILS, HASKELL, or other language to be translated into processor 2704 readable code. Alternatively, the compiler 2712 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 2710 accesses and manipulates data accepted from I/O devices and stored in the memory 2706 of the computer 2702 using the relationships and logic that were generated using the compiler 2712.

The computer 2702 also optionally comprises an external communication device such as a modem, satellite link, Ethernet card, or other device for accepting input from, and providing output to, other computers 2702.

In one embodiment, instructions implementing the operating system 2708, the computer program 2710, and the compiler 2712 are tangibly embodied in a non-transitory computer-readable medium, e.g., data storage device 2720, which could include one or more fixed or removable data storage devices, such as a zip drive, floppy disc drive 2724, hard drive, CD-ROM drive, tape drive, etc. Further, the operating system 2708 and the computer program 2710 are comprised of computer program 2710 instructions which, when accessed, read and executed by the computer 2702, cause the computer 2702 to perform the steps necessary to implement and/or use the present invention or to load the program of instructions into a memory 2706, thus creating a special purpose data structure causing the computer 2702 to operate as a specially programmed computer executing the method steps described herein. Computer program 2710 and/or operating instructions may also be tangibly embodied in memory 2706 and/or data communications devices 2730, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 2702.

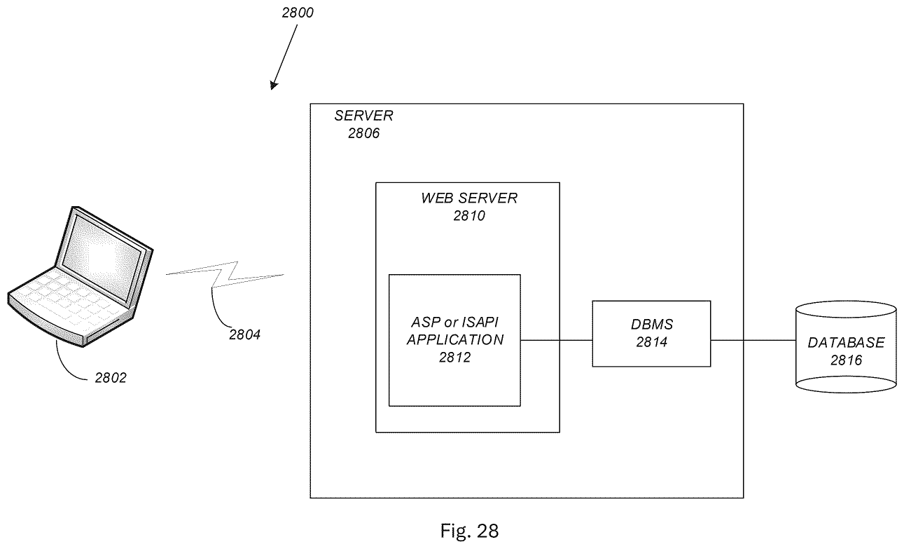

FIG. 28 schematically illustrates a typical distributed/cloud-based computer system 2800 using a network 2804 to connect client computers 2802 to server computers 2806. A typical combination of resources may include a network 2804 comprising the Internet, LANs (local area networks), WANs (wide area networks), SNA (systems network architecture) networks, or the like, clients 2802 that are personal computers or workstations (as set forth in FIG. 27), and servers 2806 that are personal computers, workstations, minicomputers, or mainframes (as set forth in FIG. 27). However, it may be noted that different networks such as a cellular network (e.g., GSM [global system for mobile communications] or otherwise), a satellite based network, or any other type of network may be used to connect clients 2802 and servers 2806 in accordance with embodiments of the invention.

A network 2804 such as the Internet connects clients 2802 to server computers 2806. Network 2804 may utilize ethernet, coaxial cable, wireless communications, radio frequency (RF), etc. to connect and provide the communication between clients 2802 and servers 2806. Further, in a cloud-based computing system, resources (e.g., storage, processors, applications, memory, infrastructure, etc.) in clients 2802 and server computers 2806 may be shared by clients 2802, server computers 2806, and users across one or more networks. Resources may be shared by multiple users and can be dynamically reallocated per demand. In this regard, cloud computing may be referred to as a model for enabling access to a shared pool of configurable computing resources.

Clients 2802 may execute a client application or web browser and communicate with server computers 2806 executing web servers 2810. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 2802 may be downloaded from server computer 2806 to client computers 2802 and installed as a plug-in or ACTIVEX control of a web browser. Accordingly, clients 2802 may utilize ACTIVEX components/component object model (COM) or distributed COM (DCOM) components to provide a user interface on a display of client 2802. The web server 2810 is typically a program such as MICROSOFT'S INTERNET INFORMATION SERVER.

Web server 2810 may host an Active Server Page (ASP) or Internet Server Application Programming Interface (ISAPI) application 2812, which may be executing scripts. The scripts invoke objects that execute business logic (referred to as business objects). The business objects then manipulate data in database 2816 through a database management system (DBMS) 2814. Alternatively, database 2816 may be part of, or connected directly to, client 2802 instead of communicating/obtaining the information from database 2816 across network 2804. When a developer encapsulates the business functionality into objects, the system may be referred to as a component object model (COM) system. Accordingly, the scripts executing on web server 2810 (and/or application 2812) invoke COM objects that implement the business logic. Further, server 2806 may utilize MICROSOFT'S TRANSACTION SERVER (MTS) to access required data stored in database 2816 via an interface such as ADO (Active Data Objects), OLE DB (Object Linking and Embedding DataBase), or ODBC (Open DataBase Connectivity).

Generally, these components 2800-2816 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 2802 and 2806 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 2802 and 2806. Embodiments of the invention are implemented as a software application on a client 2802 or server computer 2806. Further, as described above, the client 2802 or server computer 2806 may comprise a thin client device or a portable device that has a multi-touch-based display.

### System and Method and Device/Apparatus Embodiments

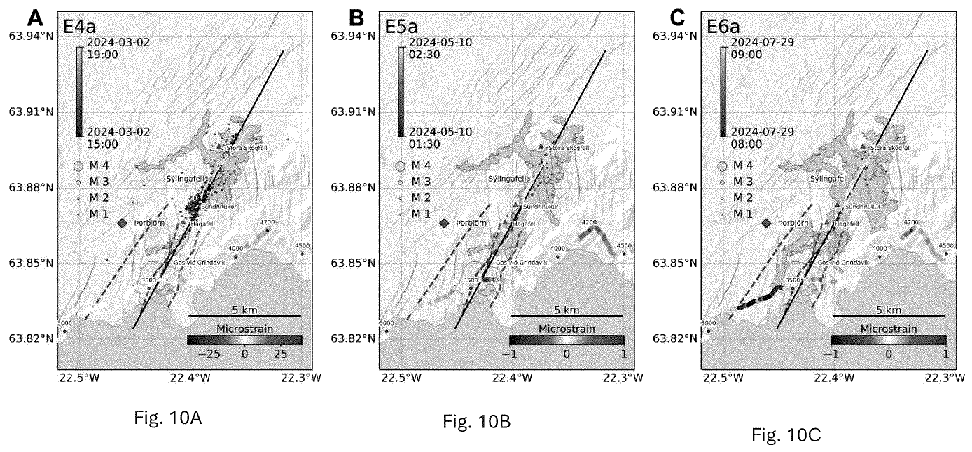

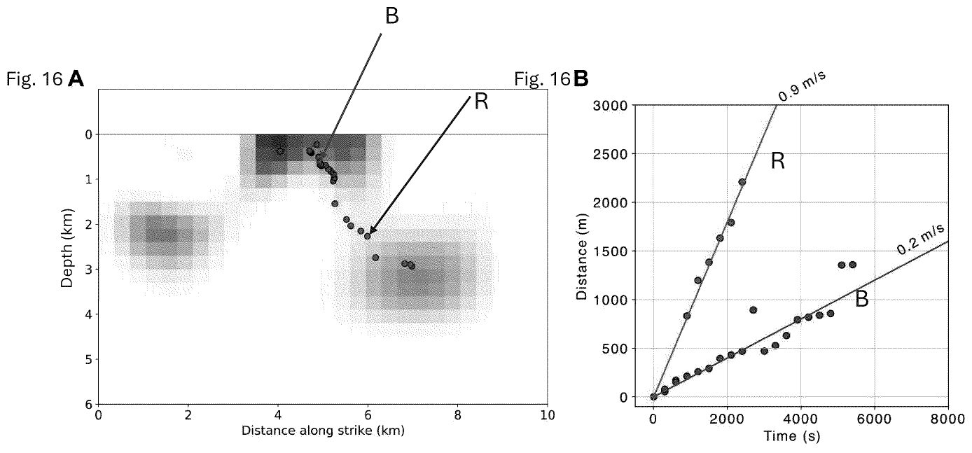

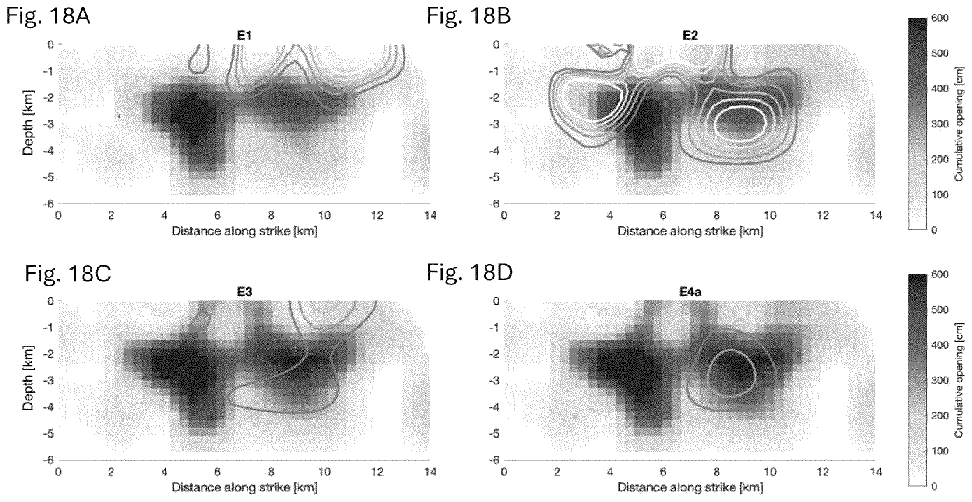

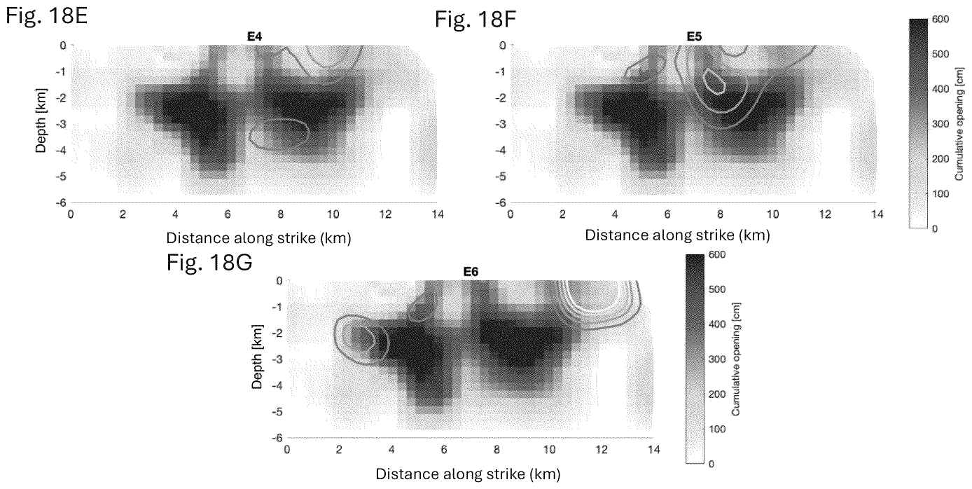

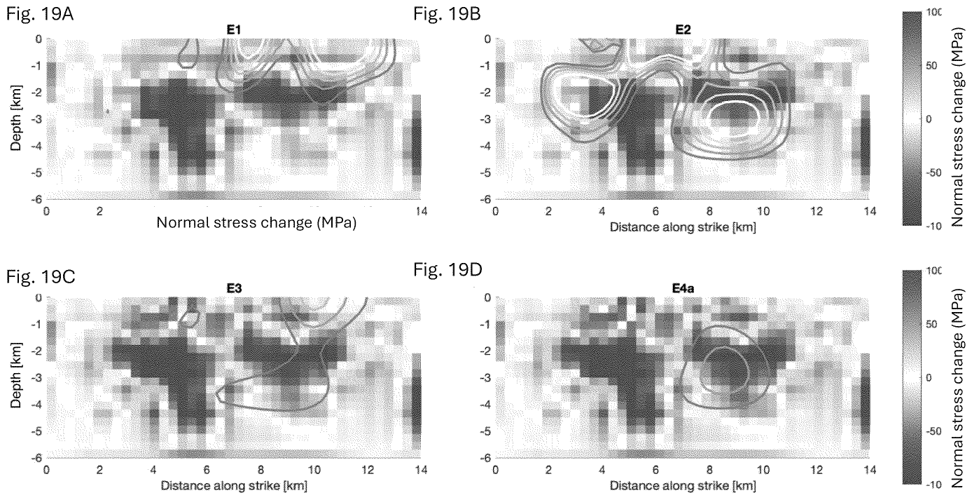

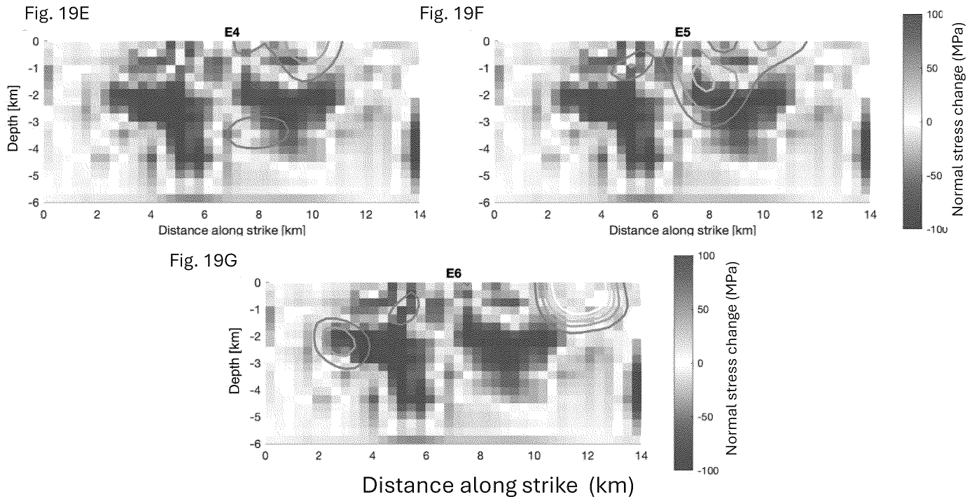

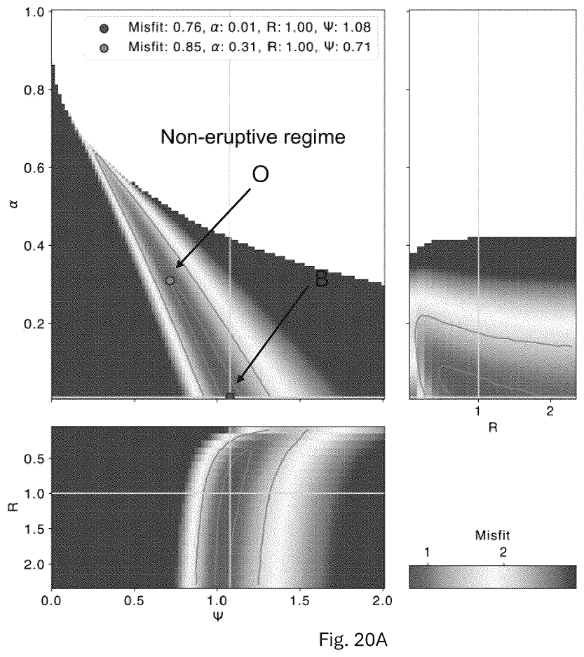

Illustrative embodiments include, but are not limited to, the following (referring also to example implementations in FIGS. 1-28).
1. A (e.g., computer implemented) method for detecting and monitoring low frequency or quasi static ground deformation distinct from seismic wave propagation, comprising:
obtaining (e.g., distributed) optical fiber sensing (OFS) data (e.g., in a computer) from a plurality of sensing points along at least one optical fiber in or coupled to a region susceptible to ground deformation; and
processing (e.g., in the computer) the OFS data to identify deformation patterns indicative of the quasi static ground deformation and optionally outputting (from the computer) or displaying (on the computer) the deformation patterns or data representing the patterns.
2. The method of clause 1, further comprising:
processing the OFS (e.g., DAS) data, comprising phase and/or amplitude of Rayleigh backscatter caused by elongation or compression of the fiber, to obtain strain data and processing the strain data using a model relating the strain data to input parameters describing the deformation in the region, and wherein the input parameters are (e.g., iteratively) adjusted so that a difference between the strain data and calculated strain data using the parameters is minimized, and optionally outputting (from the computer) the parameters calculated using the model and the strain.
3. A (e.g., computer implemented) method for detecting and monitoring a source, comprising:
receiving (e.g., distributed) acoustic sensing (DAS) data (e.g., in the computer) from a plurality of channels along at least one optical fiber in an active telecommunications network, the optical fiber in or physically coupled to a region that may be susceptible to a source of a quasi-static ground deformation; and
monitoring (e.g., using the computer) a change in the source as a function of time using the DAS data comprising or converted to strain rate data and optionally outputting (from the computer) a monitoring signal indicating a status of the change.
4. A (e.g., computer implemented) method for monitoring a source, comprising: receiving (e.g., distributed) optical fiber sensing (OFS) data (e.g., in the computer) from a plurality of channels along at least one optical fiber 470 in an active telecommunications network, the optical fiber in physical contact with ground 401 susceptible to a quasi-static deformation in response to one or more changes in at least one physical state of a source of the quasi-static ground deformation; and
monitoring (e.g., using the computer) a change in the source as a function of time using the OFS data comprising or converted to strain or strain rate data and/or processing the OFS data to identify deformation patterns indicative of the quasi static ground deformation, and optionally outputting (from the computer) a monitoring signal indicating a status of or representing the change and/or displaying (in the computer) data representing the deformation patterns.
5. The method of any of the clauses 1-4, further comprising inferring, from or using the strain or strain rate data, future mass movement resulting from the one or more changes and optionally outputting and/or displaying (from or in the computer) a signal or data representing, characterizing, or indicating the future mass movement.
6. The method of any of the clauses 1-5, wherein:
   the monitoring or processing uses the strain or strain rate data having temporal frequency components less than about 0.1 Hz (e.g., in a range of 0.005 Hz-0.1 Hz).
7. The method of any of the clauses 1-6, wherein the quasi-static deformation is characterized by the strain or strain rate data temporally filtered with a low pass filter (signal processing) with a maximum cutoff frequency at or below about 0.1 Hz, e.g., thereby retaining minute-scale to hour-scale deformation.
8. The method of any of the clauses 1-7, further comprising performing a geodetic measurement of the ground deformation and/or the source using the strain or strain rate data and wherein the strain-rate data is obtained with minute-scale temporal resolution, comprising sampling intervals in a range of approximately 1 to 120 seconds.
9. The method of any of the clauses 1-8, further comprising processing the OFS data to obtain the strain rate data.
10. The method of any of the clauses 1-9, wherein the OFS data comprises distributed acoustic sensing (DAS) data.
9. 11. The method of any of the clauses 1-10, wherein the monitoring or processing comprises calculating or determining, from the OFS data comprising or converted to strain or strain rate data, a metric for the source that can be used to infer future mass movement resulting from the one or more changes and optionally outputting and/or displaying (from or in the computer) a signal or data representing, characterizing, or indicating the future mass movement.
12. The method of any of the clauses 1-11, wherein the metric is the strain rate data above a predetermined threshold with the changes and that is a predictor or forecast of the mass movement 403 corresponding to a sinkhole 418, avalanche, landslide, mudslide, fault creeping, or magma eruption 408, or seafloor deformation 424, the method further comprising:
outputting a signal forecasting and/or warning the avalanche, mudslide, landslide, sinkhole formation, or magma eruption if the strain rate data is above the predetermined threshold.
13. The method of any of the clauses 1-12, further comprising outputting the metric in real time with the changes and wherein the metric measures the changes at a time scale of 1 minute or less.
14. The method of any of the clauses 1-13, wherein the changes and/or ground deformation(s), and/or the strain, and/or the strain rate data have a temporal period in a range of 1-6 hours.
15. The method of any of the clauses 1-14, wherein the source and positioning of the optical fiber are such that the OFS data can be processed to measure a strain rate of greater than 0.1 nanostrain per second for the optical fiber in a range of 5 m-50 km of the source and/or a strain having a frequency of more than 0.1 Hz and when at least a portion of the fiber is not in physical contact with the mass movement.
16. The method of any of the clauses 1-15, comprising:
receiving, in a computer, the strain rate data measured using the OFS data comprising phase of Rayleigh backscatter from the optical fiber caused by strain applied to the fiber in response to the ground deformation;
receiving, in the computer, source information useful in an algorithm modeling the strain rate data as a function of the physical state of the source; and calculating the metric comprising a time evolution of the at least one physical state from the strain rate data and the source information.
17. The method of any of the clauses 1-16, wherein the calculating comprises using the algorithm to numerically solve a model for the strain rate data as an inverse problem using a Green's function method, minimizing an objective function, an iterative gradient method, or a least squares method.
18. The method of any of the clauses 1-16, wherein:
the mass movement is a magma eruption 408 at a surface of the ground,
the source information comprises:
location and orientation of one or more dikes 440 connected to one or more magma chambers 402, and
location of the magma chambers, and
the at least one physical/source state comprises:
dike opening size 404 at different depths as a function of time,
magma chamber deflation volume as a function of time,
and a further input to the computer includes at least one of an elastic property of the surrounding crust or a coupling factor for conversion of the strain rate data to a ground strain.
19. The method of any of the clauses 1-17, wherein source is a source of a sinkhole 418, the mass movement is ground collapse, the source information includes location of a slip plane, and the physical source state is deflation and/or subsurface opening of the slip plane.
19. The method of any of the clauses 1-17, wherein the source is a source of the mass movement 403 comprising a landslide, avalanche, or mudslide, fault creeping, the source information includes a location of the slip plane 412, and the physical state is an amount of moving mass 410 or subsurface opening of the slip plane.
20. The method of any of the clauses 1-19, further comprising generating a spatial and temporal map of a subsurface deformation 424 and/or induced subsurface deformation inferred from the strain rate data.
21. The method of any of the clauses 1-20, further comprising processing the OFS data to obtain the strain rate data, comprising:
dividing the fiber into a plurality of the channels each having a gauge length of 5-20 m;
applying a low pass filter (e.g., cut off 0.01 Hz or less) to the OFS data to remove high frequency seismic signals that are not attributed to the ground deformation (e.g., not attributable to magmatic movement or dike intrusion);
applying a first spatial median filter across a plurality of channels to remove common mode noise resulting from temperature fluctuations,
applying a second median filter along both spatial and temporal dimensions to remove the effect of high-frequency earthquake signals and/or traffic signals;
integrating the data in time across each of the channels, and using the integrated signal to obtain strain rate data;
applying a coupling factor to convert OFS strain to actual ground deformation strain (calibrated using GNSS and seismometer data); and
integrating the data along a plurality of neighboring channels to obtain the strain rate data as a function of position along the fiber.
22. A computer-implemented system 2700, comprising:
a computer programmed or configured to:
receive distributed optical fiber sensing (OFS) data (e.g., DAS data) from a plurality of channels along at least one optical fiber in an active telecommunications network, the optical fiber in physical contact with ground that experiences a quasi-static deformation in response to one or more changes in at least one physical state of a source of the quasi-static ground deformation; and
calculate, from the OFS data comprising or converted to strain rate data, a metric for the source that can be used to infer future mass movement resulting from the one or more changes.
23. The system of clause 22, further comprising the computer programmed to output a warning forecasting the mass movement if the metric is above a threshold value.
24. The system of clause 22 or 23, further comprising:
an interrogator 2200 or device coupled to the optical fiber, wherein the interrogator or device comprises a modulator for modulating telecom signals transmitted into the fiber and a demodulator for extracting the OFS data comprising a phase of the Rayleigh backscattering of the telecom signals from each of the channels; and
the interrogator comprising or coupled to the computer 2700 with a link transmitting the OFS data to the computer.
25. The system or method of any of the clauses 1-24, wherein the computer 2700 comprises:
processing circuitry comprising one or more of:
(a) a general-purpose processor configured by executable instructions;
(b) an application-specific integrated circuit (ASIC);
(c) a field-programmable gate array (FPGA); or
(d) a non-transitory memory coupled to the processing circuitry, the memory storing program instructions/software and/or configuration data, wherein the processing circuitry is configured to perform operations, software, an application, and/or instructions comprising the receiving and the monitoring.
26. The system or method of any of the clauses 1-25, further comprising a network of the optical telecommunication fibers, where two or more fibers 470 are used to provide optical fiber sensing data, and used to monitor the changes in time.
27. The system or method of any of the clauses 1-26, wherein the channels are distributed along a length of optical fibers in a range of 50 km-10000 km.
28. The system or method of any of the clauses 1-27, wherein the fibers are in cables, e.g., with addition of optical couplers.
29. The method or system of any of the clauses 1-28, wherein the source and positioning of the optical fiber are such that the OFS (e.g., DAS) data can be processed to measure the strain rate of greater than 0.1 nanostrain per second for the optical fiber within 50 km of the source and/or a strain having a frequency of more than 0.1 Hz.
30. The method of any of the clauses 1-29, further comprising generating a subsurface deformation (e.g., dike opening) and/or induced surface deformation map inferred from the strain data as a function of time and space.
31. The method of clause 30, wherein the maps are generated modeling the crust as an elastic material.
32. The method of clause 18, wherein the model models the magma chamber as a reservoir pushing magma upward, the dike as a crack that opens when magma pressure is above a threshold, a driving force associated with magma pressure inside the chamber and dike, and a resistance to magma flow comprising the weight and stiffness (elastic modulus) of the overlying crust which pushes back to close the crack.
33. The method of clause 18 wherein the source comprises magma, wherein the measured strain from OFS (e.g., DAS) data is used to map how much the crust has deformed, which is directly linked to magma pressure wherein strain is converted to pressure using Shear modulus (μ) Bulk modulus (K) Poisson's ratio (v), and dike opening and deflation can be inferred from pressure.
34. The method of any of the clauses 1-33, wherein the processing outputs the dynamic changes in the deformation pattern at a time scale of 1 minute or less.
35. The method of any of the clauses 1-34, further comprising forecasting a mass movement such as an eruption or ground deformation from the strain data.
36. An apparatus, comprising:
a geodetic or geodesy sensor or system 2700, 2200 operable to:
receive distributed optical fiber sensing (OFS) data (e.g., DAS data) from a plurality of channels along at least one optical fiber in an active telecommunications network, the optical fiber in physical contact with ground that experiences a quasi-static deformation in response to one or more changes in at least one physical state of a source of the quasi-static ground deformation; and
sense a change in the source as a function of time using the OFS data comprising or converted to strain or strain rate data and/or processing the OFS data to identify deformation patterns indicative of the quasi static ground deformation.
37. The apparatus of clause 36 comprising or utilizing the system of any of the clauses 22-34 or implementing or using the method of any of the clauses 1-21.
38. The system of any of the clauses 22-34 or 37 implementing or using the method of any of the clauses 1-21 (e.g., perform the functionality of any of the clauses 1-21)
39. A non-transitory computer-readable medium storing instructions that, when executed by a processor, cause the processor to execute or perform the method or functionalities of any of the clauses 1-38.

### REFERENCES

The following publications are incorporated by reference herein:
1. K. Mogi, Relations between the eruptions of various volcanoes and the deformations of the ground surface around them. Bull. Earthq. Res. Inst. Univ. Tokyo 36, 99-134 (1958).
2. J. Fernández, A. Pepe, M. P. Poland, F. Sigmundsson, Volcano Geodesy: Recent developments and future challenges. J. Volcanol. Geotherm. Res. 344, 1-12 (2017). doi:10.1016/j.jvolgeores.2017.08.006.
3. D. Massonnet, P. Briole, A. Arnaud, Deflation of Mount Etna monitored by spaceborne radar interferometry. Nature 375, 567-570 (1995). doi:10.1038/375567a0.
4. M. P. Poland, H. A. Zebker, Volcano geodesy using InSAR in 2020: The past and next decades. Bull. Volcanol. 84, 27 (2022). doi:10.1007/s00445-022-01531-1.
5. V. Acocella, M. Ripepe, E. Rivalta, A. Peltier, F. Galetto, E. Joseph, Towards scientific forecasting of magmatic eruptions. Nat. Rev. Earth Environ. 5, 5-22 (2024). doi:10.1038/s43017-023-00492-z.
6. K. R. Anderson, T. Shea, K. J. Lynn, E. K. Montgomery-Brown, D. A. Swanson, M. R. Patrick, B. R. Shiro, C. A. Neal, The 2018 Eruption of Kilauea: Insights, Puzzles, and Opportunities for Volcano Science. Annu. Rev. Earth Planet. Sci. 52, 21-59 (2024). doi:10.1146/annurev-earth-031621-075925.
7. P. Segall, A. L. Llenos, S.-H. Yun, A. M. Bradley, E. M. Syracuse, Time-dependent dike propagation from joint inversion of seismicity and deformation data. J. Geophys. Res. Solid Earth 118, 5785-5804 (2013). doi:10.1002/2013JB010251.
8. F. Sigmundsson, A. Hooper, S. Hreinsdóttir, K. S. Vogfjörd, B. G. Ófeigsson, E. R. Heimisson, S. Dumont, M. Parks, K. Spaans, G. B. Gudmundsson, V. Drouin, T. Árnadóttir, K. Jónsdóttir, M. T. Gudmundsson, T. Högnadóttir, H. M. Fridriksdóttir, M. Hensch, P. Einarsson, E. Magnnsson, S. Samsonov, B. Brandsdóttir, R. S. White, T. Ágnstsdóttir, T. Greenfield, R. G. Green, Á. R. Hjartardóttir, R. Pedersen, R. A. Bennett, H. Geirsson, P. C. La Femina, H. Björnsson, F. Pálsson, E. Sturkell, C. J. Bean, M. Möllhoff, A. K. Braiden, E. P. S. Eibl, Segmented lateral dyke growth in a rifting event at Bár\acute{d}arbunga volcanic system, Iceland. Nature 517, 191-195 (2015). doi:10.1038/naturel4111 Medline.
9. R. G. Green, T. Greenfield, R. S. White, Triggered earthquakes suppressed by an evolving stress shadow from a propagating dyke. Nat. Geosci. 8, 629-632 (2015). doi:10.1038/ngeo2491.
10. E. R. Heimisson, P. Segall, Physically Consistent Modeling of Dike-Induced Deformation and Seismicity: Application to the 2014 Bár\acute{d}arbunga Dike, Iceland. J. Geophys. Res. Solid Earth 125, e2019JB018141 (2020). doi:10.1029/2019JB018141.
11. F. Sigmundsson, M. Parks, H. Geirsson, A. Hooper, V. Drouin, K. S. Vogfjörd, B. G. Ófeigsson, S. H. M. Greiner, Y. Yang, C. Lanzi, G. P. De Pascale, K. Jónsdóttir, S. Hreinsdóttir, V. Tolpekin, H. M. Fri\acute{d}riksdóttir, P. Einarsson, S. Barsotti, Fracturing and tectonic stress drive ultrarapid magma flow into dikes. Science 383, 1228-1235 (2024). doi:10.1126/science.adn2838 Medline.
12. W. Bertiger, S. D. Desai, B. Haines, N. Harvey, A. W. Moore, S. Owen, J. P. Weiss, Single receiver phase ambiguity resolution with GPS data. J. Geod. 84, 327-337 (2010). doi:10.1007/s00190-010-0371-9.
13. P. Segall, P. Cervelli, S. Owen, M. Lisowski, A. Miklius, Constraints on dike propagation from continuous GPS measurements. J. Geophys. Res. 106 (B9), 19301-19317 (2001). doi:10.1029/2001JB000229.
14. N. J. Lindsey, E. R. Martin, D. S. Dreger, B. Freifeld, S. Cole, S. R. James, B. L. Biondi, J. B. Ajo-Franklin, Fiber-optic network observations of earthquake wavefields. Geophys. Res. Lett. 44, 11-792 (2017). doi:10.1002/2017GL075722.
15. P. Jousset, T. Reinsch, T. Ryberg, H. Blanck, A. Clarke, R. Aghayev, G. P. Hersir, J. Henninges, M. Weber, C. M. Krawczyk, Dynamic strain determination using fibre-optic cables allows imaging of seismological and structural features. Nat. Commun. 9, 2509 (2018). doi:10.1038/s41467-018-04860-y Medline.
16. Z. Zhan, Distributed Acoustic Sensing Turns Fiber-Optic Cables into Sensitive Seismic Antennas. Seismol. Res. Lett. 91, 1-15 (2019). doi:10.1785/0220190112.
17. G. Currenti, P. Jousset, R. Napoli, C. Krawczyk, M. Weber, On the comparison of strain measurements from fibre optics with a dense seismometer array at Etna volcano (Italy). Solid Earth 12, 993-1003 (2021). doi:10.5194/se-12-993-2021.
18. P. Jousset, G. Currenti, B. Schwarz, A. Chalari, F. Tilmann, T. Reinsch, L. Zuccarello, E. Privitera, C. M. Krawczyk, Fibre optic distributed acoustic sensing of volcanic events. Nat. Commun. 13, 1753 (2022). doi:10.1038/s41467-022-29184-w Medline.
19. A. Fichtner, S. Klaasen, S. Thrastarson, Y. Cubuk-Sabuncu, P. Paitz, K. Jónsdóttir, Fiber-Optic Observation of Volcanic Tremor through Floating Ice Sheet Resonance. The Seismic Record 2, 148-155 (2022). doi:10.1785/0320220010.
20. E. Biondi, W. Zhu, J. Li, E. F. Williams, Z. Zhan, An upper-crust lid over the Long Valley magma chamber. Sci. Adv. 9, eadi9878 (2023). doi:10.1126/sciadv.adi9878 Medline.
21. G. Currenti, M. Allegra, F. Cannavo, P. Jousset, M. Prestifilippo, R. Napoli, M. Sciotto, G. Di Grazia, E. Privitera, S. Palazzo, C. Krawczyk, Distributed dynamic strain sensing of very long period and long period events on telecom fiber-optic cables at Vulcano, Italy. Sci. Rep. 13, 4641 (2023). doi:10.1038/s41598-023-31779-2 Medline.
22. C. Caudron, Y. Miao, Z. J. Spica, C. Wollin, C. Haberland, P. Jousset, A. Yates, J. Vandemeulebrouck, B. Schmidt, C. Krawczyk, T. Dahm, Monitoring underwater volcano degassing using fiber-optic sensing. Sci. Rep. 14, 3128 (2024). doi:10.1038/s41598-024-53444-y Medline.
23. J. Yin, W. Zhu, J. Li, E. Biondi, Y. Miao, Z. J. Spica, L. Viens, M. Shinohara, S. Ide, K. Mochizuki, A. L. Husker, Z. Zhan, Earthquake Magnitude With DAS: A Transferable DataBased Scaling Relation. Geophys. Res. Lett. 50, e2023GL103045 (2023).
24. W. Zhu, E. Biondi, J. Li, J. Yin, Z. E. Ross, Z. Zhan, Seismic arrival-time picking on distributed acoustic sensing data using semi-supervised learning. Nat. Commun. 14, 8192 (2023). doi:10.1038/s41467-023-43355-3 Medline.
25. J. Li, W. Zhu, E. Biondi, Z. Zhan, Earthquake focal mechanisms with distributed acoustic sensing. Nat. Commun. 14, 4181 (2023). doi:10.1038/s41467-023-39639-3 Medline.
26. J. Li, T. Kim, N. Lapusta, E. Biondi, Z. Zhan, The break of earthquake asperities imaged by distributed acoustic sensing. Nature 620, 800-806 (2023). doi:10.1038/s41586-023-06227w Medline.
27. G. Jin, B. Roy, Hydraulic-fracture geometry characterization using low-frequency DAS signal. Leading Edge (Tulsa Okla.) 36, 975-980 (2017). doi:10.1190/tle36120975.1.
28. Y. Liu, G. Jin, K. Wu, G. Moridis, Hydraulic-Fracture-Width Inversion Using Low-Frequency Distributed-Acoustic-Sensing Strain Data-Part I: Algorithm and Sensitivity Analysis. SPE J. 26, 359-371 (2021). doi:10.2118/204225-PA.
29. Y. Liu, G. Jin, K. Wu, G. Moridis, Hydraulic-Fracture-Width Inversion Using Low-Frequency Distributed-Acoustic-Sensing Strain Data Part II: Extension for Multifracture and Field Application. SPE J. 26, 2703-2715 (2021). doi:10.2118/205379-PA.
30. E. F. Williams, A. Ugalde, H. F. Martins, C. E. Becerril, J. Callies, M. Claret, M. R. FernandezRuiz, M. Gonzalez-Herraez, S. Martin-Lopez, J. L. Pelegri, K. B. Winters, Z. Zhan, FiberOptic Observations of Internal Waves and Tides. J. Geophys. Res. Oceans 128, e2023JC019980 (2023).
31. H. Xiao, Z. J. Spica, J. Li, Z. Zhan, Detection of Earthquake Infragravity and Tsunami Waves With Underwater Distributed Acoustic Sensing. Geophys. Res. Lett. 51, e2023GL106767 (2024).
32. T. Tonegawa, E. Araki, High-Frequency Tsunamis Excited Near Torishima Island, Japan, Observed by Distributed Acoustic Sensing. Geophys. Res. Lett. 51, e2024GL108714 (2024).
33. S. M. Ouellet, J. Dettmer, M. J. Lato, S. Cole, D. J. Hutchinson, M. Karrenbach, B. Dashwood, J. E. Chambers, R. Crickmore, Previously hidden landslide processes revealed using distributed acoustic sensing with nanostrain-rate sensitivity. Nat. Commun. 15, 6239 (2024). doi:10.1038/s41467-024-50604-6 Medline.
34. S. W. Matthews, A. Caracciolo, E. Bali, S. A. Halldórsson, O. Sigmarsson, G. H. Guǒfinnsson, G. B. M. Pedersen, J. G. Robin, E. W. Marshall, A. A. Aden, B. Ý. Gisladóttir, C. Bosq, D. Auclair, H. Merrill, N. Levillayer, N. Löw, R. H. Rúnarsdóttir, S. M. Johnson, S. Steinpórsson, V. Drouin, A dynamic mid-crustal magma domain revealed by the 2023 to 2024 Sundhnúksgigar eruptions in Iceland. Science 386, 309-314 (2024). doi:10.1126/science.adp8778 Medline.
35. See the section entitled “Supplementary Materials for Minute-scale Dynamics of Repeated Dike Intrusions in Iceland with Fiber-Optic Geodesy” in U.S. Provisional Patent Application Ser. No. 63/733,583, filed on Dec. 13, 2024, by Jiaxuan Li, Ettore Biondi, Zhongwen Zhan, Valey Kamalov and Vala Hjǒrleifsdóttir, entitled “FIBER-OPTIC GEODESY: HIGH-RESOLUTION SUBSURFACE DEFORMATION MONITORING WITH TELECOMMUNICATION INFRASTRUCTURE,” docket number G&C 176.0260USP1 (CIT 9251-P), which application is cross-referenced above and incorporated by reference herein.
36. LMI, Landmolingar islands (2024); https://atlas.Imi.is/mapview/?application=DEM.
37. Y. Okada, Internal deformation due to shear and tensile faults in a half-space. Bull. Seismol. Soc. Am. 82, 1018-1040 (1992). doi:10.1785/BSSA0820021018
38. Q. Zhai, J. Yin, Y. Yang, J. W. Atterholt, J. Li, A. Husker, Z. Zhan, Comprehensive Evaluation of DAS Amplitude and Its Implications for Earthquake Early Warning and Seismic Interferometry. J. Geophys. Res. Solid Earth 130, e2024JB030288 (2025).
39. E. Rivalta, P. Segall, Magma compressibility and the missing source for some dike intrusions. Geophys. Res. Lett. 35, 35 (2008). doi:10.1029/2007GL032521.
40. L. Wilson, J. W. Head III, Ascent and eruption of basaltic magma on the Earth and Moon. J. Geophys. Res. 86 (B4), 2971-3001 (1981). doi:10.1029/JB086iB04p02971.
41. F. Sigmundsson, M. Parks, A. Hooper, H. Geirsson, K. S. Vogfjord, V. Drouin, B. G. Ófeigsson, S. Hreinsdóttir, S. Hjaltadóttir, K. Jónsdóttir, P. Einarsson, S. Barsotti, J. Horilek, T. Ágnstsdóttir, Deformation and seismicity decline before the 2021 Fagradalsfjall eruption. Nature 609, 523-528 (2022). doi:10.1038/s41586-022-05083-4 Medline.
42. A. Caracciolo, E. Bali, S. A. Halldórsson, G. H. Guǒfinnsson, M. Kahl, I. pór\acute{d}ardóttir, G. L. Pálmadóttir, V. Silvestri, Magma plumbing architectures and timescales of magmatic processes during historical magmatism on the Reykjanes Peninsula, Iceland. Earth Planet. Sci. Lett. 621, 118378 (2023). doi:10.1016/j.epsl.2023.118378.
43. W. W. Chadwick Jr., S. L. Nooner, D. A. Butterfield, M. D. Lilley, Seafloor deformation and forecasts of the April 2011 eruption at Axial Seamount. Nat. Geosci. 5, 474-477 (2012). doi:10.1038/ngeol464.
44. M. A. Clare, I. A. Yeo, S. Watson, R. Wysoczanski, S. Seabrook, K. Mackay, J. E. Hunt, E. Lane, P. J. Talling, E. Pope, S. Cronin, M. Rib6, T. Kula, D. Tappin, S. Henrys, C. de Ronde, M. Urlaub, S. Kutterolf, S. Fonua, S. Panuve, D. Veverka, R. Rapp, V. Kamalov, M. Williams, Fast and destructive density currents created by ocean-entering volcanic eruptions. Science 381, 1085-1092 (2023). doi:10.1126/science.adi3038 Medline.
45. R. A. Harris, Large earthquakes and creeping faults. Rev. Geophys. 55, 169-198 (2017). doi:10.1002/2016RG000539.
46. Y. Xu, R. Burgmann, D. L. George, E. J. Fielding, G. X. Solis-Gordillo, D. B. Yanez-Borja, Forecasting Inundation of Catastrophic Landslides From Precursory Creep. Geophys. Res. Lett. 51, e2024GL110210 (2024).
47. C. Ducrocq, T. Árnadóttir, P. Einarsson, S. Jónsson, V. Drouin, H. Geirsson, Á. R. Hjartardóttir, Widespread fracture movements during a volcano-tectonic unrest: The Reykjanes Peninsula, Iceland, from 2019-2021 TerraSAR-X interferometry. Bull. Volcanol. 86, 14 (2024). doi:10.1007/s00445-023-01699-0.
48. LMI, Landmolingar Íslands (data collected by the Icelandic Institute of Natural History and the National Survey of Iceland) (2024); https://atlas.lmi.is/mapview/?application=umbrotasja.
49. J. Li, E. Biondi, E. Bird, Z. Zhan, Iceland eruption DAS data (2024); https:/data.caltech.edu/records/tw5s6-nd034.
50. E. Biondi, X. Wang, E. F. Williams, Z. Zhan, Geolocalization of Large-Scale DAS Channels Using a GPS-Tracked Moving Vehicle. Seismol. Res. Lett. 94, 318-330 (2022). doi:10.1785/0220220169.
51. B. Romanowicz, R. Allen, K. Brekke, L.-W. Chen, Y. Gou, I. Henson, J. Marty, D. Neuhauser, B. Pardini, T. Taira, S. Thompson, J. Zhang, S. Zuzlewski, SeaFOAM: A Year-Long DAS Deployment in Monterey Bay, California. Seismol. Res. Lett. 94, 2348-2359 (2023). doi:10.1785/0220230047.
52. N. J. Lindsey, H. Rademacher, J. B. Ajo-Franklin, On the Broadband Instrument Response of Fiber-Optic DAS Arrays. J. Geophys. Res. Solid Earth 125, e2019JB018145 (2020).
53. P. Paitz, P. Edme, D. Graff, F. Walter, J. Doetsch, A. Chalari, C. Schmelzbach, A. Fichtner, Empirical Investigations of the Instrument Response for Distributed Acoustic Sensing (DAS) across 17 Octaves. Bull. Seismol. Soc. Am. 111, 1-10 (2020). doi:10.1785/0120200185
54. G. Flóvenz, R. Wang, G. P. Hersir, T. Dahm, S. Hainzl, M. Vassileva, V. Drouin, S. Heimann, M. P. Isken, E. Á. Gudnason, K. Ágústsson, T. Ágústsdóttir, J. Horilek, M. Motagh, T. R. Walter, E. Rivalta, P. Jousset, C. M. Krawczyk, C. Milkereit, Cyclical geothermal unrest as a precursor to Iceland's 2021 Fagradalsf-jall eruption. Nat. Geosci. 15, 397-404 (2022). doi:10.1038/s41561-022-00930-5.
55. A. Lomax, J. Virieux, P. Volant, C. Berge-Thierry, “Probabilistic Earthquake Location in 3D and Layered Models” in Advances in Seismic Event Location, C. H. Thurber, N. Rabinowitz, Eds. (Springer Netherlands, 2000), pp. 101-134, 10.1007/978-94-015-95360_5.
56. D. T. Trugman, P. M. Shearer, GrowClust: A Hierarchical Clustering Algorithm for Relative Earthquake Relocation, with Application to the Spanish Springs and Sheldon, Nevada, Earthquake Sequences. Seismol. Res. Lett. 88 (2A), 379-391 (2017). doi:10.1785/0220160188.
57. R. C. Aster, B. Borchers, C. H. Thurber, Parameter Estimation and Inverse Problems (Elsevier, 2018).
58. L. A. Blackstone, B. E. Grossman-Ponemon, E. R. Heimisson, A. J. Lew, P. Segall, Modeling dike trajectories in a biaxial stress field with coupled magma flow, fracture, and elasticity. Bull. Volcanol. 86, 52 (2024). doi:10.1007/s00445-024-01734-8.
59. V. Kamalov and M. Mazur, “Environmental sensing with transmission fibers in undersea cables,” in Undersea Fiber Communication Systems, 3rd ed., J. Chesnoy and J.-C. Antona, Eds. Academic Press/Elsevier, 2025, pp. 417-478.
60. Distributed optical fiber sensing: Review and perspective Ping Lu; Nageswara Lalam; Mudabbir Badar; Bo Liu; Benjamin T. Chorpening; Michael P. Buric; Paul R. Ohodnicki Appl. Phys. Rev. 6, 041302 (2019) https://doi.org/10.1065/1.5113955
61. Mazur, M., Fontaine, N. K., Ryf, R., Karrenbach, M., McLaughlin, K. L., Sperry, B. J., Butler, A. G., Kamalov, V., Dallachiesa, L., Burrows, E. and Winter, D., 2025. Submarine Cable Deep-Ocean Observation of Mega-Thrust Earthquake and Tsunami with 44,000 100-m Spaced Sensors. arXiv preprint arXiv:2509.24813.
62. Https://www.optasense.com/technogy/quantx
63. https://www.asn.com/fiber-sensing.
64. Further information on one or more embodiments of the invention can be found in Minute-scale dynamics of recurrent dike intrusions in Iceland with fiber-optic geodesy Jiaxuan Li1,2*, Ettore Biondi1, Elias Rafn Heimisson3, Simone Puel1,4, Qiushi Zhai1, Shane Zhang1, Vala Hjörleifsdóttir5, Xiaozhuo Wei1, Elijah Bird1, Andy Klesh6, Valey Kamalov7, Theodór Gunnarsson8, Halldór Geirsson3, Zhongwen Zhan. Science. 2025 Jun. 12; 388(6752):1189-1193, and supporting information.
65. John-son, K. L. Contact Mechanics. (Cambridge University Press, 1987).
66. Bonaccorso, A. & Davis, P. M. Models of ground deformation from vertical volcanic conduits with application to eruptions of Mount St. Helens and Mount Etna. Journal of Geophysical Research: Solid Earth 104, 10531-10542 (1999).
67. Fialko, Y, Khazan, Y & Simons, M. Deformation due to a pressurized horizontal circular crack in an elastic half-space, with applications to volcano geodesy. Geophys J Int 146, 181-190 (2001).

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A method for monitoring a source, comprising:
receiving optical fiber sensing (OFS) data from a plurality of channels along at least one optical fiber in an active telecommunications network, the optical fiber in physical contact with ground susceptible to a quasi-static deformation in response to one or more changes in at least one physical state of a source of the quasi-static ground deformation; and
monitoring a change in the source as a function of time using the OFS data comprising or converted to strain or strain rate data and/or processing the OFS data to identify deformation patterns indicative of the quasi static ground deformation.

2. The method of claim 1, further comprising inferring, from or using the strain or strain rate data, future mass movement resulting from the one or more changes.

3. The method of claim 1, wherein:
the monitoring or processing uses the strain or strain rate data having temporal frequency components less than or equal to 0.1 Hz, and/or
the quasi-static deformation is characterized by the strain or strain rate data temporally filtered with a low pass filter with a maximum cutoff frequency at or below 0.1 Hz.

4. The method of claim 1, further comprising performing a geodetic or geodesy measurement of the ground deformation and/or the source using the strain or strain rate data and wherein the strain or strain-rate data is obtained with minute-scale temporal resolution, comprising sampling intervals in a range of approximately 1 to 120 seconds.

5. The method of claim 1, further comprising processing the OFS data to obtain the strain rate data and wherein the OFS data comprises distributed acoustic sensing (DAS) data or acoustic sensing data.

6. The method of claim 1, wherein the monitoring or processing comprises calculating or determining, from the OFS data comprising or converted to strain or strain rate data, a metric for the source that can be used to infer future mass movement resulting from the one or more changes.

7. The method of claim 6, wherein the metric is the strain rate data above a predetermined threshold with the changes and that is a predictor or forecast of the mass movement corresponding to a sinkhole, avalanche, landslide, mudslide, fault creeping, or magma eruption, or seafloor deformation or eruption, the method further comprising:
outputting a signal forecasting the avalanche, mudslide, landslide, sinkhole formation, fault creeping, seafloor deformation or eruption, or magma eruption if the strain or strain rate data is above the predetermined threshold.

8. The method of claim 1, the monitoring further comprising outputting the metric, the strain, or the strain rate data in real time with the changes and wherein the metric, the strain, and/or the strain rate data measures the changes at a time scale of 1 minute or less.

9. The method of claim 1, wherein the changes, the ground deformations, the strain, or the strain rate data have a temporal period in a range of 1-6 hours.

10. The method of claim 1, wherein the source and positioning of the optical fiber are such that the OFS data can be processed to measure a strain rate of greater than 0.1 nanostrain per second for the optical fiber in a range of 5 m-50 km of the source and/or a strain having a frequency of more than 0.1 Hz or less than 0.1 Hz and when at least a portion (or all) of the fiber is not in physical contact with the mass movement.

11. The method of claim 1,
receiving, in a computer, the strain rate data measured using the OFS data caused by strain applied to the fiber in response to the ground deformation;
receiving, in the computer, source information useful in an algorithm modeling the strain rate data or the strain as a function of the physical state of the source; and
calculating a metric comprising a time evolution of the at least one physical state from the strain rate data or strain and the source information.

12. The method of claim 11, wherein the calculating comprises using the algorithm to numerically solve a model for the strain rate data or strain as an inverse problem using a Green's function method, minimizing an objective function, an iterative gradient method, or a least squares method.

13. The method of claim 11, wherein:
the mass movement is a magma eruption at a surface of the ground,
the source information comprises:
location and orientation of one or more dikes connected to one or more magma chambers, and
location of the magma chambers, and
the at least one physical state comprises:
dike opening size at different depths as a function of time,
magma chamber deflation volume as a function of time,
and a further input to the computer includes at least one of an elastic property of the surrounding crust or a coupling factor for conversion of the strain rate data to a ground strain.

14. The method of claim 11, wherein source is a source of a sinkhole, the mass movement is ground collapse, the source information includes location of a slip plane, and the physical state is a deflation or subsurface opening of the slip plane.

15. The method of claim 11, wherein the source is a source of the mass movement comprising a landslide, avalanche, or mudslide, fault creeping, seafloor movement or eruption, the source information includes a location of the slip plane, and the physical source state is an amount of moving mass e.

16. The method of claim 1, further comprising generating a spatial and temporal map of a subsurface deformation and/or induced subsurface deformation inferred from the strain or strain rate data.

17. The method of claim 1, further comprising processing the OFS data to obtain the strain rate data, comprising:
dividing the fiber into a plurality of the channels each having a gauge length of 5-20 m;
applying a low pass filter to the OFS data to remove high frequency seismic signals that are not attributed to the ground deformation;
applying a first spatial median filter across a plurality of channels to remove common mode noise resulting from temperature fluctuations,
applying a second median filter along both spatial and temporal dimensions to remove the effect of high-frequency earthquake signals and/or traffic signals as needed;
integrating the data in time across each of the channels, and using the integrated signal to obtain strain rate data;
applying a coupling factor to convert OFS strain to actual ground deformation strain; and
integrating the data along a plurality of neighboring channels to obtain the strain rate data as a function of position along the fiber.

18. A computer-implemented system, comprising:
a computer programmed to:
receive distributed optical fiber sensing (OFS) data from a plurality of channels along at least one optical fiber in an active telecommunications network, the optical fiber in physical contact with ground that experiences a quasi-static deformation in response to one or more changes in at least one physical state of a source of the quasi-static ground deformation; and
monitoring a change in the source as a function of time using the OFS data comprising or converted to strain or strain rate data and/or processing the OFS data to identify deformation patterns indicative of the quasi static ground deformation.

19. The system of claim 18, further comprising the computer programmed or configured to output a warning forecasting the mass movement if a metric obtained from the strain or strain rate data is above a threshold value.

20. The system of claim 18, further comprising:
an interrogator coupled to the optical fiber, wherein the interrogator comprises a modulator for modulating telecom signals transmitted into the fiber and a demodulator for extracting the OFS data comprising a phase of the Rayleigh backscattering of the telecom signals from each of the channels; and
the interrogator comprising or coupled to the computer with a link transmitting the OFS data to the computer.

21. The system of claim 18, further comprising a network of the optical telecommunication fibers, where two or more fibers are used to provide optical fiber sensing data, and used to monitor the changes in time.
